(19) United States
(12) Patent Application Publication
(10) Pub. No.: US 2022/0131967 A1
(43) Pub. Date: Apr. 28, 2022

(54) Wearable Personal Wireless Media Station

(71) Applicant: Pinn, Inc., Tustin, CA (US)

(72) Inventor: Seung Jin Kim, Tustin, CA (US)

(21) Appl. No.: 17/647,603

(22) Filed: Jan. 11, 2022

Related U.S. Application Data
(63) Continuation of application No. 17/011,098, filed on Sep. 3, 2020.
Application No. 17/011,098 is a continuation of application No. 15/788,652, filed on Oct. 19, 2017, now abandoned.
Application No. 15/788,652 is a continuation-in-part of application No. 16/930,246, filed on Jul. 15, 2020.
Application No. 16/930,246 is a continuation of application No. 16/687,480, filed on Nov. 18, 2019, now abandoned.
Application No. 16/687,480 is a continuation of application No. 15/694,736, filed on Sep. 1, 2017, now Pat. No. 10,609,198.
Application No. 15/694,736 is a continuation of application No. 15/625,935, filed on Jun. 16, 2017, now Pat. No. 9,807,491.
Application No. 15/625,935 is a continuation of application No. PCT/US2016/025936, filed on Apr. 4, 2016.
Application No. 17/011,098 is a continuation-in-part of application No. 16/912,823, filed on Jun. 26, 2020, now Pat. No. 11,102,340.
Application No. 16/912,823 is a continuation of application No. 16/455,558, filed on Jun. 27, 2019, now Pat. No. 10,701,197.
Application No. 16/455,558 is a continuation of application No. 15/563,937, filed on Oct. 2, 2017, now Pat. No. 10,455,066.
(60) Provisional application No. 62/199,943, filed on Jul. 31, 2015.
(60) Provisional application No. 62/142,978, filed on Apr. 3, 2015.

(51) Int. Cl. H04M 1/60; G06F 1/16; H04M 1/72412

(52) U.S. Cl. CPC H04M 1/6066; G06F 1/163; H04M 2250/02; H04M 1/72412; G06F 1/1632

(57) ABSTRACT

The disclosure herein provides a wearable personal wireless media station including a wearable base station and a wireless earbud. The wearable personal wireless media station may detect that the wireless earbud is docked to the wearable base station, play audio through a speaker of the wearable base station while the wireless earbud is docked to the wearable base station, detect that the wireless earbud is undocked from the wearable base station, cease to play sound through the speaker of the wearable base station in response to detecting that the wireless earbud is undocked from the wearable base station, and begin playing audio through the wireless earbud while the wireless earbud is undocked from the wearable base station.

### INCORPORATION BY REFERENCE TO ANY PRIORITY APPLICATIONS

The present application is a continuation of U.S. patent application Ser. No. 17/011,098 (the “098 application”), filed Sep. 3, 2020, which is a continuation of U.S. patent application Ser. No. 15/788,652, filed Oct. 19, 2017. The '098 application is also a continuation-in-part application of U.S. patent application Ser. No. 16/930,246, filed Jul. 15, 2020, which is a continuation of U.S. patent application Ser. No. 16/687,480, filed Nov. 18, 2019, which is a continuation of U.S. patent application Ser. No. 15/694,736, filed Sep. 1, 2017, now U.S. Pat. No. 10,609,198, which is a continuation of U.S. patent application Ser. No. 15/625,935, filed Jun. 16, 2017, now U.S. Pat. No. 9,807,491, which is a continuation of PCT Application No. PCT/US16/25936, filed Apr. 4, 2016, which claims benefit to U.S. Provisional Patent Application Ser. No. 62/199,43, filed Jul. 31, 2015, and U.S. Provisional Patent Application Ser. No. 62/142,978, filed Apr. 3, 2015. The '098 application is also a continuation-in-part application of U.S. patent application Ser. No. 16/912,823, filed Jun. 26, 2020, which is continuation of U.S. patent application Ser. No. 16/455,558, filed Jun. 27, 2019, which is a continuation of U.S. patent application Ser. No. 15/563,937, filed Oct. 2, 2017, now U.S. Pat. No. 10,455,066, which is a national stage application of Application No. PCT/US16/25936, filed Apr. 4, 2016, which claims benefit to U.S. Provisional Patent Application Ser. No. 62/199,43, filed Jul. 31, 2015, and U.S. Provisional Patent Application Ser. No. 62/142,978, filed Apr. 3, 2015. Each of the above is incorporated herein by reference in their respective entireties.

### BACKGROUND

The present disclosure relates to mobile consumer electronic devices and, more particularly, to devices connected to smartphones and tablets for delivering sound and visual information to users. Today, mobile devices such as smartphones and tablet computers are often used with mobile accessories that facilitate user access to the inputs and outputs (e.g., display, speaker, microphone, etc.) of the mobile devices. For example, if a user wishes to listen to music stored on her smartphone without disturbing those around her, she can plug a set of earphones into her smartphone and listen to the music through the earphones. If the user wishes to type faster on her smartphone, she can connect a Bluetooth keyboard to her smartphone and type on the Bluetooth keyboard. Thus, using such mobile accessories can improve how users communicate with the mobile devices.

### SUMMARY

One aspect of the invention provides a wearable personal wireless media station in communication with a paired mobile computing device of a user for playing sound and displaying data based on communication with the paired mobile computing device. The wearable personal wireless media station comprises: a wearable base station comprising an information display, a base station speaker, a volume control button, a base station connector, a docking mechanism and a wearable mechanism configured to allow the wearable base station to be worn by a user; a wireless earbud comprising an earbud speaker and an earbud connector, the wireless earbud configured to dock to or undock from the docking mechanism of the wearable base station; wherein when the wireless earbud is docked to the docking mechanism of the wearable base station, the wireless earbud and the wearable base station form a single integrated body and the earbud connector, and the base station connector are electrically in contact with each other.

The wearable personal wireless media station may be programmed: to detect a docked-to-undocked change in which the wireless earbud becomes undocked from the docking mechanism; and to detect an undocked-to-docked change in which the wireless earbud becomes docked to the docking mechanism.

In the foregoing wearable personal wireless media station, the wearable base station and the wireless earbud may be configured to wirelessly communicate with a smartphone such that: when there is an incoming call made to the smartphone while the wireless earbud is docked to the docking mechanism of the wearable base station, the wearable base station receives text data corresponding to the incoming call from the smartphone and the wireless earbud receives audio data corresponding to a ringtone indicative of the incoming call from the smartphone; in response to receiving the text data corresponding to the incoming call, the wearable base station displays caller information on a display of the wearable base station; in response to receiving the audio data corresponding to the ringtone indicative of the incoming call, the wireless earbud converts the audio data such that the converted audio data is playable by the base station speaker while the wireless earbud is docked to the docking mechanism of the wearable base station and causes the base station speaker to play the ringtone; and in response to detecting the docked-to-undocked change, the wearable personal wireless media station sends instructions to the smartphone to accept the incoming call, and the wireless earbud plays audio data for the accepted incoming call via the earbud speaker such that the incoming call is accepted and conducted without the user touching the smartphone.

In the foregoing wearable personal wireless media station, the wearable base station and the wireless earbud may be configured to wirelessly communicate with a smartphone such that: when there is an incoming call made to the smartphone while the wireless earbud is docked to the docking mechanism of the wearable base station, the smartphone sends text data corresponding to the incoming call to the wearable base station and sends audio data corresponding to a ringtone indicative of the incoming call to a wireless audio device other than the wearable base station and the wireless earbud such that the ringtone is played by the wireless audio device; in response to receiving the text data corresponding to the incoming call, the wearable base station displays caller information on a display of the wearable base station; and in response to detecting the docked-to-undocked change, the wearable personal wireless media station sends instructions to the smartphone to accept the incoming call and begin sending audio data for the accepted incoming call to the wireless earbud instead of the wireless audio device, and the wireless earbud provides audio playback via the earbud speaker based on the audio data such that the incoming call is accepted and conducted without the user touching the smartphone.

In the foregoing wearable personal wireless media station, the wireless earbud may comprise a head a head portion, a waist portion and an ear portion, the ear portion configured to be inserted into the user's ear to provide sound playback, wherein the earbud connector is provided on the waist portion such that the earbud connector is in electrical contact with the wearable base station connector when the wireless earbud is in its docked state. The docking mechanism may comprise two docking arms that extend generally parallelly to each other with a gap therebetween, wherein the docking mechanism further comprises at least one locking device on an inner surface of one or both of the two docking arms for engaging with the waist portion of the wireless earbud when the wireless earbud is in its docked state. The wireless earbud may comprise a recess formed into the waist portion, wherein the at least one locking device of the docking mechanism comprises a locking protrusion configured to spatially correspond to the recess when the wireless earbud is in its docked state, wherein the recess is configured to receive the locking protrusion when the wireless earbud is in its docked state

In the foregoing wearable personal wireless media station, the wearable personal wireless media station may be programmed to: cease playing sound on the base station speaker and to begin playing sound on the earbud speaker in response to detecting the docked-to-undocked change while sound is being played on the base station speaker; and cease playing sound on the earbud speaker and to begin playing sound on the base station speaker in response to detecting the undocked-to-docked change while sound is being played on the earbud speaker.

In the foregoing wearable personal wireless media station, the wearable personal wireless media station may be programmed to display caller information indicative of a caller associated with the incoming call on the information display in response to receiving the data regarding the incoming call from the smartphone.

In the foregoing wearable personal wireless media station, the wearable personal wireless media station may be programmed, in response to receiving data regarding an incoming call or message from the smartphone while the wireless earbud is docked to the docking mechanism, to display a text or image associated with the incoming call or message on the information display.

In the foregoing wearable personal wireless media station, each of the wearable base station and the wireless earbud may be configured to separately and individually pair with the smartphone. In some cases, the wireless earbud is programmed to relay audio data received from the smartphone to the wearable base station for playback via the base station speaker. In some cases, the wireless earbud is programmed to wirelessly communicate directly with the smartphone to receive audio data from the smartphone and transmit voice data captured by the wireless earbud to the smartphone without going through the wearable base station. In some cases, the wearable base station is programmed to wirelessly communicate with the smartphone and with the wireless earbud to relay audio data received from the smartphone to the wireless earbud for playback via the earbud speaker and to relay voice data captured by the wireless earbud to the smartphone.

In the foregoing wearable personal wireless media station, the wearable personal wireless media station may be programmed: upon detecting activation of the volume control button by the user while the wireless earbud is undocked from the docking mechanism and sound playback for audio data received from the smartphone is being provided via the earbud speaker, to adjust a volume of the sound playback for the audio data received from the smartphone being provided via the earbud speaker such that the volume of the sound playback via the earbud speaker is controlled without the user touching the smartphone; and upon detecting activation of the volume control button by the user while the wireless earbud is docked to the docking mechanism and sound playback for audio data received from the smartphone is being provided via the base station speaker, to adjust a volume of the sound playback for the audio data received from the smartphone being provided via the base station speaker such that the volume of the sound playback via the base station speaker is controlled without the user touching the smartphone.

In the foregoing wearable personal wireless media station, the wearable personal wireless media station may be programmed, upon detecting activation of the volume control button by the user while the wireless earbud is undocked from the docking mechanism and sound playback for audio data received from the smartphone is being provided via the earbud speaker, to wirelessly communicate with the smartphone to adjust a volume of the sound playback for the audio data received from the smartphone being provided via the earbud speaker such that that the volume of the sound playback via the earbud speaker is controlled without the user touching the smartphone.

In the foregoing wearable personal wireless media station, the wearable personal wireless media station may be programmed to detect the docked-to-undocked change based on whether the base station connector is electrically connected to the earbud connector.

In the foregoing wearable personal wireless media station, the wearable personal wireless media station may be programmed, in response to detecting the undocked-to-docked change while the sound playback of the audio data received by the smartphone for the accepted incoming call is being provided via the wireless earbud, to cease providing the sound playback via the wireless earbud and begin providing the sound playback of the audio data received by the smartphone for the accepted incoming call via the wearable base station such that the sound playback for the accepted incoming call is continued via the wearable base station.

In the foregoing wearable personal wireless media station, the wearable personal wireless media station may comprise the wireless earbud comprises a rail, and the wearable base station comprises a sliding groove configured to receive the rail of the wireless earbud such that, when the rail has been fully inserted into the sliding groove, the earbud connector and the base station connector are in electrical contact with each other. In some cases, the wireless earbud comprises a head portion and an ear portion, the ear portion configured to be inserted into the user's ear to provide sound playback, wherein the wearable base station comprises a hole configured to receive the ear portion of the wireless earbud such that, when the ear portion has been fully inserted into the hole, the head portion of the wireless earbud snaps into a portion of the wearable base station surrounding the hole, and the earbud connector and the base station connector are in electrical contact with each other. In some cases, the wireless earbud comprises a head portion and an ear portion, the ear portion configured to be inserted into the user's ear to provide sound playback, wherein the wearable base station comprises a slit configured to receive the head portion of the wireless earbud, and the head portion is configured to slide into the slit such that, when the head portion has been fully slid into the slit, the earbud connector and the base station connector are in electrical contact with each other. In some cases, the wireless earbud comprises a head portion and an ear portion, the ear portion configured to be inserted into the user's ear to provide sound playback, wherein the wearable base station comprises a slit configured to receive the head portion of the wireless earbud, and the head portion is configured to slide into the slit such that, when the head portion has been fully slid into the slit, the earbud connector and the base station connector are in electrical contact with each other. In some cases, the wearable base station comprises a Universal Serial Bus (USB)-type plug, and the wireless earbud comprises a USB-type socket configured to receive the plug such that, when the plug has been fully inserted into the socket, the earbud connector and the base station connector are in electrical contact with each other. In some cases, the wireless earbud comprises a Universal Serial Bus (USB)-type plug, and the wearable base station comprises a USB-type socket configured to receive the plug such that, when the plug has been fully inserted into the socket, the earbud connector and the base station connector are in electrical contact with each other.

### BRIEF DESCRIPTION OF THE DRAWINGS

The foregoing and other features, aspects and advantages of the present invention are described in detail below with reference to the drawings of various embodiments, which are intended to illustrate and not to limit the invention. The drawings comprise the following figures in which:

FIG. 1 illustrates a use of a wearable personal wireless media station, according to an example embodiment;

FIG. 2 illustrates another use of a wearable personal wireless media station, according to an example embodiment;

FIG. 3 illustrates another use of a wearable personal wireless media station, according to an example embodiment;

FIG. 4A illustrates a perspective view of a wearable personal wireless media station, according to an example embodiment;

FIG. 4B illustrates a perspective view of a wearable personal wireless media station in a docked position, according to an example embodiment;

FIG. 5A illustrates a perspective view of a base station of the wearable personal wireless media station, according to an example embodiment;

FIG. 5B illustrates a top view of a base station of the wearable personal wireless media station, according to an example embodiment;

FIG. 6A illustrates a perspective view of a wireless earbud of the wearable personal wireless media station, according to an example embodiment;

FIG. 6B illustrates a side view of a wireless earbud of the wearable personal wireless media station, according to an example embodiment;

FIG. 7 illustrates a block diagram of a wearable personal wireless media station, according to an example embodiment;

FIG. 8 illustrates a flowchart depicting a method for redirecting sound playback, according to an example embodiment;

FIG. 9 illustrates a flowchart depicting a method for initiating sound playback, according to an example embodiment;

FIG. 10 illustrates a flowchart depicting a method for initiating sound playback via the earbud speaker, according to an example embodiment;

FIG. 11 illustrates a flowchart depicting a method for redirecting sound playback, according to an example embodiment;

FIG. 12 illustrates a flowchart depicting a method for redirecting sound playback, according to an example embodiment;

FIGS. 13A and 13B illustrate different views of a wearable personal wireless media station, according to an example embodiment;

FIGS. 14A, 14B, 15A and 15B illustrate different views of a wireless earbud, according to an example embodiment;

FIG. 16 illustrates a wearable personal wireless media station having multiple wireless earbuds docked to the base station, according to an example embodiment;

FIGS. 17A-17D illustrate a wearable personal wireless media station having an alternative docking mechanism, according to an example embodiment;

FIGS. 18A-18D illustrate a wearable personal wireless media station having an alternative docking mechanism, according to an example embodiment;

FIGS. 19A-19E illustrate a wearable personal wireless media station having an alternative docking mechanism, according to an example embodiment;

FIGS. 20A-20D illustrate a wearable personal wireless media station having an alternative docking mechanism, according to an example embodiment;

FIGS. 21A-21C illustrate a wearable personal wireless media station having an alternative docking mechanism, according to an example embodiment; and

FIGS. 22A-22C illustrate a wearable personal wireless media station having an alternative docking mechanism, according to an example embodiment.

FIG. 23 illustrates a wearable personal wireless media station, according to an example embodiment.

FIG. 24 illustrates a flowchart depicting a method for redirecting sound playback when the earbud becomes undocked, according to an example embodiment.

FIG. 25 illustrates a flowchart depicting a method for redirecting sound playback when the earbud becomes docked, according to an example embodiment.

FIG. 26 illustrates a flowchart depicting a method for directing sound playback based on sound content when the earbud becomes docked, according to an example embodiment.

FIG. 27 illustrates a flowchart depicting a method for directing sound playback based on sound content when the earbud becomes undocked, according to an example embodiment.

FIG. 28 illustrates a flowchart depicting a method for charting the earbud battery, according to an example embodiment.

FIG. 29 illustrates a diagram depicting usage of buttons provided on a wearable personal wireless media station, according to an example embodiment.

FIGS. 30-49 illustrate different views of a wearable personal wireless media station, according to example embodiments.

### DETAILED DESCRIPTION OF EMBODIMENTS

Embodiments of the invention will now be described with reference to the accompanying figures. The terminology used in the description presented herein is not intended to be interpreted in any limited or restrictive manner, simply because it is being utilized in conjunction with a detailed description of certain specific embodiments of the invention. Furthermore, embodiments of the invention may comprise several novel features, no single one of which is solely responsible for its desirable attributes or which is essential to practicing the inventions herein described.

### Need for Convenient Access to Primary Devices

Today, many mobile electronic accessories are available for use with mobile electronic devices such as smartphones, tablet computers, and other user computing devices (collectively referred to herein as primary devices). Some of these accessories allow the user to switch between the different ways of accessing the content provided on the primary device. For example, if a user wishes to listen to music stored on his smartphone without disturbing others around him, rather than using the speaker on his smartphone, he can use a set of headphones that wirelessly connects to his smartphone and listen to the music through the headphones. Other accessories allow the user to access the content provided on the primary device in a more convenient manner. For example, a user may keep her smartphone in her purse (e.g., her smartphone may be too big to fit in her pocket or she may be wearing a dress without any pockets). If she does not wish to constantly reach into her purse and take out her smartphone to check for any new text messages, she can use a smartwatch that wirelessly connects to her smartphone and read and respond to text messages using the touch screen on the smartwatch.

### Wearable Personal Wireless Media Station

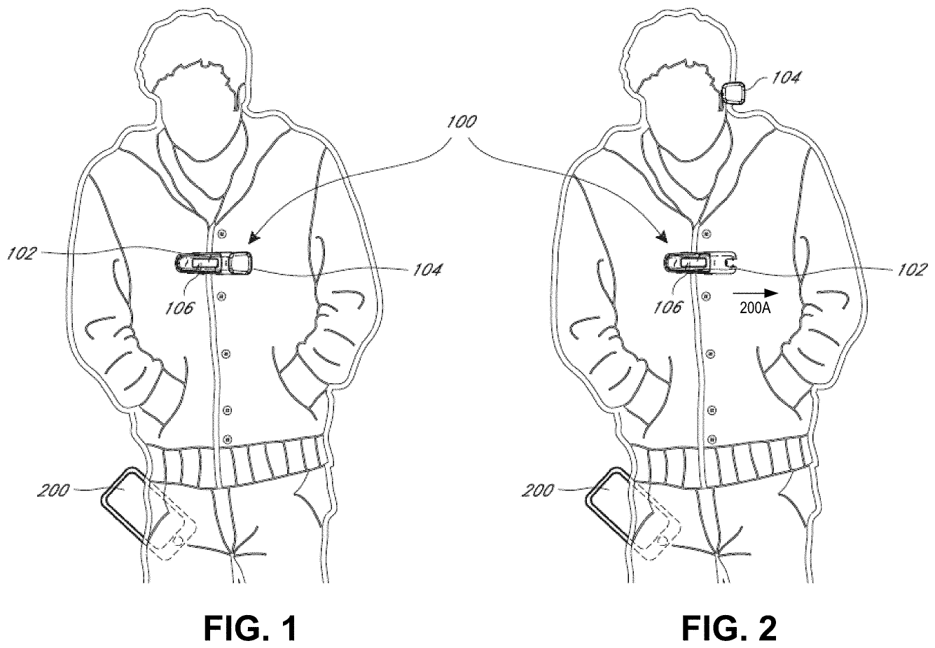

In one aspect, the invention provides a wearable personal wireless media station 100 (also referred to herein as personal wireless media station 100) as exemplified in FIGS. 1-3. The personal wireless media station 100 can be wirelessly connected to the user's primary device 200 (e.g., smartphones, tablet computers, etc.) and facilitate the user's access to the content provided on the primary device 200. For example, once wirelessly connected to the primary device 200, the personal wireless media station 100 can display messages received on the primary device 200 and play music stored or streamed on the primary device 200.

### Base Station and Earbud

Referring to FIGS. 1 and 2, the personal wireless media station 100 includes a wearable base station 102 (also referred to herein as base station 102) and a wireless earbud 104. The base station 102 includes a speaker for providing sound data and a display surface for providing visual data. The wireless earbud 104 includes a speaker for providing sound data. The wireless earbud 104 is configured to be docked (e.g., connected both mechanically and electrically) to the base station 102. In embodiments, the playing mode of the personal wireless media station 100 may be based on whether or not the wireless earbud 104 is docked to the base station 102.

### Base Station Is Not A Phone

In some cases, the primary device 200 is capable of making and receiving voice calls, and the base station 102 is not capable of, on its own, making and receiving voice calls. For example, the primary device 200 is a smartphone, and the base station 102 is not a phone. Alternatively, in some cases, the base station 102 is capable of making and receiving voice calls. For example, the base station 102 is a smartphone.

### Wearing and Carrying Personal Wireless Media Station

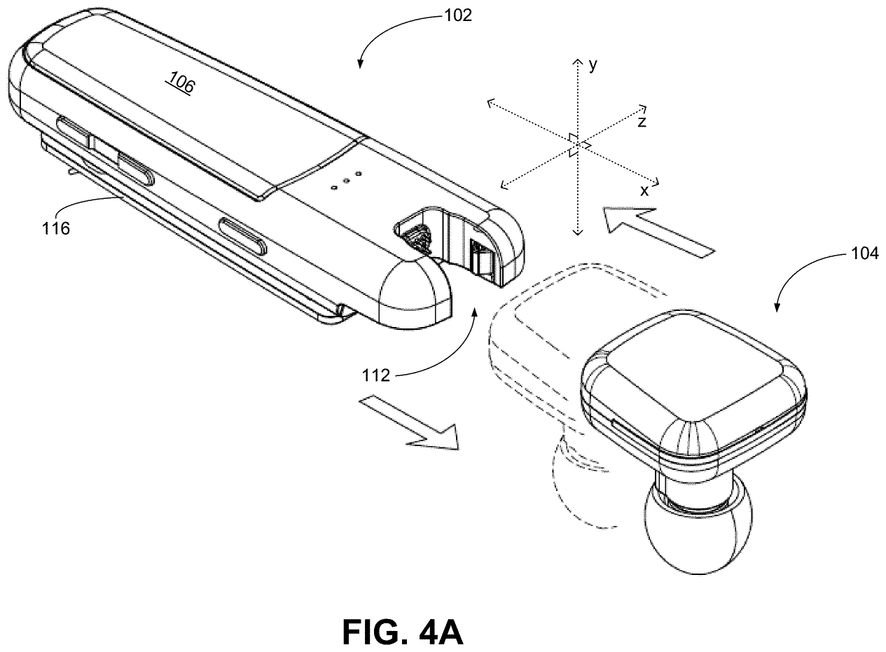

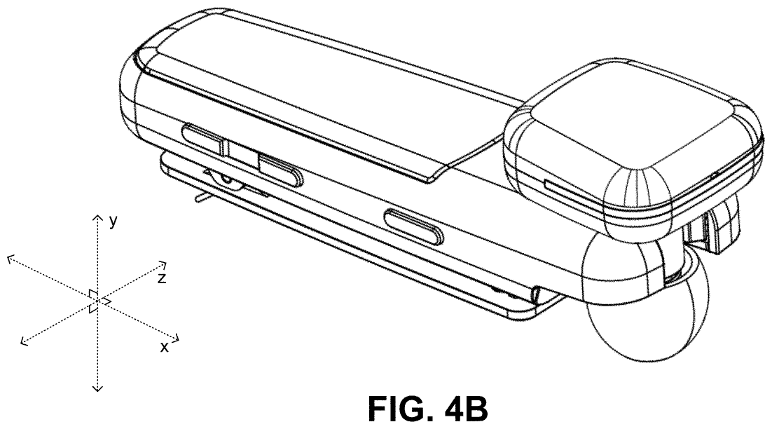

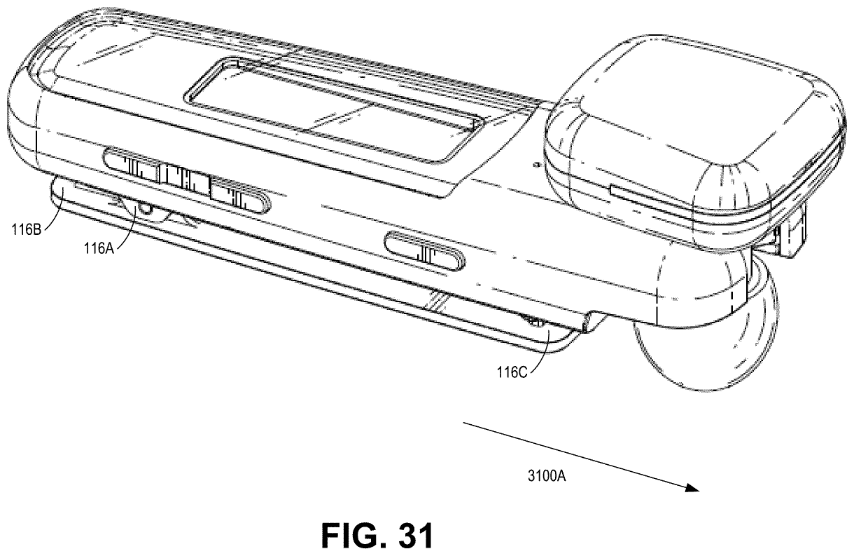

The clip provided on the base station 102 allows the personal wireless media station 100 to be clipped to the user's clothing or other possessions. The clip allows the user to keep the personal wireless media station 100 in a place that is easily accessible and visible as illustrated in FIGS. 1-3. The clip is described in greater detail below with reference to FIGS. 4A and 31.

### Accessing Primary Device Content Via Base Station

FIG. 1 illustrates an example in which the wireless earbud 104 is docked to the base station 102. As shown in FIG. 1, the user can leave his primary device 200 in his pocket and access the content on the primary device 200 via the personal wireless media station 100. For example, when a new message arrives on the primary device 200, the user can check the content of the message by simply gripping and turning the base station 102 with fingers such that the display surface 106 faces upward for him to read the message displayed on the display surface 106, without having to take out the primary device 200 from his pocket. As another example, the user can play the music stored on the primary device 200 through the speaker provided on the personal wireless media station 100. As illustrated by these examples, the personal wireless media station 100 provides convenient wireless access to the content on the primary device 200 without requiring the user to physically maneuver the primary device 200.

### Accessing Primary Device Content Via Base Station and Wireless Earbud

FIG. 2 illustrates an example in which the wireless earbud 104 is undocked from the base station 102. As shown in FIG. 2, the user can undock the wireless earbud 104 by pulling the wireless earbud 104 away from the base station 102 in the undocking direction 200A and plug the ear portion of the wireless earbud 104 into his ear to listen to the music stored on the primary device 200 through the speaker provided on the wireless earbud 104. Even when the wireless earbud 104 is undocked from the base station 102, the user can still use the display surface 106 of the base station 102 to access the content provided on the primary device 200, such as text, email, and other data. For example, the display surface 106 on the base station 102 may display the name and/or lyrics of the song that is currently being played through the speaker on the wireless earbud 104 or display an incoming message received on the primary device 200.

Reading Messages and Answering Calls without Touching Your Phone

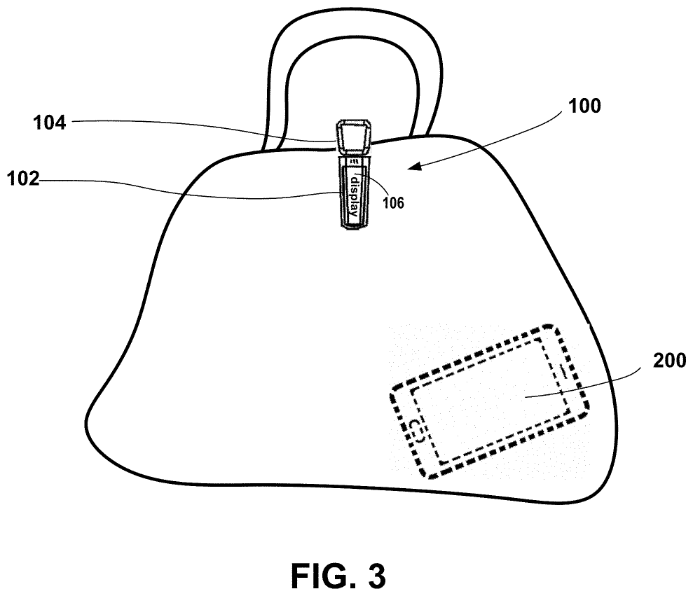

FIG. 3 illustrates another example in which the wireless earbud 104 is docked to the base station 102. The personal wireless media station 100, which is clipped to the top of the purse and sitting in plain view, is much more accessible than the primary device 200 buried at the bottom of the purse. For example, the user can read incoming messages via the display surface 106 on the base station 102 and answer incoming calls using the wireless earbud 104 without touching the phone as is in the examples illustrated in FIGS. 1 and 2.

### Docking and Undocking of Personal Wireless Media Station

In embodiments, the wireless earbud 104 can be docked to and undocked from the base station 102. The base station 102 provides a docking bay 112 to receive the wireless earbud 104. Referring to FIG. 4A, the earbud 104 can be docked to the base station 102 by moving the earbud 104 along the X axis toward the base station 102 (specifically to the docking bay 112) while generally maintaining the earbud 104 at a position in the Y and Z axes corresponding to the docking bay 112. FIG. 4B illustrates a state in which the earbud 104 is docked with the base station 102, in which a waist portion (middle in the Y axis) of the earbud 104 is located within the docking bay 112. Referring back to FIG. 4A, the earbud 104 can be undocked from the base station 102 by moving the earbud 104 along the X axis away from the base station 102.

### Base Station

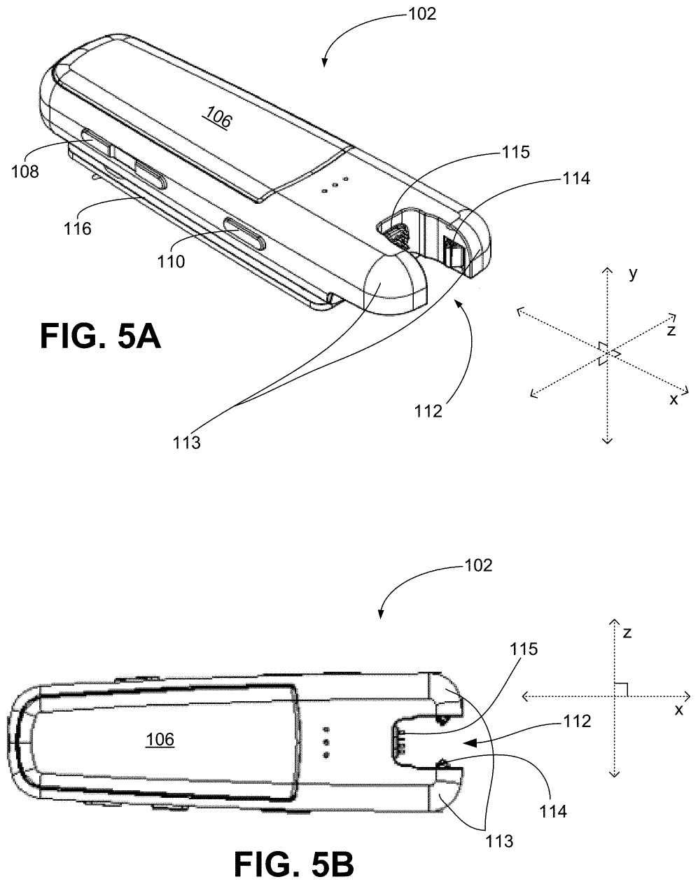

Referring to FIG. 5A, the base station 102 includes a display surface 106, a docking bay 112, contact connectors 115, and a clip 116. Although not shown in FIG. 4B, in embodiments, the base station 102 includes at least one speaker, a battery, and/or a microphone. In some embodiments, the base station includes one or more of volume control buttons 108, a function control button 110 and a camera.

### Display Surface

In embodiments, a display panel is provided under the display surface 106. The display panel may incorporate an available display technology such as LCD and OLED technologies. In embodiments, the display surface 106 is capable of displaying information including incoming call information, song information, text information, email information, photographic information and the like.

### Volume Control Buttons

In embodiments, the volume control buttons 108 are used to increase or decrease the volume of the speaker of the base station 102 and/or the speaker of the wireless earbud 104. When the earbud 104 is docked to the base station 102, in response to a volume control input at the volume control buttons 108, base station increase or decrease the volume of its own speaker, i.e., the speaker of the base station 102. When the earbud 104 is undocked from the base station 102, however, in response to a volume control input at the volume control buttons 108, the base station 102 wirelessly communicates with the earbud 104 to increase or decrease the volume of the speaker of the earbud 104. In the alternative, when the earbud 104 is undocked from the base station 102, in response to a volume control input at the volume control buttons 108, the base station 102 wirelessly communicates with the primary device 200 for controlling the volume of the speaker of the earbud 104. In addition, the volume control buttons 108 can be used to increase or decrease the size of the text displayed on the display surface 106, to increase or decrease the scrolling speed of the text displayed on the display surface, and/or to go to the next page or the previous page of the text, email, or other information displayed on the display surface 106.

### Function Control Button

In embodiments, the function control button 110 is used to activate or deactivate a variety of functions available on the personal wireless media station 100. One or more functions described herein (e.g., enabling/disabling modes or components, activating/deactivating modes or components, causing the personal wireless media station 100 to perform certain actions, etc.) may be activated or deactivated by pressing the function control button, pressing and holding the function control button for a threshold period of time (e.g., 1 second, 2 seconds, 3 seconds, or any other duration), pressing the function control button while another button is pressed (e.g., one or more volume control buttons), or pressing and holding the function control button for a threshold period of time (e.g., 1 second, 2 seconds, 3 seconds, or any other duration) while another button is pressed (e.g., one or more volume control buttons).

### Docking Bay

In embodiments, the docking bay 112 is configured, shaped and sized to receive the wireless earbud 104 in a docking space provided therein and allow the wireless earbud 104 to be docked to the base station 102. In the illustrated embodiment, the docking space of the docking bay 112 is provided between two docking arms 113 that are elongated in the X axis and generally parallel to each other with a gap therebetween in the Z axis.

### Locking Devices

In embodiments, a locking device 114 is installed on an inner side of each docking arm 113. Each locking device 114 includes a locking protrusion protruding from the corresponding docking arm 113 and a locking mechanism (spring-loaded or elastic) exerting force on the locking protrusion toward the opposite docking arm along the z-axis. When the earbud 104 is securely docked in the docking space created by the docking bay 112, the locking devices 114 provided on the docking arms 113 hug the waist portion of the earbud 104. In some embodiments, when the earbud 104 is securely docked to the base station 102 in the desired position, the locking devices 114 are in contact with the rear portions (portions that are farther away from the connectors 115 along the x-axis) of the waist portion of the earbud 104 such that the locking devices 114 securely hold the earbud 104 in place in the docked position. In other embodiments, when the earbud 104 is securely docked to the base station 102 in the desired position, the locking protrusions of the locking devices 114 are inserted into the corresponding recesses provided on the waist portion of the earbud 104 such that the locking devices 114 securely hold the earbud 104 in place in the docked position.

### Cross-Section of Docking Bay

As shown in FIG. 5B, the cross-section of the docking bay 112 of the base station 102 may be substantially in the shape of a “U” having three sides. In some embodiments, the cross-section may include two substantially parallel sides that face each other and a third side adjacent to the two substantially parallel sides. For example, the two sides that face each other may each include a protrusion corresponding to the recess provided on the waist portion of the wireless earbud 104. The third side may include pogo connectors that are spring-loaded in a direction substantially perpendicular to the direction in which the protrusions of the two sides are configured to be retracted.

### Gap Between Docking Arms

The docking arms 113 are distanced apart to allow sliding in of the waist of the wireless earbud 104 for docking (attaching) or undocking (detaching). The width of the “U” of the docking bay 112 may be substantially equal to the width of the waist portion 104B of the wireless earbud 104 in the z-axis direction. In some embodiments, the distance between the bottom of the “U” and the portion of the protrusions that is farthest from the bottom of the “U” on the docking arms 113 along the x-axis is substantially equal to the width of the waist portion 104B in the x-axis direction. In other embodiments, the distance between the bottom of the “U” and the portion of the protrusions that is farthest from the bottom of the “U” on the docking arms 113 along the x-axis is less than the width of the waist portion 104B in the x-axis direction. In some embodiments, the distance between the two protrusions on the opposite docking arms along the z-axis is less than the width of the width of the waist portion 104B of the wireless earbud 104 in the z-axis direction.

No Rotation about X-Axis or Y-Axis During Slide-In

In some embodiments, the gap (distance and/or other mechanical structure) in the docking bay 112 is configured such that the wireless earbud 104 can be rotated about neither the x-axis nor the y-axis during sliding as well as while docked. For example, the respective surfaces of the waist of the wireless earbud 104 are flat and parallel to the surfaces of the docking arms 113 facing the respective surfaces of the waist of the wireless earbud 104 while the wireless earbud 104 is slid into the docking space.

### Contact Connector

In embodiments, the base station 102 includes contact one or more connectors 115 on an inner side of the docking bay 112 for electrically connecting to the earbud 104 when it is docked to the base station 102. When the earbud 104 is docked and secured, the one or more connectors contact one or more counterpart connectors of the earbud 104. When the earbud 104 is pulled away from the base station 102 along the X axis with a threshold amount of force along the X axis, the earbud 104 becomes undocked (the connectors 115 are no longer electrically connected to the corresponding connectors on the earbud 104, and the earbud 104 physically exits the docking bay 112. In embodiments, the one or more connectors 115 include pogo pins although not limited thereto.

### Pogo Connectors on Base Station

In some embodiments, the base station and earbud connectors may be pogo connectors. The base station pogo connectors may be configured to be connected with the counterpart pogo connectors provided on the wireless earbud 104 when the wireless earbud 104 is moved into the docking space along the x-axis to be connected with the base station 102. When the wireless earbud 104 is connected with the base station 102, the counterpart pogo connectors on the wireless earbud 104 are in contact with the pogo connectors on the base station 102.

### Clip

In embodiments, the clip 116 is integrated with the body of the base station 102. The clip 116 clips the base station 102 to the user's clothing or other belongings (e.g., shirt, tie, pocket, bag, etc.). Instead of the clip 116, the base station 102 may include any other attachment mechanism such as a band or other fasteners for attaching the base station 102 to the user's body, clothing, or other belongings.

### Wireless Earbud

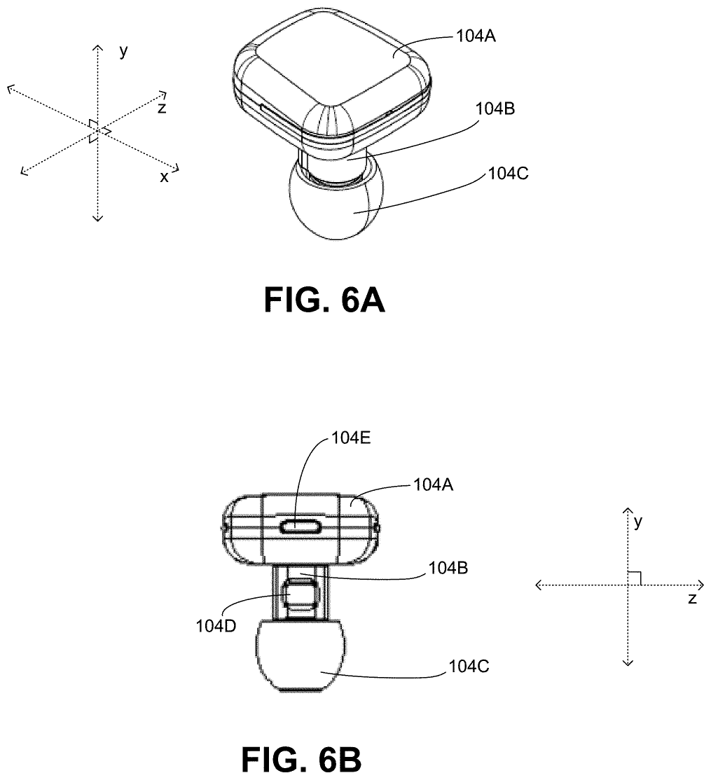

With reference to FIGS. 6A and 6B, the wireless earbud 104 includes a head portion 104A, a waist portion 104B, and an ear portion 104C. The waist portion 104B includes one or more earbud connectors for connecting with the base station connectors 115 of the base station 102. The waist portion 104B may include one or more recesses for engaging with the locking devices 114 of the base station 102. The wireless earbud 104 also includes a connector 104D for establishing an electrical connection to the base station 102 and a button 104E for receiving user input.

### Function of Wireless Earbud

In some embodiments, the wireless earbud 104 plays back sound data received from the base station 102. In other embodiments, the wireless earbud 104 plays back sound data received from the primary device 200.

### Earbud Connectors

In some embodiments, the waist portion 104B of the wireless earbud 104 may include one or more pogo connectors. In some embodiments, the waist portion 104B of the wireless earbud 104 may include one or more recesses. In some embodiments, the waist portion 104B of the wireless earbud 104 may include one or more pogo connectors and one or more recesses. The pogo connectors are mateable with the base station pogo connectors provided in the docking bay 112 of the base station 102.

### Sound Playback Via Wireless Earbud

In some embodiments, the wireless earbud 104 plays back sound received from the base station 102 when the earbud connectors are not connected to the base station connectors. In other embodiments, the wireless earbud 104 plays back sound received from the primary device 200 when the earbud connectors are not connected to the base station connectors.

### Waist

The waist portion of the wireless earbud 104 may have a width in the z-axis direction that is slightly narrower than the distance between the docking arms 113 in the z-axis direction such that the waist portion of the wireless earbud 104 can slide into the docking space between the docking arms 113 along the x-axis while maintaining contact with both of the docking arms 113.

### Recess on Waist Portion of Wireless Earbud

The waist portion of the wireless earbud 104 may have one or more recesses that match and correspond to the protrusions on the docking arms 113. The protrusions are either in contact with or inserted into the recesses when the wireless earbud 104 is fully docked. The protrusions (locking device) on the docking arms 113 may hug the one or more recesses formed in the waist of wireless earbud 104 or may be inserted into the recesses such that once the wireless earbud 104 is fully docked and the locking device is engaged, the protrusions (locking device) exert enough force on the wireless earbud 104 to prevent the wireless earbud 104 from moving in the x-axis direction, rotating about the y-axis or the z-axis, or moving up or down in the y-axis direction. In some embodiments, the protrusions are configured such that once the wireless earbud 104 is fully docked (e.g., locking device is engaged), a threshold amount of force in the x-axis direction away from the docking space is needed to disengage the locking device. Thus, inadvertent disengaging of the locking device or undocking of the wireless earbud 104 may be prevented.

### Position of Locking Device on Docking Arms

In some embodiments, when the wireless earbud 104 is fully docked, the protrusion is returned to its original position (e.g., when the docking space is unoccupied). In other embodiments, when the wireless earbud 104 is fully docked, the protrusion is sitting between its fully-loaded position (e.g., when the amount by which it extends from the docking arm 113 in the z-axis direction is at its minimum) and its original position. In other embodiments, when the wireless earbud 104 is fully docked, the protrusion is sitting at its fully-loaded position (e.g., when the amount by which it extends from the docking arm 113 in the z-axis direction is at its minimum).

### Undocking Wireless Earbud

One or both of the docking arms 113 may have a spring-loaded or elastic protrusion (locking device) that is configured to convert the force exerted thereon in the x-axis direction into the protrusion's outward movement in the z-axis direction (e.g., away from the docking space) when the wireless earbud 104 is slid out of the docking space in the x-axis direction. When the earbud is fully undocked, the spring-loaded or elastic protrusion (locking device) returns to its original position and stops exerting inward force.

### Guide Surface on Head Portion of Wireless Earbud

In some embodiments, the head portion of the wireless earbud 104 has a flat (planar) surface on the x-z plane parallel to the display surface 106. While the wireless earbud 104 is slid into the docking space and when the wireless earbud 104 is fully docked, the flat (planar) surface maintains contact with a counterpart flat (planar) surface on the base station 102.

### Guide Surface on Waist Portion of Wireless Earbud

In some embodiments, the waist portion of the wireless earbud 104 has two flat (planar) surfaces respectively maintaining contact with the docking arms 113 while the wireless earbud 104 is slid into the docking space and when the wireless earbud 104 is fully docked. In some embodiments, the flat (planar) surface on the head portion of the wireless earbud 104 and the flat (planar) surfaces on the waist portion of the wireless earbud 104 all maintain contact with the respective counterpart surfaces of the base station 102 while the wireless earbud 104 is slid into the docking space and when the wireless earbud 104 is fully docked.

### Guide Surface Restricts Unwanted Movement of Wireless Earbud

In some embodiments, the guide surfaces provided on the wireless earbud 104 restrict unwanted movement of the wireless earbud 104 while the wireless earbud 104 is slid into the docking space and when the wireless earbud 104 is fully docked. For example, maintaining contact between the flat (planar) surface on the head portion of the wireless earbud 104 and the counterpart surface on the base station 102 while the wireless earbud 104 is slid into the docking space and when the wireless earbud 104 is fully docked prevents the wireless earbud 104 from rotating about the x-axis or the z-axis. Further, maintaining contact between the flat (planar) surfaces on the waist of the wireless earbud 104 and the counterpart surfaces on the docking arms 113 while the wireless earbud 104 is slid into the docking space and when the wireless earbud 104 is fully docked prevents the wireless earbud 104 from rotating about the x-axis or the y-axis.

### Guide Surface Guides Movement of Wireless Earbud

In some embodiments, the guide surfaces provided on the wireless earbud 104 provide guidance as the wireless earbud 104 is slid into the docking space. For example, maintaining contact between the flat (planar) surface on the head portion of the wireless earbud 104 and the counterpart surface on the base station 102 while the wireless earbud 104 is slid into the docking space and when the wireless earbud 104 is fully docked allows the wireless earbud 104 to maintain its relative position in the y-axis direction with respect to the base station 102, facilitating the docking process.

### Space for Wireless Earbud's Ear Portion

In some embodiments, the base station 102 is shaped such that a space is formed on the opposing side of the guide surface on the base station 102 corresponding to the flat (planar) surface on the head portion of the wireless earbud 104. The space has a width in the x-axis direction that is substantially the same as the width of the ear portion of the wireless earbud 104 in the x-axis direction.

Wireless Earbud's Ear Portion does not Touch Base Station

In some embodiments, the ear portion of the wireless earbud 104 is not in contact with any part of the base station 102 when the wireless earbud 104 is fully docked. In other embodiments, the widest portion of the ear portion of the wireless earbud 104 in the x-axis direction is not in contact with any part of the base station 102 when the wireless earbud 104 is fully docked.

Alignment of Wireless Earbud's Ear Portion when Fully Docked

When the wireless earbud 104 is fully docked, the portion of the ear portion of the wireless earbud 104 that is farthest away from the base station connectors in the x-axis direction is substantially aligned with the portion of the docking arms 113 that is farthest away from the base station connectors in the x-axis direction. In some embodiments, when the wireless earbud 104 is fully docked, the portion of the ear portion of the wireless earbud 104 that is farthest away from the base station connectors in the x-axis direction is substantially on the same y-z plane as the portion of the docking arms 113 that is farthest away from the base station connectors in the x-axis direction.

### Thickness of Docking Arms

In some embodiments, the docking arms 113 have a thickness in the y-axis direction that is smaller than the thickness of the thinnest portion of the base station 102 in the y-axis direction excluding the docking arms 113. In some embodiments, the docking arms 113 constitute the thinnest portions of the base station 102 in the y-axis direction. By providing thinner docking arms 113 relative to the thickness of the base station 102 in the y-axis direction, the ear portion of the wireless earbud 104 may be positioned within the space adjacent to the base station 102 and the docking arms 113 when the wireless earbud 104 is docked to the base station 102.

### Earbud Connectors

The waist portion of the wireless earbud 104 may include connectors that correspond to the connectors provided in the docking bay 112 of the base station 102. The connectors on the wireless earbud 104 and the connectors on the base station 102 may be of the opposite gender. When fully docked in the correct position along the y-axis and at the correct angle along the z-axis, each connector (e.g., pogo pin/connector) of the wireless earbud 104 contacts its corresponding connector (e.g., pogo pin/connector) of the base station 102.

### Cross-Section of Earbud's Waist

The cross-section of the waist portion of the wireless earbud 104 may be substantially in the shape of a square or a rectangle. In some embodiments, the cross-section may include two pairs of parallel sides that face each other. For example, the side including the connectors may be opposite and parallel to a side including neither connectors nor recesses. In another example, the side including the connectors may be adjacent to two sides that each include a recess corresponding to the protrusion on the docking arms 113.

In some embodiments, the cross-section of the waist portion may be circular, elliptical, or oval. In other embodiments, the cross-section of the waist portion may include a side that is flat, includes the connectors, and is configured to face the bottom of the “U” of the docking arms 113 when docked to the base station 102, and the remaining portion of the waist portion may be round.

### Speaker

The base station 102 and/or the wireless earbud 104 may include one or more speakers for playing back sound data from another user device (e.g., primary device 200) paired with the personal wireless media station 100.

### LED Light Indicator

The base station 102 and/or the wireless earbud 104 may include LED light indicators for indicating information to the user by blinking or flashing light therefrom. For example, such LED light indicators may indicate that the battery level is low (e.g., by blinking in red) or that there is an unread message or a missed call (e.g., by lighting up).

### Microphone

The base station 102 and/or the wireless earbud 104 may include one or more microphones for capturing sound data and providing the captured sound data to the primary device 200 paired with the personal wireless media station 100.

### Other Components of Base Station

Although not shown in FIGS. 4 and 5, the base station 102 may include one or more additional buttons or sensors for receiving the user's input. Such buttons or sensors may include a power button, volume control button(s), touch sensitive button(s), function control button(s), or the like. The base station 102 may include a charging slot (not shown) into which a charging cable (not shown) for charging the personal wireless media station 100 may be inserted. The base station 102 may also include one or more other components that are not illustrated in FIGS. 4 and 5. Further, the base station 102 may include one or more additional wireless earbuds, clips, speakers, LED indicators, microphones, LCD screens, and/or base station connectors. In some embodiments, one or more of the components shown in FIGS. 4 and 5 may be omitted. Further, the base station 102 may include a Bluetooth module (or other communication module) to connect with a mobile device (e.g., primary device 200) and/or a Bluetooth module (or other communication module) to connect with the wireless earbud 104.

### Example Architecture of Personal Wireless Media Station

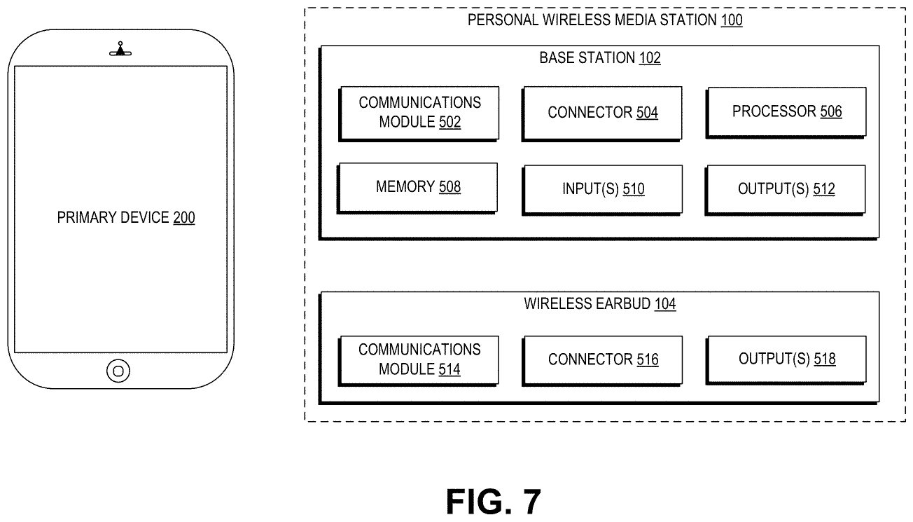

FIG. 7 illustrates a block diagram of a personal wireless media station 100, according to an example embodiment. As shown in FIG. 7, the personal wireless media station 100 is wirelessly connected to the primary device 200 and includes the base station 102 and the wireless earbud 104.

### Example Components of Base Station

As shown in FIG. 7, the base station 102 includes a communications module 502, a base station connector 504, a processor 506, a memory 508, input(s) 510, and output(s) 512. The processor 506 may include one or more processors. The memory 508 may be a volatile memory, a non-volatile memory, or a combination thereof. The input(s) 510 may include one or more microphones, mechanical buttons, touch-sensitive buttons, switches, etc. The output(s) 512 may include one or more speakers, display surfaces, light indicators, etc. As shown in FIG. 7, the base station 102 communicates with the primary device 200 including a mobile application 202 and the wireless earbud 104 including a communications module 514 and output(s) 516.

### Example Components of Earbud

As shown in FIG. 7, the wireless earbud 104 includes a communications module 514, an earbud connector 516, and output(s) 516. The output(s) 516 may include one or more speakers, display surfaces, light indicators, etc. Although not illustrated in FIG. 7, the wireless earbud 104 may include one or more inputs such as microphones, mechanical buttons, touch-sensitive buttons, switches, etc.

### Communications Module

The communication modules 502 and 514 may be Bluetooth modules configured to establish Bluetooth connections with each other and/or with the primary device 200. Although Bluetooth is used as an example, any other wireless protocols may be used to establish wireless connections between the base station 102 and the wireless earbud 104 and/or between the personal wireless media station 100 and the primary device 200.

### Connectors

The connectors 504 and 516 may be pogo pins/connectors of opposite gender. Once electrically connected, the connectors 504 and 516 allow the base station 102 and the wireless earbud 104 to transmit and receive data to and from each other. The data transmission may be two way (e.g., the wireless earbud 104 transmits data to the base station 102 via the connectors, and the base station 102 transmits data to the wireless earbud 104) or one way (e.g., the wireless earbud 104 transmits data to the base station 102 via the connectors but the base station 102 does not or cannot transmit data to the wireless earbud 104, or the base station 102 transmits data to the wireless earbud 104 via the connectors but the wireless earbud 104 does not or cannot transmit data to the base station 102). Although pogo pins/connectors are used as examples, other connectors such as the 3.5 mm jack or other types of connectors.

### Processor

The processor 506 may receive data and instructions from other computing systems via the communications module 502. Further, the processor 506 may store data in the memory 508 or retrieve data from the memory 508. The processor 506 may process input data received by the input(s) 510, and provide output data to the output(s) 512. Further, the processor 506 may perform one or more techniques described herein regarding the process of providing and/or redirecting sound playback. For example, the processor 506 may, via one or more sensors or detectors, detect whether the earbud connector of the wireless earbud 104 is connected to the base station connector of the base station 102. Based on whether or not the earbud connector of the wireless earbud 104 is connected to the base station connector of the base station 102, the processor 506 may cause different output(s) (e.g., the speaker on the base station 102 or the speaker on the wireless earbud 104) to play back the sound based on the audio data received from the primary device 200.

### Software

The base station 102 may include software or firmware that, when executed by the processor 506, configures the base station 102 to perform one or more processes described herein.

### Memory

The memory 508 may store audio data transmitted from the primary device 200. In some embodiments, the memory 508 is a volatile memory and only stores what is currently being transmitted and played back by the personal wireless media station 100. For example, all the data stored in the memory 508 may be lost shortly after use or upon power down of the personal wireless media station 100. In other embodiments, the memory 508 is a nonvolatile memory or a combination of volatile and nonvolatile memory. The memory 508 may include RAM, ROM and/or other persistent, auxiliary or non-transitory computer-readable media. The memory 508 may store computer program instructions to be executed by the processor 506 in the general administration and operation of the personal wireless media station 100. The memory 508 may further include computer program instructions and other data for implementing aspects of the present disclosure.

### Input(s)

The base station 102 may include one or more inputs (e.g., physical or digital buttons) that allow the user of the personal wireless media station 100 to enter various user commands. Such buttons or sensors may include a power button, volume control button(s), touch sensitive button(s), function control button(s), or the like. Although not illustrated in FIG. 7, the wireless earbud 104 may include one or more of the inputs described herein.

### Output(s)

The base station 102 may include one or more outputs for providing visual or audible information to the user. Such outputs may include one or more speakers, displays, LED indicators, and the like. The speaker may be configured to play sound received from the primary device 200. The sound played via the speaker may be a telephone conversation, a song, a voice recording, an alarm, etc. The display may include one or more display screens that display, e.g., under the control of the processor 506, the data processed by the processor 506. The data may include text, images, or other visual content. For example, the display may be provided on a side surface of the base station 102 as shown in FIG. 4A. The one or more display screens can be any of various conventional displays such as a liquid crystal display (LCD), a light-emitting diode (LED) display, an organic light-emitting diode (OLED) display, etc., or any other display means to be developed in the future. In certain embodiments, the display is a color display. In other embodiments, the display is not a color display but is grayscale. Although not illustrated in FIG. 7, the wireless earbud 104 may include one or more of the outputs described herein.

### Mobile Phone Application

The primary device 200 may have a mobile application 202 installed thereon for configuring the personal wireless media station 100. For example, the mobile application may be configured to set and monitor the Bluetooth pairing with the personal wireless media station 100. The mobile application 202 may include a feature for finding a personal wireless media station within the communication range. The mobile application 202 may be used to monitor and control the various features of the personal wireless media station 100. The mobile application 202 may be configured to display (or cause the personal wireless media station 100 to display) a low battery warning based on the battery status of the personal wireless media station 100. The mobile phone may be configured to automatically transmit any audiovisual data that may otherwise be displayed on the mobile phone itself to the personal wireless media station 100 when the primary device 200 is paired with the personal wireless media station 100. The mobile application 202 may also receive audio data and image data captured by the personal wireless media station 100 and store the data in a memory (not shown) of the primary device 200.

### Other Components of Personal Wireless Media Station

The base station 102 and the wireless earbud 104 of the personal wireless media station 100 are not limited to the configuration illustrated in FIG. 7, and may include one or more other components. For example, the base station 102 may include a camera module configured to capture image data. Such a camera module may communicate with the processor 506 to cause the captured image data to be transmitted to the primary device 200 (e.g., via the communications module 502).

### Providing and Redirecting Sound Playback

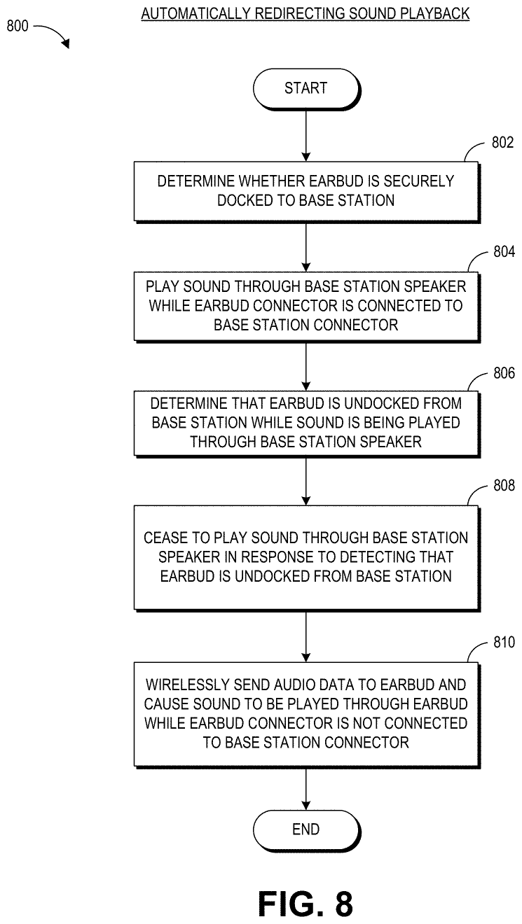

Referring to FIGS. 8-12, example methods of providing and redirecting sound playback are described. Depending on when and whether the wireless earbud 104 is docked to or undocked from the base station 102, different methods may be utilized to provide sound playback to the user.

### Automatic Redirecting Sound Playback

FIG. 8 is a flowchart for redirecting sound playback, according to an embodiment of the present invention. The steps illustrated in FIG. 8 may be performed by the personal wireless media station 100 of FIG. 7, or any components therein, or any other personal wireless media stations discussed herein or other devices (presently known or developed in the future) within the scope of the present disclosure. For convenience, method 800 is described as performed by the personal wireless media station 100.

### Determining Docking

At block 802, the personal wireless media station 100 determines whether the earbud 104 is securely docked to the base station 102. In embodiments, determining docking of the earbud 104 occurs in response to the user action for turning on the personal wireless media station 100 from its turned-off state or in response to the user's command for playing a sound recording or streaming sound from its state where no sound is played. Alternatively, determining docking of the earbud 104 occurs repeatedly and/or periodically while the personal wireless media station 100 is turned on. For example, the base station 102 periodically and repeatedly performs a routine to detect that the earbud 104 is docked. Alternatively, the earbud 104 periodically and repeatedly performs a routine to detect that the earbud 104 is docked. In yet other embodiments, determining docking of the earbud 104 occurs in response to receiving a signal that indicates docking. For example, the base station 102 waits for a signal from the earbud 104 (or a component within the base station 102) that indicates the earbud 104 has been docked. Alternatively, the earbud 104 waits for a signal from the base station 102 (or a component within the earbud 104) that indicates the earbud 104 has been docked. Other known or similar alternative methods of detecting the docking can also be used.

### Condition for Determining Docking

In embodiments, the personal wireless media station 100 (e.g., base station 102 or earbud 104) may determine whether or not the earbud 104 has been docked based on whether the base station and earbud connectors have been electrically connected or not. For example, the base station 102 determines docking of the earbud 104 based on detecting that the earbud connector is in electrical contact with the base station connector, and determines undocking of the earbud 104 based on detecting that the earbud connector is not in electrical contact with the base station connector. In other embodiments, the base station 102 includes at least one electro-mechanical sensor integrated with the locking device 114 for sensing docking of the earbud 104.

### Playing Sound on Base Station

At block 804, upon determining that the earbud 104 is docked to the base station 102, the personal wireless media station 100 plays sound through the speaker of the base station 102 while the earbud connector is connected to the base station connector. In embodiments, the base station 102 plays sound using audio data from the primary device 200 to which the personal wireless media station 100 is wirelessly connected. In some embodiments, the audio data come from the primary device 200 directly. In other embodiments, the audio data come from the primary device 200 via the earbud 104 which wirelessly communicates with the primary device 200 and communicates with the base station 102 via the connectors.

### Detecting Earbud Undocked

At block 806, the personal wireless media station 100 determines that the earbud 104 is undocked from the base station 102 while sound is being played on the base station 102. In embodiments, determining undocking of the earbud 104 is performed in the same or similar manner as for determining docking of the earbud 104. In embodiments, determining undocking of the earbud 104 occurs in response to the user action for turning on the personal wireless media station 100 from its turned-off state or in response to the user's command for playing a sound recording or streaming sound from its state where no sound is played. Alternatively, determining undocking of the earbud 104 occurs repeatedly and/or periodically while the personal wireless media station 100 is turned on. For example, the base station 102 periodically and repeatedly performs a routine to detect that the earbud 104 is undocked. Alternatively, the earbud 104 periodically and repeatedly performs a routine to detect that the earbud 104 is undocked. In yet other embodiments, determining undocking of the earbud 104 occurs in response to receiving a signal that indicates undocking. For example, the base station 102 waits for a signal from the earbud 104 (or a component within the base station 102) that indicates the earbud 104 has been undocked. Alternatively, the earbud 104 waits for a signal from the base station 102 (or a component within the earbud 104) that indicates the earbud 104 has been undocked. Other known or similar alternative methods of detecting the undocking can also be used.

### Condition for Determining Undocking

In embodiments, the personal wireless media station 100 (e.g., base station 102 or earbud 104) may determine whether or not the earbud 104 has been undocked based on whether the base station and earbud connectors have been electrically disconnected or not. In other embodiments, the base station 102 includes at least one electro-mechanical sensor integrated with the locking device 114 for sensing undocking of the earbud 104.

### Ceasing to Play Sound on Base Station

At block 808, the personal wireless media station 100 ceases to play the sound it was playing through the speaker of the base station 102 in response to determining that the earbud 104 is undocked from its docked state.

### Playing Sound on Earbud

At block 810, along with ceasing to play sound on the base station 102, the earbud 104 takes over the task of playing the sound that the base station 102 was playing. In some embodiments, the base station 102 wirelessly sends audio data for the sound to the wireless earbud 104 for playing through the wireless earbud 104. In other embodiments, the base station 102 wirelessly communicates to the primary device 200 to inform undocking of the earbud 104 and to request that the primary device 200 sends the audio data to the earbud 104 directly. In such embodiments, in response to the request, the primary device 200 wirelessly sends the audio data to the earbud 104 such that the earbud 104 plays the sound that the base station 102 has played and ceased to play.

No Action Other than Undocking for Redirecting to Earbud

As discussed above, there may be situations when the user may want to have a call or listen to the music privately using the wireless earbud 104. In such situations, the user can simply unplug the wireless earbud 104 from the base station 102 of the personal wireless media station 100, and the sound information received from the user device 206 automatically begins to be played back via the wireless earbud 104 without the user having to taking any actions (e.g., no actions to activate the wireless earbud 104 and wirelessly connect to the base station 102 or primary device 200) other than undocking the wireless earbud 104 from the base station 102.

### Initiating Sound Playback in Response to User Request

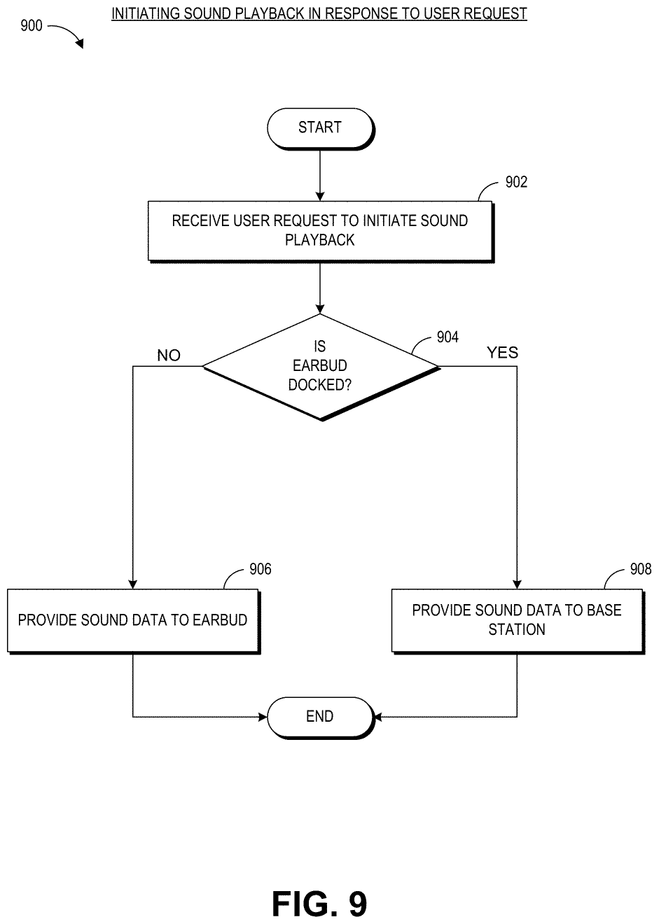

FIG. 9 is a flowchart for initiating sound playback, according to an embodiment of the present invention. The steps illustrated in FIG. 9 may be performed by the personal wireless media station 100 of FIG. 7, or any components therein, or any other personal wireless media stations discussed herein or other devices (presently known or developed in the future) within the scope of the present disclosure. For convenience, method 900 is described as performed by the personal wireless media station 100.

### User Request to Initiate Sound Playback

At block 902, the personal wireless media station 100 receives a user request to initiate sound playback. In embodiments, the user request may be received in response to the user pressing a button (either mechanical or digital) on the personal wireless media station 100 or the primary device 200 to accept an incoming call, to play a song, to play a voice message or voicemail, or to perform any other action that may involve providing sound playback. At block 904, the personal wireless media station 100 determines whether the wireless earbud 104 is docked to the base station 102. If the personal wireless media station 100 determines that the wireless earbud 104 is not docked to the base station 102, the method 900 proceeds to block 906. Otherwise, the method 900 proceeds to 908.

### Docking or Undocking Determination

In embodiments, determining whether the earbud 104 is docked or not is performed in the same or similar manner as discussed herein in connection with other embodiments. For example, the personal wireless media station 100 may determine whether or not the wireless earbud 104 is docked based on whether the base station and earbud connectors are electrically connected or not. In some embodiments, the determination of whether the base station and earbud connectors are electrically connected or not is made every time sound playback is initiated or requested. In other embodiments, the determination of whether the base station and earbud connectors are electrically connected or not is made periodically regardless of whether sound playback is initiated or requested. In other embodiments, the determination of whether the base station and earbud connectors are electrically connected or not is made in response to the docking or undocking of the wireless earbud 104. For example, when the wireless earbud 104 becomes docked or undocked, a signal or instruction may be sent to the processor 506 to make such a determination.

### Providing Sound Playback

At block 906, the personal wireless media station 100 provides sound playback through the speaker on the wireless earbud 104. At block 908, the personal wireless media station 100 provides sound playback through the speaker on the base station 102. The sound played back via the speaker may be an incoming voice call, music stored on the primary device 200, a voicemail received on the primary device 200, or any other voice data stored on the primary device 200 or the personal wireless media station 100.

### Variations

In the method 900, one or more of the blocks shown in FIG. 9 may be removed (e.g., not performed) and/or the order in which the method is performed may be switched. In some embodiments, additional blocks may be added to the method 900. For example, in some embodiments, block 904 may be omitted, and the sound playback may be automatically provided via the primary speaker. In some of such embodiments, the identity of the primary speaker may be updated only when the docking/undocking status is changed (i.e., upon docking and undocking of the wireless earbud 104). In some other such embodiments, the circuitry is configured such that the sound playback is automatically provided via the base station speaker if the wireless earbud 104 is docked and via the earbud speaker if the wireless earbud 104 is undocked. Thus, the embodiments of the present disclosure are not limited to or by the example shown in FIG. 9, and other variations may be implemented without departing from the spirit of this disclosure.

### Primary Device Sending Sound Data to Earbud

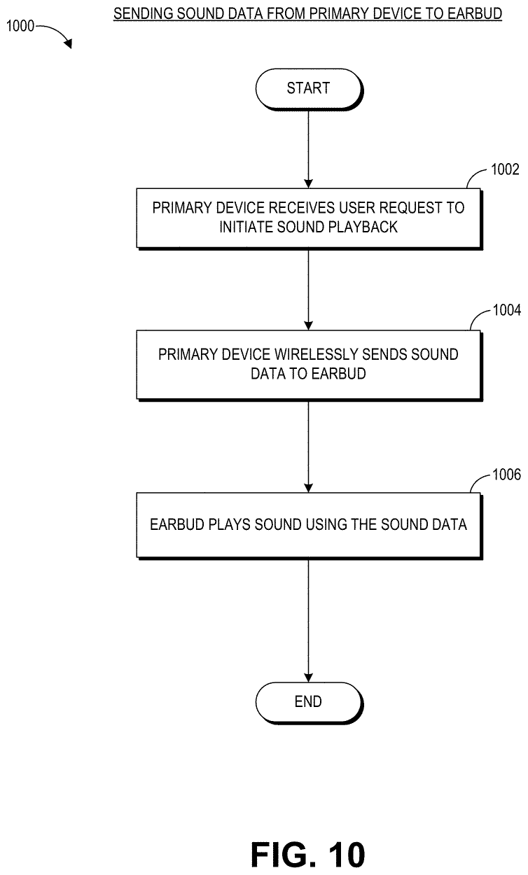

FIG. 10 is a flowchart for initiating sound playback, according to an embodiment of the present invention. The steps illustrated in FIG. 10 may be performed by the personal wireless media station 100 of FIG. 7, or any components therein, or any other personal wireless media stations discussed herein or other devices (presently known or developed in the future) within the scope of the present disclosure. For convenience, method 1000 is described as performed by the primary device 200.

### User Request to Initiate Sound Playback

At block 1002, the primary device 200 receives a user request to initiate sound playback. For example, the user request may be received in response to the user pressing a button (either mechanical or digital) on the personal wireless media station 100 or the primary device 200 to accept an incoming call, to play a song, to play a voice message or voicemail, or to perform any other action that may involve providing sound playback.

### Sending Sound Data to Earbud

At block 1004, in response to receiving the request to initiate sound playback, the primary device 200 wirelessly sends sound data to the wireless earbud 104. If needed, the primary device 200 established a wireless link with the earbud 104. In embodiments, on or before sending the sound data to the earbud 104, the primary device 200 does not make determination as to whether the earbud 104 is docked to or undocked from the base station 104.

### Playing Sound Via Earbud Speaker

At block 1006, in response to receiving the sound data, the earbud plays sound using the sound data from the primary device 200. The sound played back via the speaker may be an incoming voice call, music stored on the primary device 200, a voicemail received on the primary device 200, or any other voice data stored on the primary device 200 or the personal wireless media station 100.

Redirecting Sound Playback when Earbud Becomes Undocked

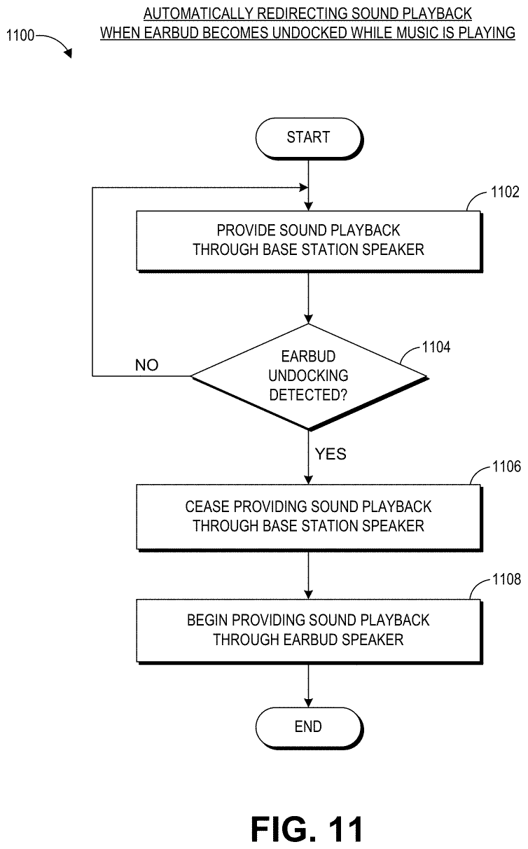

As discussed above, there may be situations when the user may want to have a voice call or listen to music privately using the wireless earbud 104. In such situations, the user can simply unplug the wireless earbud 104 from the base station 102, and the sound data received from the primary device 200 automatically begins to be played back via the speaker on the wireless earbud 104 without the user having to activate the wireless earbud 104 or press any button(s). Such an example is illustrated in FIG. 11.

Flowchart for Redirecting Sound Playback when Earbud Becomes Undocked

FIG. 11 is a flowchart for redirecting sound playback, according to an embodiment of the present invention. The steps illustrated in FIG. 11 may be performed by the personal wireless media station 100 of FIG. 7, or any components therein, or any other personal wireless media stations discussed herein or other devices (presently known or developed in the future) within the scope of the present disclosure. For convenience, method 1100 is described as performed by the personal wireless media station 100.

### Sound Playback Via Base Station Speaker

At block 1102, the personal wireless media station 100 provides sound playback through the base station speaker. The sound played back via the speaker may be an incoming voice call, music stored on the primary device 200, a voicemail received on the primary device 200, or any other voice data stored on the primary device 200 or the personal wireless media station 100.

### Undocking Determination

At block 1104, the personal wireless media station 100 determines whether the wireless earbud 104 has been undocked from the base station 102 while playing sound on the base station 102. If the personal wireless media station 100 determines that the wireless earbud 104 has been undocked from the base station 102, the method 1100 proceeds to block 1106. Otherwise, the method 1100 returns to block 1102, and the personal wireless media station 100 continues to provide sound playback through the base station speaker. The undocking determination may be performed using any of the techniques described herein (e.g., with reference to FIG. 8).

### Sound Playback Via Earbud Speaker

At block 1106, the base station 102 ceases or stops playing the sound in response to the determination that the earbud 104 has been undocked. At block 1108, the personal wireless media station 100 begins providing sound playback through the earbud speaker immediately after or substantially simultaneously with stopping to play on the base station 102. Here, immediately after or substantially simultaneously means within 0.01, 0.01, 0.1, 0.5, 1.0, 2.0, 3.0, or 5.0 seconds (or any other value between such values) from stoppage of playing sound on the base station 102 or from determination that the earbud 104 has been undocked.

### Variations

In the method 1100, one or more of the blocks shown in FIG. 11 may be removed (e.g., not performed) and/or the order in which the method is performed may be switched. In some embodiments, additional blocks may be added to the method 1100. For example, in some embodiments, block 1104 may be omitted, and the sound playback may be automatically provided via the primary speaker. In some of such embodiments, the circuitry is configured such that the sound playback is automatically provided via the base station speaker if the wireless earbud 104 is docked and via the earbud speaker if the wireless earbud 104 is undocked. Thus, the embodiments of the present disclosure are not limited to or by the example shown in FIG. 11, and other variations may be implemented without departing from the spirit of this disclosure.

Redirecting Sound Playback when Earbud Becomes Docked

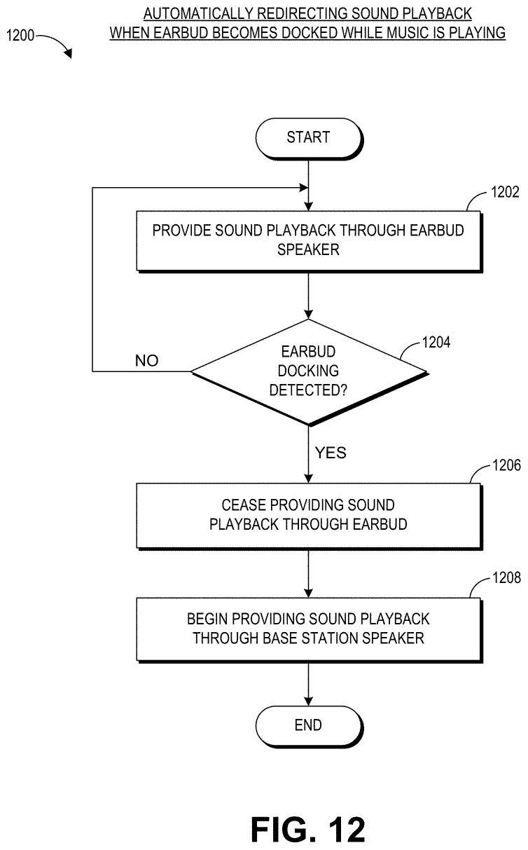

As discussed above, there may be situations when the user may want to use the base station speaker to listen to music after conducting a private voice call using the wireless earbud 104. In such situations, the user can simply plug the wireless earbud 104 back into the base station 102, and the sound data received from the primary device 200 automatically begins to be played back via the speaker on the base station 102 without the user having to activate the base station 102 or press any button(s). Such an example is illustrated in FIG. 12.

Flowchart for Redirecting Sound Playback when Earbud Becomes Docked

FIG. 12 is a flowchart for redirecting sound playback, according to an embodiment of the present invention. The steps illustrated in FIG. 12 may be performed by the personal wireless media station 100 of FIG. 7, or any components therein, or any other personal wireless media stations discussed herein or other devices (presently known or developed in the future) within the scope of the present disclosure. For convenience, method 1200 is described as performed by the personal wireless media station 100.

### Sound Playback Via Earbud Speaker

At block 1202, the personal wireless media station 100 provides sound playback through the speaker of the earbud 104. The sound played back via the speaker may be an incoming voice call, music stored on the primary device 200, a voicemail received on the primary device 200, or any other voice data stored on the primary device 200 or the personal wireless media station 100.

### Docking Determination

At block 1204, the personal wireless media station 100 determines whether the wireless earbud 104 has been docked to the base station 102 while the sound is being played. In embodiments, determining docking of the earbud 104 is performed in the same or similar manner as used for determining undocking of the earbud 104. If the personal wireless media station 100 determines that the wireless earbud 104 has been docked to the base station 102, the method 1200 proceeds to block 1206. Otherwise, the method 1200 returns to block 1202, and the personal wireless media station 100 continues to provide sound playback through the earbud speaker. The docking determination may be performed using any of the techniques described herein (e.g., with reference to FIG. 8).

### Sound Playback Via Base Station Speaker

At block 1206, the personal wireless media station 100 ceases providing sound playback through the earbud speaker in response to the determination that the earbud 104 has been docked to the base station 102. At block 1208, the personal wireless media station 100 begins providing sound playback through the base station speaker immediately after or substantially simultaneously with stopping to play on the earbud 104. Here, immediately after or substantially simultaneously means within 0.01, 0.01, 0.1, 0.5, 1.0, 2.0, 3.0, or 5.0 seconds (or any other value between such values) from stoppage of playing sound on the earbud 104 or from determination that the earbud 104 has been docked.

### Variations

In the method 1200, one or more of the blocks shown in FIG. 12 may be removed (e.g., not performed) and/or the order in which the method is performed may be switched. In some embodiments, additional blocks may be added to the method 1200. For example, in some embodiments, block 1204 may be omitted, and the sound playback may be automatically provided via the primary speaker. In some of such embodiments, the circuitry is configured such that the sound playback is automatically provided via the base station speaker if the wireless earbud 104 is docked and via the earbud speaker if the wireless earbud 104 is undocked. Thus, the embodiments of the present disclosure are not limited to or by the example shown in FIG. 12, and other variations may be implemented without departing from the spirit of this disclosure.

Pairing with Primary Device

In some embodiments, the base station 102 and the wireless earbud 104 are separately and individually paired with the primary device 200 for communication. In some other embodiments, the base station 102 is solely paired with the primary device 200 (e.g., the wireless earbud 104 is not paired with the primary device 200) and relays the data received from the primary device 200 to the wireless earbud 104. In some other embodiments, the wireless earbud 104 is solely paired with the primary device 200 (e.g., the base station 102 is not paired with the primary device 200) and relays the data received from the primary device 200 to the base station 102. In some of such embodiments, the relayed data is limited to audio data.

### Exclusive Pairing Between Primary Device and Base Station

In some embodiments, the base station 102 is solely paired with the primary device 200, with no other device paired with the primary device 200. If the wireless earbud 104 (or any other device) was paired with the primary device 200 prior to the pairing of the base station 102 and the primary device 200, the pairing between the wireless earbud 104 and the primary device 200 (and any other pairings) would be terminated upon the pairing of the base station 102 and the primary device 200.

### Exclusive Pairing Between Primary Device and Earbud

In some embodiments, the wireless earbud 104 is solely paired with the primary device 200, with no other device paired with the primary device 200. If the base station 102 (or any other device) was paired with the primary device 200 prior to the pairing of the wireless earbud 104 and the primary device 200, the pairing between the base station 102 and the primary device 200 (and any other pairings) would be terminated upon the pairing of the wireless earbud 104 and the primary device 200.

### Primary and Secondary Paired Devices

In some embodiments, the primary device 200 designates the wireless earbud 104 as the primary paired device and the base station 102 as the secondary paired device. In other embodiments, the primary device 200 designates the base station 102 as the primary paired device and the wireless earbud 104 as the secondary paired device

### Adjusting Volume Using Volume Control Buttons

While playing sound on the personal media player 100, the volume control buttons adjust volume of playing sound on either of the base station 102 and earbud 104. When the earbud 104 is docked to the base station 102, and sound is being played on the base station 102, the personal media player 100 is programmed to adjust volume of the speaker of the base station 102 by pressing volume control buttons. On the other hand, when the earbud 104 is undocked from the base station 102, and sound is being played on the earbud 104, the personal media player 100 is programmed to adjust volume of the speaker of the earbud 104 by pressing volume control buttons.

### Adjusting Scrolling Speed

If the volume control buttons are activated while content is being displayed on the display surface 106 in scrolling display mode, the scrolling speed is adjusted.

### Displaying Previous or Next Page

If the volume control buttons are activated while content is being displayed in page display mode, the next or previous page of the content (e.g., text or email) is displayed. For example, if the (+) button is pressed while an email is being displayed in page display mode, the next page/portion of the email is displayed, and if the (−) button is pressed while an email is being displayed in page display mode, the previous page/portion of the email is displayed.

### Silent Mode

For example, upon detecting that the (−) volume button is pressed for a threshold period of time (e.g., 1 second, 2 seconds, 3 seconds, or any other duration), silent mode may be activated, and upon detecting that the (+) volume button is pressed for a threshold period of time (e.g., 1 second, 2 seconds, 3 seconds, or any other duration), silent mode may be deactivated (i.e., normal mode is activated). In silent mode, the speaker of the base station 102 may be disabled. Alternatively, in silent mode, both the speaker of the base station 102 and the LED light indicator of the base station 102 may be disabled.

### Displaying Previous or Next Message

Upon detecting that the volume control button is pressed within a threshold time period after being pressed, the personal wireless media station 100 may cause the next text or email or the previous text or email to be displayed on the display surface 106. For example, upon detecting that the (−) volume button is pressed within a threshold time period (e.g., 0.5 seconds, 1 second, or any other duration) after being pressed, the personal wireless media station 100 may cause the previous text or email to be displayed on the display surface 106, and upon detecting that the (+) volume button is pressed within a threshold time period (e.g., 0.5 seconds, 1 second, or any other duration) after being pressed, the personal wireless media station 100 may cause the next text or email to be displayed on the display surface 106.

### Voice Commands Using Function Control Button

Voice commands or voice-controlled interface (e.g., Siri) may be activated when the function control button is pressed and held for a threshold period of time (e.g., 1 second, 2 seconds, 3 seconds, or any other duration). In some embodiments, if such voice commands or voice-controlled interface is disabled or not available, the most recent phone number in the call history may be dialed when the function control button is pressed and held for a threshold period of time (e.g., 1 second, 2 seconds, 3 seconds, or any other duration). In other embodiments, a user-defined task is performed instead of dialing the most recent phone number in the call history.

### Display Unread Text and Email Using Function Control Button

When there is an unread text or email, upon detecting that the function control button is pressed, the personal wireless media station 100 causes the unread text or email to be displayed on the display surface 106. After the text or email is displayed, if the function control button is pressed and there is no additional unread text or email, the personal wireless media station 100 may turn off the display surface 106. If there are additional unread texts and/or emails, upon detecting that the function control button is pressed again, the personal wireless media station 100 causes the next unread text or email to be displayed on the display surface 106.

### Answer or Terminate Voice Calls Using Function Control Button

When there is an incoming voice call, upon detecting that the function control button is pressed, the personal wireless media station 100 causes the call incoming call to be answered. When there is an active voice call, upon detecting that the function control button is pressed, the personal wireless media station 100 causes the active voice call to be terminated.

### Call Waiting Using Function Control Button

During an active voice call, if another incoming call is received, upon detecting that the function control button is pressed and held for a threshold period of time, the personal wireless media station 100 causes call waiting to be activated (e.g., the currently active voice call is placed on hold and the incoming voice call is answered). If the second call is terminated, the first call that was put on hold is automatically resumed. Upon detecting that the function control button is pressed and held for a threshold period of time while the second call is active and the first call is placed on hold, the personal wireless media station 100 causes the second call to be placed on hold and the first call to be resumed.

### Splitting of Text/Image Data and Audio Data

In some embodiments, the primary device 200 splits text/image data from audio data and sends text/images data to the base station 102 and the audio data to the wireless earbud 104 such that the base station 102 displays text and images and the wireless earbud 104 plays audio. In other embodiments, the primary device 200 sends text/image and audio data to the base station 102 and only audio data to the wireless earbud 104 such that the base station 102 displays text and images and the wireless earbud 104 plays audio, in which the base station 102 also has the ability to play the audio data.

### Operations: Earbud is Docked

In some embodiments, some or all components of the wireless earbud 104 are turned off or disabled when the wireless earbud 104 is docked to the base station 102. The battery of the wireless earbud 104 is charged when the wireless earbud 104 is docked to the base station 102.

Operation of Base Station Display when Earbud is Docked

When the wireless earbud 104 is docked to the base station 102, if an incoming call or an outgoing call is detected, the display surface 106 displays the caller/receiver data. When the wireless earbud 104 is docked to the base station 102, if a message (e.g., text, image, video, email message) is received, the display surface 106 displays the text/image associated with the received message. When the wireless earbud 104 is docked to the base station 102, when sound/music is being played, the display surface 106 displays data associated with the sound/music currently being played.

Operation of Base Station Microphone when Earbud is Docked

Upon detecting that the wireless earbud 104 is docked to the base station 102, the personal wireless media station 100 causes the microphone on the base station 102 to be automatically activated, if it has not been active or turned on.

Operation of Base Station Speaker when Earbud is Docked

Upon detecting that the wireless earbud 104 is docked to the base station 102, the personal wireless media station 100 causes the speaker on the base station 102 to be automatically activated if it has not been active or turned on.

Operation of Earbud Microphone when Earbud is Docked

Upon detecting that the wireless earbud 104 is docked to the base station 102, the personal wireless media station 100 causes the microphone on the wireless earbud 104 to be automatically disabled if it has been active or turned on. While the wireless earbud 104 is docked to the base station 102, the microphone on the wireless earbud 104 remains disabled. In some embodiments, the wireless earbud 104 does not have a microphone.

Operation of Earbud Speaker when Earbud is Docked

Upon detecting that the wireless earbud 104 is docked to the base station 102, the personal wireless media station 100 causes the speaker on the wireless earbud 104 to be automatically disabled if it has been active or turned on. While the wireless earbud 104 is docked to the base station 102, the speaker on the wireless earbud 104 remains disabled.

### Operations: Earbud is Undocked

In some embodiments, some or all components of the wireless earbud 104 are turned on or enabled when the wireless earbud 104 is undocked to the base station 102.

Operation of Base Station Display when Earbud is Undocked

When the wireless earbud 104 is undocked from the base station 102, if an incoming call or an outgoing call is detected, the display surface 106 displays the caller/receiver data. When the wireless earbud 104 is undocked from the base station 102, if a message (e.g., text, image, video, email message) is received, the display surface 106 displays the text/image associated with the received message. When the wireless earbud 104 is undocked from the base station 102, when sound/music is being played, the display surface 106 displays data associated with the sound/music currently being played. In some embodiments, the operation of the base station display when and while the wireless earbud 104 is undocked from the base station 102 is identical to the operation of the operation of the base station display when and while the wireless earbud 104 is docked to the base station 102.

Operation of Base Station Microphone when Earbud is Undocked

Upon detecting that the wireless earbud 104 is undocked from the base station 102, the personal wireless media station 100 causes the microphone on the base station 102 to be automatically disabled. In some embodiments, if the wireless earbud 104 does not have a microphone, the microphone on the base station 102 remains activated or enabled even after the wireless earbud 104 is undocked from the base station 102.

Operation of Base Station Speaker when Earbud is Undocked

Upon detecting that the wireless earbud 104 is undocked from the base station 102, the personal wireless media station 100 causes the speaker on the base station 102 to be automatically disabled. In some embodiment, upon detecting a user request to enable the base station speaker, the personal wireless media station 100 causes the base station speaker causes to be enabled or remain enabled even when the wireless earbud 104 is undocked from the base station 102.

Operation of Earbud Microphone when Earbud is Undocked

Upon detecting that the wireless earbud 104 is undocked from the base station 102, the personal wireless media station 100 causes the microphone on the wireless earbud 104 to be automatically activated or enabled. In some embodiment, upon detecting a user request to disable the earbud microphone, the personal wireless media station 100 causes the earbud microphone to be disabled or remain disabled even when the wireless earbud 104 is undocked from the base station 102

Operation of Earbud Speaker when Earbud is Undocked

Upon detecting that the wireless earbud 104 is undocked from the base station 102, the personal wireless media station 100 causes the speaker on the wireless earbud 104 to be automatically activated or enabled.

### No Microphone in Earbud

In some embodiments in which the wireless earbud 104 does not have a microphone, upon detecting that a voice call is initiated, the personal wireless media station 100 automatically causes the microphone of the base station 102 to become active to pick up the user's voice even while the wireless earbud 104 is undocked from the base station 102.

### Microphone in Earbud

In some embodiments in which the wireless earbud 104 includes a microphone, upon detecting that a voice call is initiated, the personal wireless media station 100 automatically causes the microphone of the wireless earbud 104 to become active to pick up the user's voice even while the earbud is undocked from the base station 102.

### Communication Between Primary Device and Personal Wireless Media Station

In one embodiment, the communications modules 502 and 514 each communicate with the primary device 200 but not with each other. In another embodiment, the communications modules 502 and 514 communicate with each other but only the communications module 502, and not the communications module 514, communicates with the primary device 200. In yet another embodiment, the communications modules 502 and 514 communicate with each other but only the communications module 514, and not the communications module 502, communicates with the primary device 200. In yet another embodiment, the communications modules 502 and 514 each communicate with the primary device 200 and also communicate with each other.

Only Base Station Communicates with Primary Device

In some embodiments, the communications modules 502 and 514 communicate with each other but only the communications module 502, and not the communications module 514, communicates with the primary device 200. In some of such embodiments, the communication between the communications modules 502 and 514 is one way (e.g., data is transmitted from the communications module 502 to the communications module 514). In other such embodiments, the communication between the communications modules 502 and 514 is two way (e.g., data is transmitted from the communications module 502 to the communications module 514 and also transmitted from the communications module 514 to the communications module 502).

Only Earbud Communicates with Primary Device

In some embodiments, the communications modules 502 and 514 communicate with each other but only the communications module 514, and not the communications module 502, communicates with the primary device 200. In some of such embodiments, the communication between the communications modules 502 and 514 is one way (e.g., data is transmitted from the communications module 514 to the communications module 502). In other such embodiments, the communication between the communications modules 502 and 514 is two way (e.g., data is transmitted from the communications module 502 to the communications module 514 and also transmitted from the communications module 514 to the communications module 502).

### Two-Way Wireless Module on Base Station

In some embodiments, the communications module 502 is a two-way wireless module. In such embodiments, the communications module 502 receives data from the primary device 200 as well as transmits data to the primary device 200. In some embodiments, the communications module 502 receives data from the wireless earbud 104 as well as transmits data to the wireless earbud 104. The communications module 502 may use the Bluetooth technology. However, the communications module 502 is not limited as such and may be implemented using any wireless communications standards currently available or developed in the future. For example, the data received from the primary device 200 and/or the wireless earbud 104 may include call data, caller data, sound data, text, voice, or video message data, and any other data that the user can directly (e.g., without the help of the personal wireless media station 100) access from the primary device 200. The data transmitted to the primary device 200 and/or the wireless earbud 104 may include user input data, recorded sound data, captured image data, and any other data that the user can directly (e.g., without the help of the personal wireless media station 100) provide to the primary device 200.

### One-Way Wireless Module on Base Station

In some embodiments, the base station 102 includes one or more one-way wireless modules. In such embodiments, such wireless modules transmit data to the primary device 200 and/or the wireless earbud 104 (e.g., to the communications module 514) but does not receive any data from the primary device 200 and/or the wireless earbud 104 (e.g., from the communications module 514). Such wireless modules may use the Bluetooth technology. However, such wireless modules are not limited as such and may be implemented using any wireless communications standards currently available or developed in the future. For example, the data transmitted to the wireless earbud 104 may include sound data or any other data that the user can directly (e.g., without the help of the wireless earbud 104) access from the base station 102 of the personal wireless media station 100. In some embodiments, the communications module 502 is a one-way wireless module that is configured to only transmit data. In some embodiments, the communications module 502 is a one-way wireless module that is configured to only receive data.

### Two-Way Wireless Module on Earbud

In some embodiments, the communications module 514 is a two-way wireless module. In such embodiments, the communications module 514 receives data from the primary device 200 as well as transmits data to the primary device 200. In some embodiments, the communications module 514 receives data from the base station 102 as well as transmits data to the base station 102. The communications module 502 may use the Bluetooth technology. However, the communications module 514 is not limited as such and may be implemented using any wireless communications standards currently available or developed in the future. For example, the data received from the primary device 200 and/or the base station 102 may include call data, caller data, sound data, text, voice, or video message data, and any other data that the user can directly (e.g., without the help of the personal wireless media station 100) access from the primary device 200. In some embodiments, the received data is limited to audio data. The data transmitted to the primary device 200 and/or the base station 102 may include user input data, recorded sound data, captured image data, and any other data that the user can directly (e.g., without the help of the personal wireless media station 100) provide to the primary device 200. In some embodiments, the transmitted data is limited to audio data.

### One-Way Wireless Module on Earbud

In some embodiments, the wireless earbud 104 includes one or more one-way wireless modules. In such embodiments, such wireless modules transmit data to the primary device 200 and/or the base station 102 (e.g., to the communications module 502) but does not receive any data from the primary device 200 and/or the base station 102 (e.g., from the communications module 502). Such wireless modules may use the Bluetooth technology. However, such wireless modules are not limited as such and may be implemented using any wireless communications standards currently available or developed in the future. For example, the data transmitted to the base station 102 may include sound data or any other data that the user can directly (e.g., without the help of the wireless earbud 104) access from the base station 102 of the personal wireless media station 100. In some embodiments, the communications module 514 is a one-way wireless module that is configured to only transmit data. In some embodiments, the communications module 514 is a one-way wireless module that is configured to only receive data.

### Detecting Docking and Undocking of Earbud

The base station connector may include a switch that is used for detecting whether the wireless earbud 104 has been docked to the base station 102. For example, such a switch may be switched on when an electrical connection is established between the base station and earbud connectors. Alternatively or additionally, the base station connector may include circuitry that measures the impedance and/or other characteristics of the connector (e.g., the earbud connector) that plugs into the base station connector. The base station connector may provide any measured data to the processor included in the personal wireless media station 100. Based on the state of the switch and/or the measured data, the processor 506 may provide the sound playback to either the base station speaker or the earbud speaker. For example, if the processor 506 determines that the switch is in a first state (or the measured data exceeds a threshold level), the processor 506 may cause the sound playback to be provided via the base station speaker, and if the processor 506 determines that the switch is in a second state different from the first state (or the measured data does not exceed the threshold level), the processor 506 may cause the sound playback to be provided via the earbud speaker.

### When to Check for Docking and Undocking of Earbud

In some embodiments, the processor 506 may periodically determine whether the base station and earbud connectors are electrically connected. In some embodiments, upon docking or undocking of the wireless earbud 104, a signal or instruction is sent to the processor 506, causing the processor 506 to determine whether the base station and earbud connectors are electrically connected. In some embodiments, the processor 506 does not check at all whether the base station and earbud connectors are electrically connected, and the sound playback is automatically redirected, based on the circuitry of the personal wireless media station 100, upon docking and undocking of the wireless earbud 104.

### Other Types of Connectors

In some embodiments, the base station pogo connectors and the earbud pogo connectors described herein may be replaced with other types of connectors. For example, the base station pogo connectors and the earbud pogo connectors may be replaced with a female 3.5 mm earphone socket and a male 3.5 mm earphone plug, respectively. As another example, any types of connectors that allow charging and detection of docked and undocked states of the wireless earbud 104 may be used.

### Incoming Text and Email Messages

The personal wireless media station 100 may allow the user to read texts and emails via the display surface 106, without having to maneuver the primary device 200. In some embodiments, when a new text or email arrives, data regarding the text or email is transmitted to the personal wireless media station 100 by the primary device 200. Based on the data received from the primary device 200, the personal wireless media station 100 may cause at least a portion of the content of the text or email on the display surface 106. For example, the display surface 106 may initially display a notification that a new text or email has arrived, and upon detecting a user input indicating that the user wishes to view the content of the text or email, display the beginning portion of the text or email.

### Scrolling

Once the beginning portion of the text or email is displayed on the display surface 106, the personal wireless media station 100 may continue to display the remaining portion of the text or email by scrolling the content across the display surface 106 (e.g., move the text displayed on the display surface 106 to the left at a specified speed, with the displayed text disappearing to the left end of the display surface 106 and new text appearing from the right end of the display surface 106).

### Jumping to Next Text or Email

The personal wireless media station 100 may cause the next text or email to be displayed if additional unopened texts or emails exist. For example, while a text or email is being displayed on the display surface 106, if the user provides a user input indicating that the user wishes to view the next text or email, the personal wireless media station 100 causes the beginning portion of the next text or email to be displayed on the display surface 106.

### Display Scrolling Speed

The user may control the speed at which the text is scrolled across the display surface 106, for example, by using the volume up and volume down buttons. Other buttons may be used to control the scrolling speed. For example, if the user slides his finger across the touch-sensitive button in one direction, the personal wireless media station 100 increases the scrolling speed, and if the user slides his finger across the touch-sensitive button in the other direction, the personal wireless media station 100 decreases the scrolling speed.

### Page Turning

In some embodiments, the personal wireless media station 100, after causing the beginning portion of the text or email on the display surface 106, awaits a user input indicating that the user wishes to view the next portion of the text or email. When the user provides such an input (e.g., by activating a button on the personal wireless media station 100), the personal wireless media station 100 causes the next portion of the text or email to be displayed on the display surface 106.

### Display Text Size

The user may control the size of the text displayed on the display surface 106, for example, by using the volume up and volume down buttons. Other buttons or combinations of buttons may be used to control the text size (e.g., function control button+volume up increases the text size and function control button+volume down decreases the text size).

### Incoming Telephone Call

In some embodiments, when a call is received on the primary device 200, the data regarding the call (e.g., data indicating who the caller is) is transmitted to the personal wireless media station 100, and based on the received data, the personal wireless media station 100 causes caller data to be displayed on the display surface 106. Additionally, the personal wireless media station 100 may provide an indication that a call is incoming via the base station speaker (or the earbud speaker if the wireless earbud 104 is undocked) by playing a sound, via the LED indicator by providing a blinking signal, or by vibrating the base station 102.

### Accepting an Incoming Telephone Call

While a call is incoming, the user may provide a user input to the personal wireless media station 100 to take the call. For example, the user may press the function control button to indicate that he wishes to take the call, and in response, the base station 102 may transmit the indication to the primary device 200 and cause the primary device 200 to take the call. During the call, the sound data is transmitted from the primary device 200 to the personal wireless media station 100 and the voice data captured by the base station microphone (or the earbud microphone if the wireless earbud 104 is undocked) is transmitted to the primary device 200. In some embodiments, if the wireless earbud 104 is undocked from the base station 102, the personal wireless media station 100 may further relay the sound data to the wireless earbud 104 to be played via the wireless earbud 104, and relay the captured voice data from the wireless earbud 104 to the primary device 200. In other embodiments, the wireless earbud 104 exchanges sound data and captured voice data with the primary device 200 directly without going through the base station 102.

### Black Box Feature

In embodiments, the personal wireless media station 100 includes a black box feature. For example, the personal wireless media station 100 may capture audio data or image data upon user activation of the black box feature. In some embodiments, the personal wireless media station 100 records audio data captured by the microphone in the background and/or records image or video data captured by a camera module (not shown) in the background. The recorded data may be transmitted to the primary device 200, and may be discarded after a specified period of time or after a specified amount of new data has been collected.

### Charging

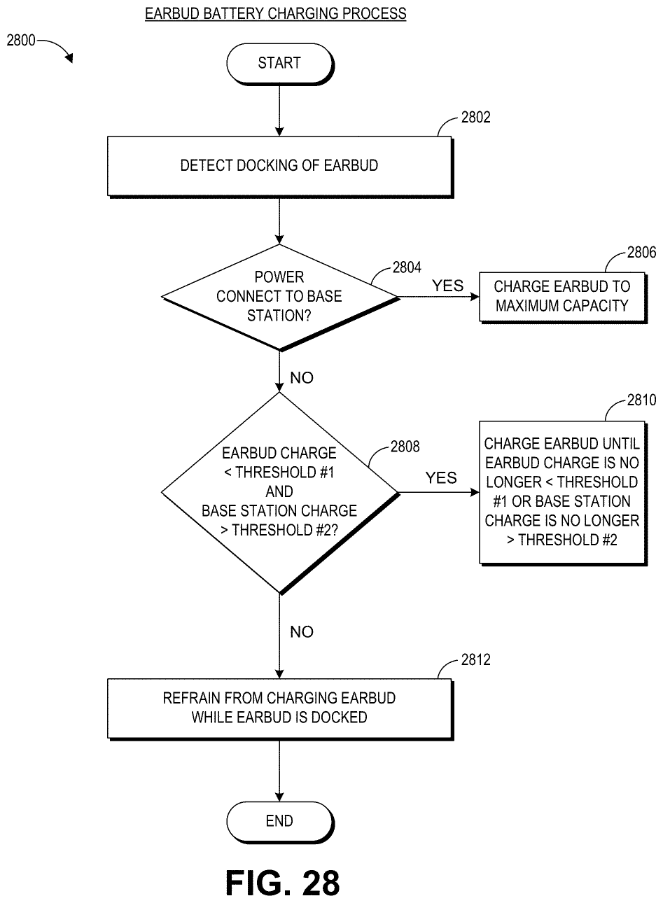

In embodiments, the base station 102 charges the wireless earbud 104 while the wireless earbud 104 is plugged into the base station 102. The base station 102 may be charged via a charge port (not shown in FIG. 3) using an external charging cable. When the wireless earbud 104 is plugged into the base station 102 for charging, the wireless communication between the base station 102 of the personal wireless media station 100 and the wireless earbud 104 may be turned off. Charging of the earbud 104 is described in greater detail below with reference to FIG. 28.

### No Storage

In embodiments, the personal wireless media station 100 does not have any storage (e.g., nonvolatile memory), and any data output by the personal wireless media station 100 is stored on volatile memory. For example, the personal wireless media station 100 may only stream sound without permanently storing any audio data on the personal wireless media station 100. In some embodiments, the audio data transmitted from the primary device 200 to the base station 102 is further transmitted and played via the wireless earbud 104. In other embodiments, the audio data transmitted from the primary device 200 to the wireless earbud 104 is further be transmitted and played via the base station 102. In other embodiments, the audio data transmitted from the primary device 200 to the wireless earbud 104 is played directly by the wireless earbud 104.

### Mechanical Clip or Necklace

In embodiments, as shown in FIG. 4A, the base station 102 includes a clip 116 that may be used to attach the personal wireless media station 100 to the user's clothing (e.g., shirt) or accessory (e.g., hat). The clip 116 may be integrated with the body and may include a spring plate that faces the rear surface of the body of the base station 102. In some embodiments, instead of or in addition to the clip 116, the base station 102 includes a necklace that may be used to hang the base station 102 from the user's neck.

### Watch

In embodiments, the personal wireless media station 100 includes a watch feature. For example, the display surface 106 may display the current time when the display surface 106 is idle, when the display surface 106 is not displaying data received from the primary device 200, or when the user presses one of the buttons of the personal wireless media station 100. The personal wireless media station 100 may further include an alarm function that plays an alarm indication at a specified time via a speaker, an LED indicator, and/or the display surface 106. In some embodiments, the user device 106 may transmit such an alarm indication to the personal wireless media station 100 at the specified time. In response to receiving the alarm indication, the personal wireless media station 100 causes the alarm indication to be output to the user via the speaker, the LED indicator, and/or the display surface 106.

### Camera

In embodiments, the personal wireless media station 100 includes a camera feature. The personal wireless media station 100 may capture images via a camera module, and the personal wireless media station 100 may transmit the captured images to the primary device 200 and cause the captured images to be stored in the primary device 200.

### Activating and Deactivating Voice Command Feature

In embodiments, the personal wireless media station 100 activates or deactivates the voice command feature of the primary device 200 based on a user input to the personal wireless media station 100. For example, the user may press a button provided on the personal wireless media station 100, and the button may be configured to generate a command to the primary device 200 wirelessly connected to the personal wireless media station 100 to turn on or turn off the voice command feature of the primary device 200. Other user inputs to the personal wireless media station 100 may be configured to activate or deactivate other features of the primary device 200.

Two-Way Communication with Wireless Earbud

In embodiments, the wireless earbud 104 is paired with the base station 102 of the personal wireless media station 100 using a two-way wired or wireless communication.

### Recording Telephone Calls

In embodiments, the personal wireless media station 100 records telephone calls. The recording may be initiated on the personal wireless media station 100 or the mobile application running on the primary device 200. The recording may be stored in cloud storage assigned to the registered user of the primary device 200 or the personal wireless media station 100. For example, the user may register his or her personal wireless media station 100 online (e.g., on the provider associated with the personal wireless media station 100 or any other provider of cloud storage services), and cloud storage may be provided to the user for use. The recording may have a file name including the name or the telephone number of the calling party initiating the telephone call.

### Finder Function

In embodiments, the mobile application 202 provides a signal or instruction to the personal wireless media station 100 to turn off all functions except for the finder function that allows the user to locate the personal wireless media station 100. When the finder function is activated, the personal wireless media station 100 may beep and the LED light indicator may blink.

### Display Current Date/Time and Battery Life

In embodiments, upon detecting that the function control button 110 is pressed, the personal wireless media station 100 displays the current date/time and/or the battery life of the personal wireless media station 100. In other embodiments, upon detecting that the function control button 110 is pressed, the personal wireless media station 100 displays the current date/time and/or the battery life of the personal wireless media station 100 only when there is no unread text and while no phone call/incoming phone ringing.

Automatically Turn Off Bluetooth while Charging

In embodiments, upon detecting that battery charging is initiated or active, the personal wireless media station 100 automatically turns off Bluetooth (or other wireless connection).

### New Earbud Pairing

In embodiments, upon receiving a user request to pair a new earbud, the mobile application 202 initiates pairing with the new earbud using the user-provided serial number of the new earbud.

### Bluetooth Priority

In embodiments, when multiple Bluetooth devices are available, the personal wireless media station 100 takes priority and connects to the primary device 200. For example, the mobile application 202 may configure the Bluetooth settings on the primary device 200 such that the personal wireless media station 100 has the highest priority.

### Water Resistance

In embodiments, the base station 102 and/or the wireless earbud 104 are water resistant. For example, one or both of the base station 102 and the wireless earbud 104 have a rating of IPX 4 or higher.

### Automatic Picture Taking

In embodiments, the base station 102 periodically takes pictures and store them in the base station 102 and/or transmit them to the primary device 200. In other embodiments, the base station 102 periodically takes pictures and store them in the base station 102 and/or transmit them to the primary device 200 only while the base station 102 is not being charged.

### Control Settings

Controllable settings may include one or more of earbud volume, text scrolling speed, text auto display on/off, display surface brightness, microphone input volume, speaker output volume, Siri or voice command on/off, LED light indicator on/off, automatic Bluetooth on/off, automatic sound recording on/off, automatic photo taking on/off, voice call recording on/off, and automatic file name generation on/off.

### Mobile App: Types

The mobile application 202 may have multiple versions: a free version, and a paid version that includes all the functionalities of the free version plus cloud storage. The paid app may include auto-naming feature for recorded data, where the automatically generated names include the caller IDs, etc.

### Ringtones

The wireless earbud 104 is capable of playing ringtones or ringtone-equivalents and media including music or any combination thereof. The base station 102 is capable of displaying text and images and playing ringtones or ringtone-equivalents and media including music and video or any combination thereof.

### Other Views and Embodiments of Personal Wireless Media Station

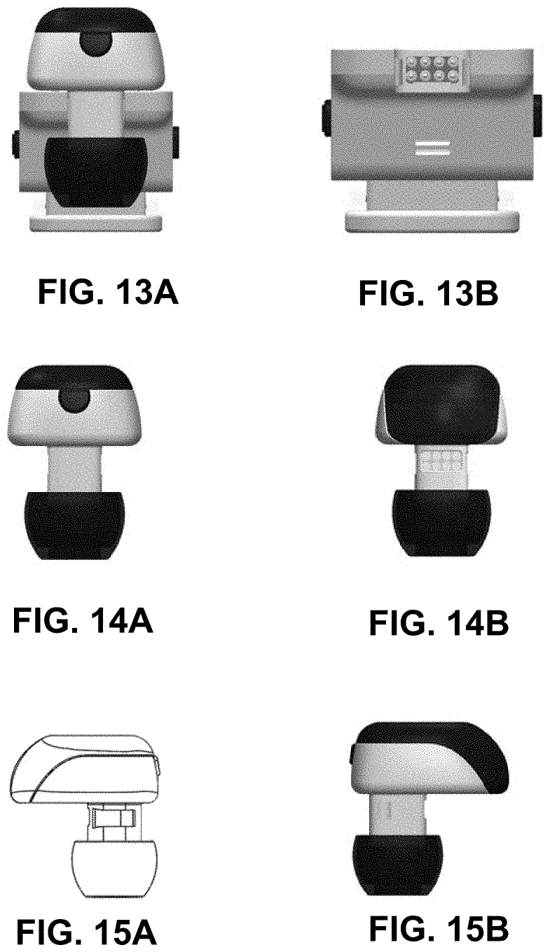

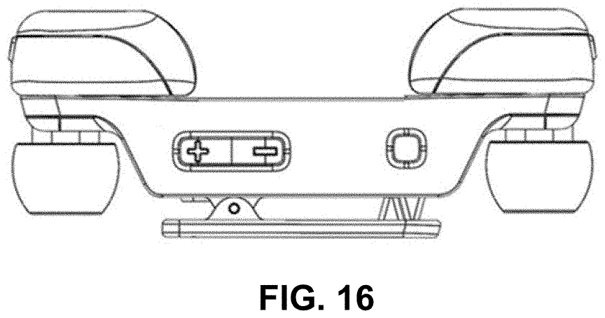

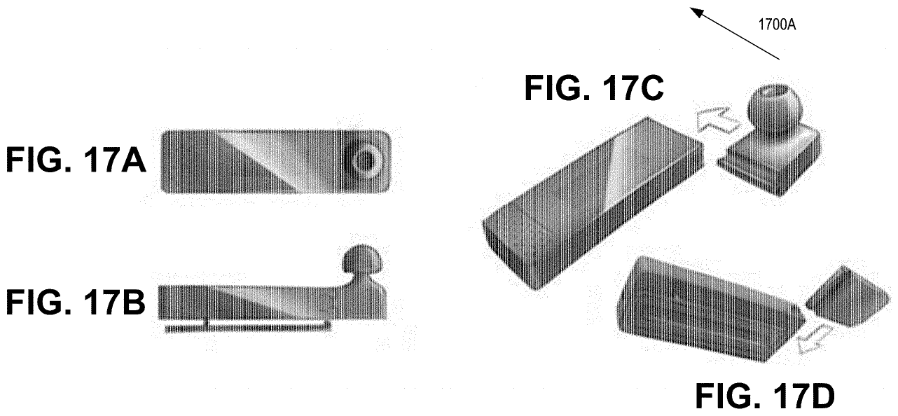

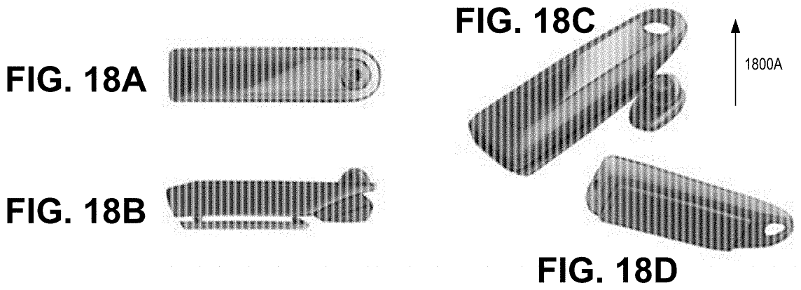

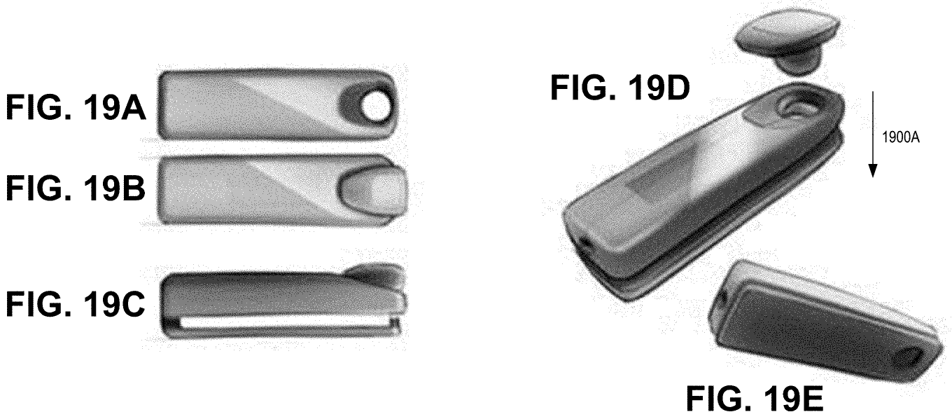

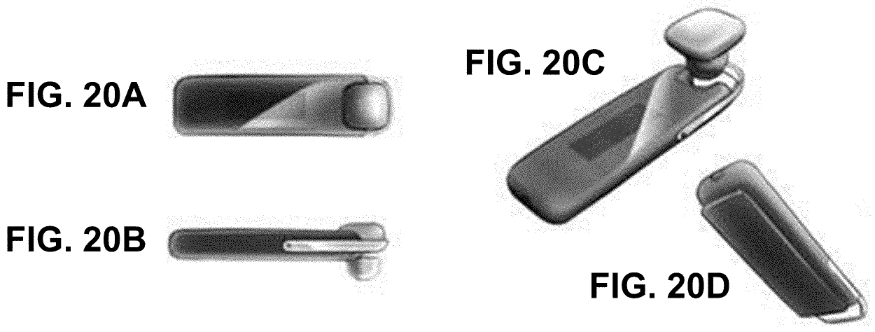

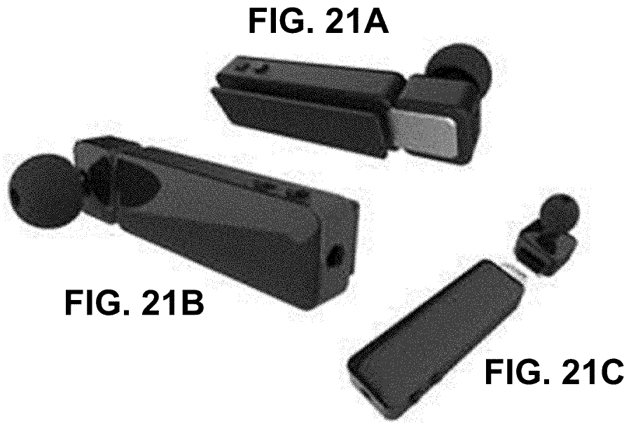

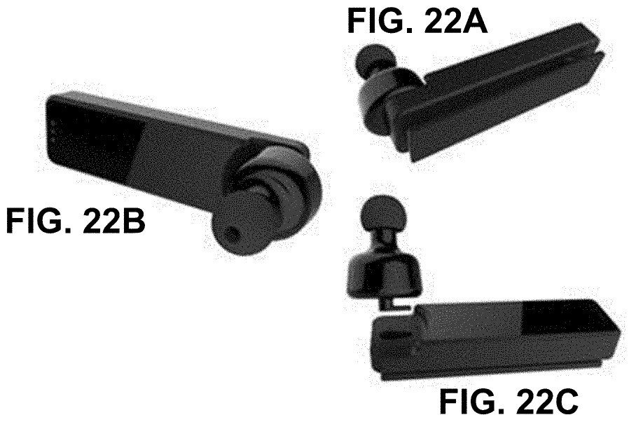

FIGS. 13-22 illustrate other views and embodiments of the personal wireless media station 100. FIGS. 13A-13F illustrate different views of the wireless earbud 104, according to an example embodiment. FIGS. 14 and 15 illustrate different views of the wireless earbud 104, according to an example embodiment. FIG. 16 illustrates a personal wireless media station 100 having multiple wireless earbuds docked to the base station, according to an example embodiment. FIGS. 17A-17D illustrate a personal wireless media station 100 having an alternative docking mechanism, according to an example embodiment. FIGS. 18A-18D illustrate a personal wireless media station 100 having an alternative docking mechanism, according to an example embodiment. FIGS. 19A-19E illustrate a personal wireless media station 100 having an alternative docking mechanism, according to an example embodiment. FIGS. 20A-20D illustrate a personal wireless media station 100 having an alternative docking mechanism, according to an example embodiment. FIGS. 21A-21C illustrate a personal wireless media station 100 having an alternative docking mechanism, according to an example embodiment. FIGS. 22A-22C illustrate a personal wireless media station 100 having an alternative docking mechanism, according to an example embodiment.

### Other Mechanical Embodiments

In addition to the examples described with reference to FIGS. 1-4, various example embodiments related to the operation of the personal wireless media station 100 are described below.

### Microphone on Wireless Earbud

In embodiments, the wireless earbud 104 includes a microphone. Additionally, in some of such embodiments, the base station 102 does not include a microphone.

### No Speaker on Base Station

In embodiments, the base station 102 does not include a speaker. In some of such embodiments, upon detecting the undocking of the wireless earbud 104, the personal wireless media station 100 causes an incoming voice call to be picked up, cause sound/music playback to be enabled, and/or cause other actions to be performed.

### Multiple Wireless Earbuds

As illustrated in FIG. 16, one or more additional earbuds can be docked on the base station 102 with additional sets of docking arms, connectors, and arm protrusions (locking device). Each additional earbud may include waist recessions corresponding to the arm protrusions.

### Additional Docking Embodiments

Following are additional embodiments of the invention providing docking (engaging)/undocking (disengaging) between the base station 102 and the wireless earbud 104 in which the base station 102 and the wireless earbud 104 become mechanically and electrically coupled when the wireless earbud 104 is fully docked (engaged).

### Additional Docking Embodiment #1

As illustrated in FIGS. 17A-17D, in some embodiments, the base station 102 has a sliding groove in either the y-axis direction or the z-axis direction (as defined herein). The wireless earbud 104 has a corresponding rail that fits snugly into the sliding groove on the base station 102. When the rail of the wireless earbud 104 has fully slid into the sliding groove on the base station 102 by moving the wireless earbud 104 in the docking direction 1700A, the base station 102 and the wireless earbud 104 are mechanically locked and electrically connected.

### Additional Docking Embodiment #2

As illustrated in FIGS. 18A-18D, in some embodiments, the base station 102 has a ring-like (donut-like) hole in either the y-axis direction or the z-axis direction (as defined herein). The wireless earbud 104 has a corresponding protruding ball-like ear portion that can be inserted into the hole in the base station 102. In one embodiment, the ear portion is inserted into the hole from the clip side to the display side of the base station 102 by moving the wireless earbud 104 in the docking direction 1800A. As illustrated in FIGS. 19A-19E, in another embodiment, the ear portion is inserted into the hole from the display side to the clip side of the base station 102 by moving the wireless earbud 104 in the docking direction 1900A. When the ear portion of the wireless earbud 104 is fully inserted into the hole of the base station 102, the head portion of the wireless earbud 104 mechanically snaps into the portion of the base station 102 surrounding the hole and facing the wireless earbud 104. When the ear portion of the wireless earbud 104 is fully inserted into the hole of the base station 102, the base station 102 and the wireless earbud 104 are mechanically locked and an electric connection is made between the base station 102 and the wireless earbud 104.

### Additional Docking Embodiment #3

As illustrated in FIGS. 20A-20D, in some embodiments, the base station 102 has a slit configured to receive the head portion of the wireless earbud 104, in which the head portion has a configuration to slide along the x-z plane and fit snugly in the slit. When the head portion of the wireless earbud 104 is fully inserted into the slit of the base station 102, the base station 102 and the wireless earbud 104 are mechanically locked and an electric connection is made between the base station 102 and the wireless earbud 104.

### Additional Docking Embodiment #4

As illustrated in FIGS. 21A-21C, in some embodiments, the base station 102 has a USB-male-like-plug configured for insertion along the x-axis (as defined herein). The wireless earbud 104 has a USB-female-like socket ear portion accepts the plug provided on the base station 102 in the x-axis direction. When the plug portion of the base station 102 is fully inserted into the socket portion of the wireless earbud 104, the base station 102 and the wireless earbud 104 are mechanically locked and an electric connection is made between the base station 102 and the wireless earbud 104. Alternatively, the wireless earbud 104 may include a plug portion, and the base station 102 may include a corresponding socket portion.

### Additional Docking Embodiment #5

As illustrated in FIGS. 22A-22C, in some embodiments, the wireless earbud 104 has a hook-like insertion piece located on the earbud's head portion. The base station 102 has a socket (cavity) that allows for insertion of the earbud's hook-like insertion piece along a first axis and sliding along second axis perpendicular to the first axis. When the insertion piece of the wireless earbud 104 is fully inserted and slid into the base station's socket, the insertion piece mechanically snaps into the locking mechanism located in the sockets of the base station 102. When the insertion piece of the wireless earbud 104 is fully inserted and slid into the base station's socket, the base station 102 and the wireless earbud 104 are mechanically locked and an electric connection is made between the base station 102 and the wireless earbud 104.

### Tables and Definitions

Tables 1-5, which are individually discussed below, illustrate various examples of device operations triggered by a user action or other change in the environment (e.g., a connectable Bluetooth speaker becoming available or unavailable). Each row in Tables 1-5 illustrates an example scenario involving the base station 102 and the earbud 104. The columns illustrate the following: “#” identifies the example number assigned to the given example scenario; “Device connection status prior to action” specifies whether and how the devices are connected before the triggering action is performed; “Audio being played prior to action” specifies whether and what kind of audio is being played before the triggering action is performed; “Device operation prior to action” specifies which device is performing what kind of operation before the triggering action is performed; “Action” specifies the triggering action performed; and “Device operation triggered by action” specifies which device is triggered to perform what kind of action in response to the triggering action being performed.

### Device Connection Status

In addition, in Tables 1-5, the following terms are, in example embodiments, defined as follows: “Undocked” refers to the state in which the earbud 104 is not connected (electrically and/or mechanically) to the base station 102; “Docked” refers to the state in which the earbud 104 is connected (electrically and/or mechanically) to the base station 102; “3P connected” refers to the state in which a third-party (i.e., other than the primary device 200 and the personal wireless media station 100) audio output device (such as a Bluetooth speaker, a Bluetooth office phone, a Bluetooth car stereo system, other stationary phones or speakers, etc.) is connected to the primary device 200 and/or the personal wireless media station 100 (e.g., the base station 102 and/or the earbud 104); and “3P not connected” refers to the state in which such a third-party audio output device is not connected to the primary device 200 and/or the personal wireless media station 100 (in one example, “3P not connected” refers to the state in which the only audio output device connected to the primary device 200 is the personal wireless media station 100 and no other third-party devices that can play audio playback are connected to the primary device 200).

Audio being Played Prior to Action

“Ringtone for incoming voice call” refers to a ringtone that is played to indicate that a voice call is incoming (e.g., another user is calling the phone number or user account associated with the primary device 200) that an incoming call has been accepted and the accepted call is being conducted by the user; “Call audio for current voice call” means that an incoming call has been accepted and the accepted call is being conducted by the user; “Non-call audio” means that sound is being played (e.g., via the earbud 104 or the base station 102) but the sound is not for a voice call (e.g., the sound may be a song, a music stream, a podcast, or other content with audio data); and “No audio” means that no sound is being played via the earbud 104 or the base station 102 (or that no sound is being received by the earbud 104 or the base station 102 from the primary device 200).

### Triggering Action

“Docking” refers to the earbud 104 becoming connected (electrically and/or mechanically) to the base station 102; “Undocking” refers to the earbud 104 becoming disconnected (electrically and/or mechanically) from the base station 102; “3P becomes discoverable” refers to a third-party audio output device becoming connectable or connected to the primary device 200 (or the personal wireless media station 100); “3P becomes undiscoverable” refers to such a third-party audio output device becoming disconnected from the primary device 200 (or the personal wireless media station 100); and “Button press” refers to a user input (e.g., via a mechanical or digital button) being received via the base station 102, the earbud 104, the primary device 200, or another third-party audio output device.

### Table #1: Docked to Undocked

Table 1 illustrates the changes in the device operations upon the user undocking the earbud 104 from the base station 102 in a variety of different scenarios. For example, example #2 of Table 1 illustrates the scenario in which the user undocks the earbud 104 from the base station 102 while a voice call is incoming to cause the incoming call to be accepted and played via the earbud 104. In this example, the user is driving in her car, and her smartphone is wirelessly connected to both the car speaker and the personal wireless media station 100 using Bluetooth. She then receives a phone call on her smartphone, and a ringtone begins to play on the car speaker. To accept the incoming call and conduct the phone call via the earbud 104, the user simply undocks the earbud 104 from the base station 102. Upon detecting the undocking of the earbud 104, the personal wireless media station 100 sends instructions to her smartphone to accept the incoming phone call and to direct the audio playback for the accepted phone call to the earbud 104 and not to the car speaker. Although not described in detail, each example in Table 1 illustrates the different operations caused by the undocking of the earbud 104 depending on (i) whether a third-party audio output device is connected to the primary device 200 and (ii) what kind of audio is playing at the time the undocking occurs.

TABLE 1
When the earbud 104 is undocked from the base station 102

| | | | Audio | | | |
|---|---|---|---|---|---|---|
| | | | being | | | |
| | Device connection | | played | | | |
| | status prior to | | prior to | Device operation | | Device operation |
| # | action | | action | prior to action | Action | triggered by action |
| 1 | Docked | 3P not | Ringtone | Ringtone played via | Undocking | Send instructions to |
| | | connected | for | base station | | primary device to |
| | | | incoming | speaker; caller ID | | accept incoming |
| | | | voice call | displayed via base | | call; begin providing |
| | | | | station display | | call audio via earbud |
| | | | | | | speaker (or do so |
| | | | | | | without sending |
| | | | | | | instructions to |
| | | | | | | primary device to |
| | | | | | | direct audio to |
| | | | | | | earbud) |
| 2 | Docked | 3P | Ringtone | Ringtone played via | Undocking | Send instructions to |
| | | connected | for | 3P speaker; caller | | primary device to |
| | | | incoming | ID displayed via | | accept incoming call |
| | | | voice call | base station display | | and to direct audio to |
| | | | | (alternatively or | | earbud; begin |
| | | | | additionally, caller | | providing call audio |
| | | | | ID displayed via 3P | | to earbud speaker |
| | | | | display) | | |
| 3 | Docked | 3P not | Call audio | Call audio provided | Undocking | Begin providing call |
| | | connected | for current | via base station | | audio to earbud |
| | | | voice call | speaker | | speaker (or do so |
| | | | | | | without sending |
| | | | | | | instructions to |
| | | | | | | primary device to |
| | | | | | | direct audio to |
| | | | | | | earbud) |
| 4 | Docked | 3P | Call audio | Call audio provided | Undocking | Send instructions to |
| | | connected | for current | via 3P speaker | | primary device to |
| | | | voice call | | | direct audio to |
| | | | | | | earbud; begin |
| | | | | | | providing call audio |
| | | | | | | to earbud speaker |
| 5 | Docked | 3P not | Non-call | Audio provided via | Undocking | Begin providing |
| | | connected | audio | base station speaker | | audio to earbud |
| | | | | | | speaker (or do so |
| | | | | | | without sending |
| | | | | | | instructions to |
| | | | | | | primary device to |
| | | | | | | direct audio to |
| | | | | | | earbud) |
| 6 | Docked | 3P | Non-call | Audio provided via | Undocking | Send instructions to |
| | | connected | audio | 3P speaker | | primary device to |
| | | | | | | direct audio to |
| | | | | | | earbud; begin |
| | | | | | | providing audio to |
| | | | | | | earbud speaker |
| 7 | Docked | 3P not | No audio | None | Undocking | None |
| | | connected | | | | |
| 8 | Docked | 3P | No | None | Undocking | Send instructions to |
| | | connected | audio | | | primary device to |
| | | | | | | direct audio to |
| | | | | | | earbud |

### Table #2: Undocked to Docked

Table 2 illustrates the changes in the device operations upon the user docking the earbud 104 to the base station 102 in a variety of different scenarios. For example, example #14 of Table 2 illustrates the scenario in which the user docks the earbud 104 to the base station 102 while listening to music to cause the music to be played via her Bluetooth car speaker. The user may have gotten into her car while listening to a song stored on her smartphone via the earbud 104. Once she starts the car, her smartphone may automatically connect to the car speaker using Bluetooth. Even though her smartphone is now connected to the car speaker, the song continues to be played via the earbud 104 because the earbud 104 is her preferred audio output device whenever the earbud 104 is undocked. If she decides to listen to the song via the car speaker, she can simply dock the earbud 104 to the base station 102. According to example #14 of Table 2, when the user docks the earbud 104 to the base station 102 while the car speaker is connected to her smartphone (“3P connected”) and while she is listening to music (“non-call audio”), the personal wireless media station 100 sends instructions to her smartphone to direct the audio playback to the car speaker, and subsequently begin playing the song via the car speaker instead of the earbud 104. Although not described in detail, each example in Table 2 illustrates the different operations caused by the docking of the earbud 104 depending on (i) whether a third-party audio output device is connected to the primary device 200 and (ii) what kind of audio is playing at the time the docking occurs.

TABLE 2
When the earbud 104 is docked to the base station 102

| | | | Audio | | | |
|---|---|---|---|---|---|---|
| | | | being | | | |
| | | | played | | | |
| | Device connection | | prior to | Device operation | | Device operation |
| # | status prior to action | | action | prior to action | Action | triggered by action |
| 9 | Undocked | 3P not | Ringtone | Ringtone played | Docking | Begin playing |
| | | connected | for | via earbud speaker; | | ringtone via base |
| | | | incoming | caller ID displayed | | station speaker |
| | | | voice call | via base station | | |
| | | | | display | | |
| 10 | Undocked | 3P | Ringtone | Ringtone played | Docking | Send instructions to |
| | | connected | for | via earbud speaker; | | primary device to |
| | | | incoming | caller ID displayed | | direct audio to 3P; |
| | | | voice call | via base station | | begin playing |
| | | | | display | | ringtone via 3P |
| | | | | (alternatively or | | speaker |
| | | | | additionally, caller | | |
| | | | | ID displayed via 3P | | |
| | | | | display) | | |
| 11 | Undocked | 3P not | Call audio | Call audio provided | Docking | Begin providing call |
| | | connected | for current | via earbud speaker | | audio via base |
| | | | voice call | | | station speaker (or |
| | | | | | | alternatively send |
| | | | | | | instructions to |
| | | | | | | primary device to |
| | | | | | | terminate the call) |
| 12 | Undocked | 3P | Call audio | Call audio provided | Docking | Send instructions to |
| | | connected | for current | via earbud speaker | | primary device to |
| | | | voice call | | | direct audio to 3P; |
| | | | | | | begin providing call |
| | | | | | | audio via 3P |
| | | | | | | speaker (or |
| | | | | | | alternatively send |
| | | | | | | instructions to |
| | | | | | | primary device to |
| | | | | | | terminate the call) |
| 13 | Undocked | 3P not | Non-call | Audio provided via | Docking | Begin providing |
| | | connected | audio | earbud speaker | | audio via base |
| | | | | | | station speaker |
| 14 | Undocked | 3P | Non-call | Audio provided via | Docking | Send instructions to |
| | | connected | audio | earbud speaker | | primary device to |
| | | | | | | direct audio to 3P; |
| | | | | | | begin providing |
| | | | | | | audio via 3P |
| | | | | | | speaker |
| 15 | Undocked | 3P not | No audio | None | Docking | None |
| | | connected | | | | |
| 16 | Undocked | 3P | No audio | None | Docking | Send instructions to |
| | | connected | | | | primary device to |
| | | | | | | direct audio to 3P |

### Table #3: Third-Party Wireless Device Becomes Discoverable

Table 3 illustrates the changes in the device operations upon a third-party audio output device becoming discoverable in a variety of different scenarios. For example, example #20 of Table 3 illustrates the scenario in which a Bluetooth car speaker becomes discoverable or connected to the primary device 200 while the user is conducting a voice call via the earbud 104. The user may have gotten into her car while having a phone call using the earbud 104. Once she starts the car, her smartphone may automatically connect to the car speaker using Bluetooth. Upon connecting to the car speaker, her smartphone continues to send audio data for the phone call to the earbud 104, rather than the car speaker. In some cases, her smartphone (i) sends audio data for the phone call to the earbud 104 if the user's preference setting indicates that she prefers to use the earbud 104 while the earbud 104 is undocked even when a car speaker is connected, and (ii) sends audio data for the phone call to the car speaker if the user's preference setting indicates that she prefers to use the car speaker even when the earbud 104 is undocked. According to example #20 of Table 3, when the car speaker becomes discoverable (e.g., turned on in a threshold wireless communication range or comes into the threshold wireless communication range), the user's smartphone connects to the car speaker and continues to provide the audio data for the phone call to the earbud 104. In some cases, the smartphone indicates to the personal wireless media station 100 that the car speaker is connected to the smartphone, and the personal wireless media station 100 sends instructions to the smartphone to provide the audio data for the phone call to the earbud 104 instead of the car speaker. Accordingly, the user can continue the phone call via the earbud 104 without any interruptions. Although not described in detail, each example in Table 3 illustrates the different operations caused by a third-party audio output device becoming discoverable, available, or connected depending on (i) whether the earbud 104 is docked to the base station 102 and (ii) what kind of audio is playing at the time the third-party audio output device becomes discoverable. In some cases, in the examples of Table 3, the primary device 200, upon detecting a third-party audio output device, queries the personal wireless media station 100 for its docking status, and if the earbud 104 is docked to the base station 102, the primary device 200 sends audio data to the earbud 104, and if the earbud 104 is not docked to the base station 102, the primary device 200 sends audio data to the third-party audio output device.

TABLE 3
When a third-party speaker becomes discoverable

| | | | Audio | | | |
|---|---|---|---|---|---|---|
| | | | being | Device | | |
| | | | played | operation | | |
| | Device connection | | prior to | prior to | | Device operation |
| # | status prior to action | | action | action | Action | triggered by action |
| 17 | Docked | 3P not | Ringtone | Ringtone | 3P becomes | Primary device |
| | | connected | for | played via | discoverable | connects to 3P (and |
| | | | incoming | base station | | optionally |
| | | | voice call | speaker; caller | | terminates |
| | | | | ID displayed | | connection to |
| | | | | via base | | earbud); begin |
| | | | | station display | | playing ringtone via |
| | | | | | | 3P speaker (or do so |
| | | | | | | after instructing |
| | | | | | | primary device to |
| | | | | | | direct audio to 3P) |
| 18 | Undocked | 3P not | Ringtone | Ringtone | 3P becomes | Primary device |
| | | connected | for | played via | discoverable | connects to 3P; |
| | | | incoming | earbud | | continue playing |
| | | | voice call | speaker; caller | | ringtone via earbud |
| | | | | ID displayed | | speaker (or do so |
| | | | | via base | | after instructing |
| | | | | station display | | primary device to |
| | | | | | | direct audio to |
| | | | | | | earbud) |
| 19 | Docked | 3P not | Call audio | Call audio | 3P becomes | Primary device |
| | | connected | for current | provided via | discoverable | connects to 3P (and |
| | | | voice call | base station | | optionally |
| | | | | speaker | | terminates |
| | | | | | | connection to |
| | | | | | | earbud); begin |
| | | | | | | providing call audio |
| | | | | | | via 3P speaker (or |
| | | | | | | do so after |
| | | | | | | instructing primary |
| | | | | | | device to direct |
| | | | | | | audio to 3P) |
| 20 | Undocked | 3P not | Call audio | Call audio | 3P becomes | Primary device |
| | | connected | for current | provided via | discoverable | connects to 3P; |
| | | | voice call | earbud | | continue providing |
| | | | | speaker | | call audio via earbud |
| | | | | | | speaker (or do so |
| | | | | | | after instructing |
| | | | | | | primary device to |
| | | | | | | direct audio to |
| | | | | | | earbud) |
| 21 | Docked | 3P not | Non-call | Audio | 3P becomes | Primary device |
| | | connected | audio | provided via | discoverable | connects to 3P (and |
| | | | | base station | | optionally |
| | | | | speaker | | terminates |
| | | | | | | connection to |
| | | | | | | earbud); begin |
| | | | | | | providing audio via |
| | | | | | | 3P speaker (or do so |
| | | | | | | after instructing |
| | | | | | | primary device to |
| | | | | | | direct audio to 3P) |
| 22 | Undocked | 3P not | Non-call | Audio | 3P becomes | Primary device |
| | | connected | audio | provided via | discoverable | connects to 3P; |
| | | | | earbud | | continue providing |
| | | | | speaker | | audio via earbud |
| | | | | | | speaker (or do so |
| | | | | | | after instructing |
| | | | | | | primary device to |
| | | | | | | direct audio to |
| | | | | | | earbud) |
| 23 | Docked | 3P not | No audio | None | 3P becomes | None (or instruct |
| | | connected | | | discoverable | primary device to |
| | | | | | | direct audio to 3P) |
| 24 | Undocked | 3P not | No audio | None | 3P becomes | None (or instruct |
| | | connected | | | discoverable | primary device to |
| | | | | | | direct audio to |
| | | | | | | earbud) |

### Table #4: Third-Party Wireless Device Becomes Undiscoverable

Table 4 illustrates the changes in the device operations upon a third-party audio output device becoming undiscoverable in a variety of different scenarios. For example, example #29 of Table 4 illustrates the scenario in which a Bluetooth car speaker connected to the user's smartphone becomes undiscoverable or turned off while the user is listening to music via the car speaker. The user may be driving and listening to a song streaming on her smartphone via the car speaker. Once she arrives at her destination, she may turn off the engine, which may cause the car speaker to also turn off. Upon detecting that the car speaker has disconnected, her smartphone begins sending audio data for the song streamlining on her smartphone to the personal wireless media station 100 instead of the car speaker. In some cases, her smartphone (i) sends audio data for the song to the personal wireless media station 100 if the user's preference setting indicates that she prefers to continue listening on the personal wireless media station 100 when the car speaker disconnects, and (ii) pauses the song if the user's preference setting indicates that she prefers not to continue listening to the audio playing via the car speaker when the car speaker disconnects. According to example #29 of Table 4, when the car speaker becomes undiscoverable (e.g., turns off or goes outside the threshold wireless communication range), the user's smartphone switches over to the personal wireless media station 100 that is already connected to the smartphone at the time the car speaker becomes undiscoverable and provides audio playback via the personal wireless media station 100. Alternatively, when the car speaker becomes undiscoverable, the smartphone may establish a wireless connection to the personal wireless media station 100 and begin providing, via the personal wireless media station 100, the audio that was previously being played via the car speaker. Accordingly, the user can continue listening to the music or conducting the phone call via the personal wireless media station 100 (e.g., the base station 102 or the earbud 104) without any interruptions when the car speaker disconnects. Although not described in detail, each example in Table 4 illustrates the different operations caused by a third-party audio output device becoming undiscoverable, unavailable, or disconnected depending on (i) whether the earbud 104 is docked to the base station 102 and (ii) what kind of audio is playing at the time the third-party audio output device becomes undiscoverable.

TABLE 4
When a third-party speaker becomes undiscoverable

| | | | Audio | | | |
|---|---|---|---|---|---|---|
| | | | being | | | |
| | | | played | Device | | Device operation |
| | Device connection | | prior to | operation | | triggered by |
| # | status prior to action | | action | prior to action | Action | action |
| 25 | Docked | 3P | Ringtone | Ringtone | 3P becomes | 3P is disconnected |
| | | connected | for | played via 3P | undiscoverable | from primary |
| | | | incoming | speaker; caller | | device (and |
| | | | voice call | ID displayed | | optionally |
| | | | | via base station | | establishes |
| | | | | display | | connection to |
| | | | | (alternatively or | | earbud); begin |
| | | | | additionally, | | providing ringtone |
| | | | | caller ID | | via base station |
| | | | | displayed via | | speaker (or do so |
| | | | | 3P display) | | after instructing |
| | | | | | | primary device to |
| | | | | | | direct audio to |
| | | | | | | personal wireless |
| | | | | | | media station, |
| | | | | | | base station, or |
| | | | | | | earbud) |
| 26 | Undocked | 3P | Ringtone | Ringtone | 3P becomes | 3P is disconnected |
| | | connected | for | played via | undiscoverable | from primary |
| | | | incoming | earbud speaker; | | device; continue |
| | | | voice call | caller ID | | providing ringtone |
| | | | | displayed via | | via earbud |
| | | | | base station | | speaker |
| | | | | display | | |
| | | | | (alternatively or | | |
| | | | | additionally, | | |
| | | | | caller ID | | |
| | | | | displayed via | | |
| | | | | 3P display) | | |
| 27 | Docked | 3P | Call | Call audio | 3P becomes | 3P is disconnected |
| | | connected | audio for | provided via 3P | undiscoverable | from primary |
| | | | current | speaker | | device (and |
| | | | voice call | | | optionally |
| | | | | | | establishes |
| | | | | | | connection to |
| | | | | | | earbud); begin |
| | | | | | | providing call |
| | | | | | | audio via base |
| | | | | | | station speaker (or |
| | | | | | | do so after |
| | | | | | | instructing |
| | | | | | | primary device to |
| | | | | | | direct audio to |
| | | | | | | personal wireless |
| | | | | | | media station, |
| | | | | | | base station, or |
| | | | | | | earbud) |
| 28 | Undocked | 3P | Call | Call audio | 3P becomes | 3P is disconnected |
| | | connected | audio for | provided via | undiscoverable | from primary |
| | | | current | earbud speaker | | device; continue |
| | | | voice call | | | providing call |
| | | | | | | audio via earbud |
| | | | | | | speaker |
| 29 | Docked | 3P | Non-call | Audio provided | 3P becomes | 3P is disconnected |
| | | connected | audio | via 3P speaker | undiscoverable | from primary |
| | | | | | | device (and |
| | | | | | | optionally |
| | | | | | | establishes |
| | | | | | | connection to |
| | | | | | | earbud); begin |
| | | | | | | providing audio |
| | | | | | | via base station |
| | | | | | | speaker (or do so |
| | | | | | | after instructing |
| | | | | | | primary device to |
| | | | | | | direct audio to |
| | | | | | | personal wireless |
| | | | | | | media station, |
| | | | | | | base station, or |
| | | | | | | earbud) |
| 30 | Undocked | 3P | Non-call | Audio provided | 3P becomes | 3P is disconnected |
| | | connected | audio | via earbud | undiscoverable | from primary |
| | | | | speaker | | device; continue |
| | | | | | | providing audio |
| | | | | | | via earbud |
| | | | | | | speaker |
| 31 | Docked | 3P | No audio | None | 3P becomes | None (or instruct |
| | | connected | | | undiscoverable | primary device to |
| | | | | | | direct audio to |
| | | | | | | personal wireless |
| | | | | | | media station, |
| | | | | | | base station, or |
| | | | | | | earbud) (primary |
| | | | | | | device optionally |
| | | | | | | establishes |
| | | | | | | connection to |
| | | | | | | earbud) |
| 32 | Undocked | 3P | No audio | None | 3P becomes | None |
| | | connected | | | undiscoverable | |

### Table #5: User Input Received

Table 5 illustrates the changes in the device operations upon detecting a user input (e.g., on the user's smartphone, the personal wireless media station 100, or a third-party audio output device) in a variety of different scenarios. For example, example #34 of Table 5 illustrates the scenario in which (i) the user's smartphone is connected to a Bluetooth car speaker and the personal wireless media station 100, (ii) the earbud 104 is docked to the base station 102, and (iii) a voice call is incoming at the user's smartphone. The user may have been listening to music via the car speaker while driving. Upon detecting an incoming phone call, the smartphone sends the audio data for the ringtone to the car speaker, alerting the user that a phone call is incoming. To accept the incoming phone call and conduct the phone call via the car speaker, the user presses a button on the personal wireless mediate station 100 clipped to her shirt. Upon detecting the button press, the personal wireless mediate station 100 sends instructions to the smartphone to accept the incoming phone call and to begin providing audio data for the accepted phone call to the car speaker instead of the personal wireless mediate station 100. Accordingly, the user can accept the incoming call using one audio output device (e.g., the personal wireless media station 100) and conduct the accepted call using another audio output device (e.g., the car speaker). Although not described in detail, each example in Table 5 illustrates the different operations caused by a user input being received at the personal wireless media station 100, the primary device 200, or a third-party audio output device depending on (i) whether the earbud 104 is docked to the base station 102, (ii) whether a third-party audio output device is connected to the primary device 200, and (ii) what kind of audio is playing at the time the user input is received.

TABLE 5
When a button is pressed

| | | | Audio | | | |
|---|---|---|---|---|---|---|
| | | | being | | | |
| | | | played | | | Device operation |
| | Device connection | | prior to | Device operation | | triggered by |
| # | status prior to action | | action | prior to action | Action | action |
| 33 | Docked | 3P not | Ringtone | Ringtone played via | Button | Send instructions to |
| | | connected | for | base station speaker; | press | primary device to |
| | | | incoming | caller ID displayed | | accept incoming |
| | | | voice call | via base station | | call; begin |
| | | | | display | | providing call audio |
| | | | | | | via base station |
| | | | | | | speaker |
| 34 | Docked | 3P | Ringtone | Ringtone played via | Button | Send instructions to |
| | | connected | for | 3P speaker; caller ID | press | primary device to |
| | | | incoming | displayed via base | | accept incoming |
| | | | voice call | station display | | call; begin |
| | | | | (alternatively or | | providing call audio |
| | | | | additionally, caller | | via 3P speaker |
| | | | | ID displayed via 3P | | |
| | | | | display) | | |
| 35 | Undocked | 3P not | Ringtone | Ringtone played via | Button | Send instructions to |
| | | connected | for | earbud speaker; | press | primary device to |
| | | | incoming | caller ID displayed | | accept incoming |
| | | | voice call | via base station | | call; begin |
| | | | | display | | providing call audio |
| | | | | | | via earbud speaker |
| 36 | Undocked | 3P | Ringtone | Ringtone played via | Button | Send instructions to |
| | | connected | for | earbud speaker; | press | primary device to |
| | | | incoming | caller ID displayed | | accept incoming |
| | | | voice call | via base station | | call; begin |
| | | | | display (alternatively | | providing call audio |
| | | | | or additionally, | | via earbud speaker |
| | | | | caller ID displayed | | |
| | | | | via 3P display) | | |
| 37 | Docked | 3P not | Call audio | Call audio provided | Button | Send instructions to |
| | | connected | for current | via base station | press | primary device to |
| | | | voice call | speaker | | terminate the call |
| 38 | Docked | 3P | Call audio | Call audio provided | Button | Send instructions to |
| | | connected | for current | via 3P speaker | press | primary device to |
| | | | voice call | | | terminate the call |
| 39 | Undocked | 3P not | Call audio | Call audio provided | Button | Send instructions to |
| | | connected | for current | via earbud speaker | press | primary device to |
| | | | voice call | | | terminate the call |
| 40 | Undocked | 3P | Call audio | Call audio provided | Button | Send instructions to |
| | | connected | for current | via earbud speaker | press | primary device to |
| | | | voice call | | | terminate the call |
| 41 | Docked | 3P not | Non-call | Audio provided via | Button | Send instructions to |
| | | connected | audio | base station speaker | press | primary device to |
| | | | | | | pause the audio (or |
| | | | | | | to move to the |
| | | | | | | beginning of the |
| | | | | | | current content or |
| | | | | | | move to the |
| | | | | | | previous or next |
| | | | | | | available content) |
| 42 | Docked | 3P | Non-call | Audio provided via | Button | Send instructions to |
| | | connected | audio | 3P speaker | press | primary device to |
| | | | | | | pause the audio (or |
| | | | | | | to move to the |
| | | | | | | beginning of the |
| | | | | | | current content or |
| | | | | | | move to the |
| | | | | | | previous or next |
| | | | | | | available content) |
| 43 | Undocked | 3P not | Non-call | Audio provided via | Button | Send instructions to |
| | | connected | audio | earbud speaker | press | primary device to |
| | | | | | | pause the audio (or |
| | | | | | | to move to the |
| | | | | | | beginning of the |
| | | | | | | current content or |
| | | | | | | move to the |
| | | | | | | previous or next |
| | | | | | | available content) |
| 44 | Undocked | 3P | Non-call | Audio provided via | Button | Send instructions to |
| | | connected | audio | earbud speaker | press | primary device to |
| | | | | | | pause the audio (or |
| | | | | | | to move to the |
| | | | | | | beginning of the |
| | | | | | | current content or |
| | | | | | | move to the |
| | | | | | | previous or next |
| | | | | | | available content) |
| 45 | Docked | 3P not | No audio | None | Button | Send instructions to |
| | | connected | | | press | primary device to |
| | | | | | | begin playing the |
| | | | | | | audio (e.g., paused |
| | | | | | | content or most |
| | | | | | | recently played |
| | | | | | | content) |
| 46 | Docked | 3P | No audio | None | Button | Send instructions to |
| | | connected | | | press | primary device to |
| | | | | | | begin playing the |
| | | | | | | audio (e.g., paused |
| | | | | | | content or most |
| | | | | | | recently played |
| | | | | | | content) |
| 47 | Undocked | 3P not | No | None | Button | Send instructions to |
| | | connected | audio | | press | primary device to |
| | | | | | | begin playing the |
| | | | | | | audio (e.g., paused |
| | | | | | | content or most |
| | | | | | | recently played |
| | | | | | | content) |
| 48 | Undocked | 3P | No audio | None | Button | Send instructions to |
| | | connected | | | press | primary device to |
| | | | | | | begin playing the |
| | | | | | | audio (e.g., paused |
| | | | | | | content or most |
| | | | | | | recently played |
| | | | | | | content) |

### Communication Among Primary Device, Base Station, and Earbud

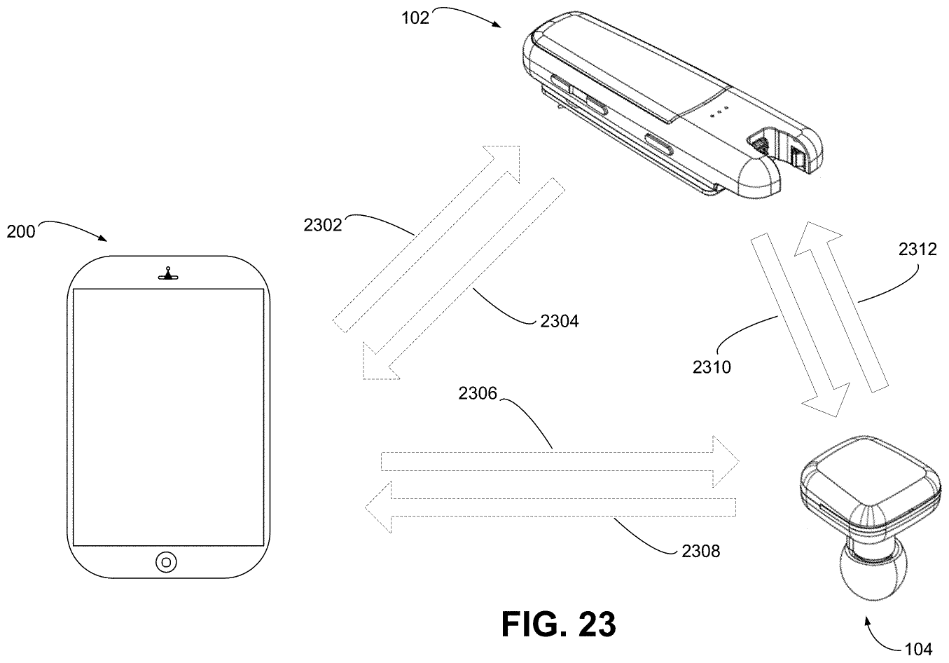

FIG. 23 illustrates an example of how primary device 200, base station 102, and earbud 104 communicate with each other. In embodiments, dashed arrows indicate communication over a wireless connection, and solid arrows indicate communication over a wired connection.

### Communication Between Primary Device and Base Station

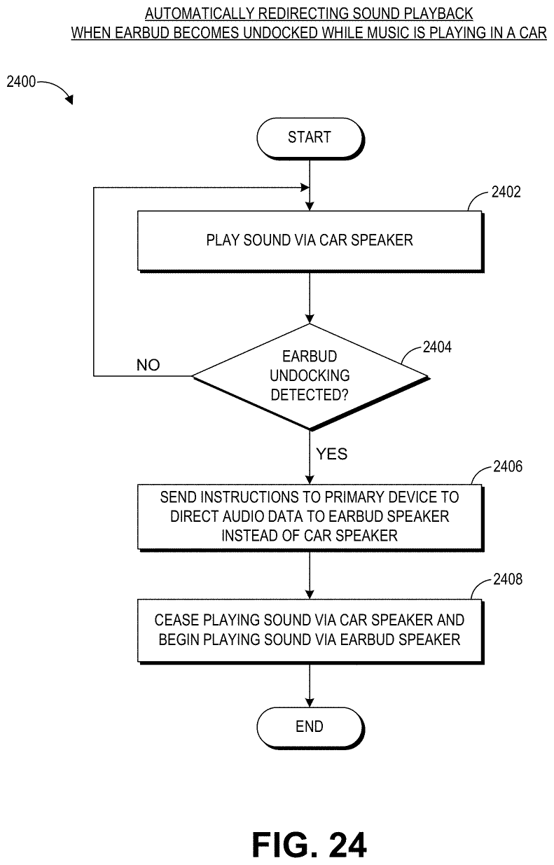

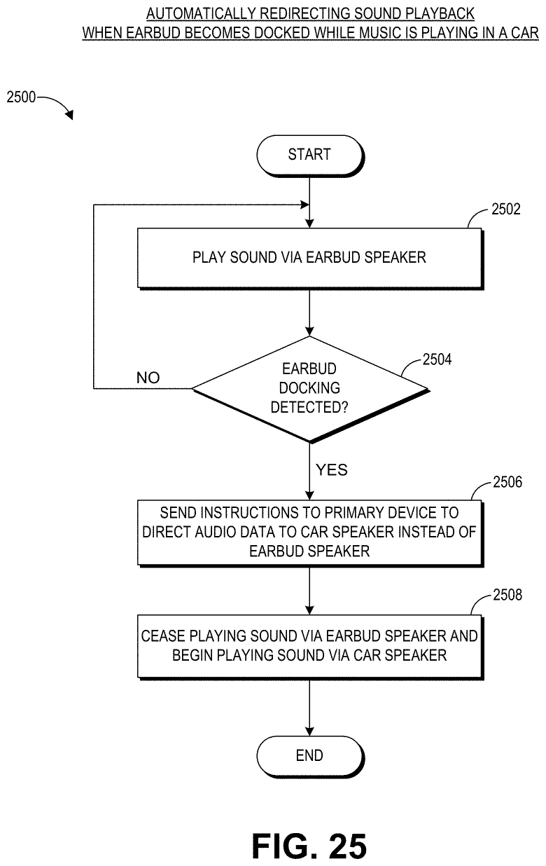

As indicated by the dashed arrows 2302 and 2304 in FIG. 23, primary device 200 and base station 102 can communicate over a wireless connection (e.g., using Bluetooth or other communications technologies). In embodiments, the information 2302 sent from primary device 200 to base station 102 includes call information, message information, email information, notification information, missed call information, music information, and/or the like. The information 2304 sent from base station 102 to primary device 200 may include instructions to pick up a call, reject a call, play music, change sound playback priority (e.g., as further described with reference to FIGS. 24 and 25), and/or the like. In some embodiments, primary device 200 and base station 102 communicate only over a wireless connection. In other embodiments, primary device 200 and base station 102 communicate both over a wireless connection and a wired connection.

### Communication Between Primary Device and Earbud

As indicated by the dashed arrows 2306 and 2308 in FIG. 23, primary device 200 and earbud 104 can communicate over a wireless connection (e.g., using Bluetooth or other communications technologies). In embodiments, the information 2306 sent from primary device 200 to earbud 104 includes call/message/email notification information, encoded audio data, and/or the like. The information 2308 sent from earbud 104 to primary device 200 may include instructions to pick up a call, reject a call, play music, change sound playback priority (e.g., as further described with reference to FIGS. 24 and 25), and/or the like. In some embodiments, primary device 200 and earbud 104 communicate only over a wireless connection. In other embodiments, primary device 200 and earbud 104 communicate both over a wireless connection and a wired connection.

### Communication Between Base Station and Earbud

As indicated by the solid arrows 2310 and 2312 in FIG. 23, base station 102 and earbud 104 can communicate over a wired connection (e.g., via the electrical connectors provided on the base station 102 and earbud 104). In embodiments, the element 2310 going from base station 102 to earbud 104 includes power for charging earbud 104, and the element 2312 going from earbud 104 to base station 102 to primary device 200 includes decoded analog audio data to be played via the speaker on base station 102. In some embodiments, base station 102 and earbud 104 communicate only over a wired connection. In other embodiments, base station 102 and earbud 104 communicate both over a wireless connection and a wired connection.

### Difference Between Wireless Connections for Base Station and Earbud

In embodiments, the first wireless connection established between primary device 200 and base station 102 is different from the second wireless connection established between primary device 200 and earbud 104. For example, the first wireless connection may utilize Bluetooth Low Energy (BLE), and the second wireless connection may utilize Bluetooth Classic. The first wireless connection may be configured to consume less power than the second wireless connection. The first wireless connection may be configured to transfer data at a slower rate than the second wireless connection. For example, the maximum data transfer rate over the first wireless connection may be less than the maximum data transfer rate over the second wireless connection.

### No Audio Data Sent to Base Station

In some embodiments, the communications protocol governing the connection between the primary device 200 and the base station 102 allows only non-audio data (e.g., text data, caller ID, volume control data, etc.) to be transmitted from the primary device 200 to the base station 102 and does not allow any audio data (e.g., voice call, music, ringtone, or any other sound playable via the speaker on primary device 200) to be transmitted from the primary device 200 to the base station 102. In other embodiments, the communications protocol allows audio data to be sent from the primary device 200 to the base station 102, but the primary device 200 is configured to refrain from sending audio data to the base station 102. For example, the primary device 200 sends audio data only to earbud 104 and not to base station 102.

### Audio Data Sent to Base Station

Alternatively, in some cases, primary device 200 sends audio data to the base station 102, but the base station 102 lacks the capacity to (e.g., does not have the circuitry or chip configured to) process audio data (e.g., encode or decode audio data and/or convert digital audio data to analog audio data, or otherwise convert the audio data into a format readily playable by a speaker). In some of such cases, the base station 102 ignores such audio data. In other cases, the base station 102 relays such audio data to the earbud 104. Alternatively, in some cases, the base station 102 has the capacity to process audio data, but is configured to refrain from doing so. In other cases, the base station 102 is capable of processing audio data, processes audio data received from the primary device 200, and plays the audio data via the base station speaker. In some of such cases, the base station 102 and the earbud 104 each have its own audio chip/circuitry for processing the audio data. Alternatively, only the base station 102 has an audio chip/circuitry for processing the audio data and the earbud 104 does not have an audio chip/circuitry for processing the audio data. In some other cases, only the earbud 104 has an audio chip/circuitry for processing the audio data and the base station 102 does not have an audio chip/circuitry for processing the audio data.

### No Microphone on Base Station

In some embodiments, base station 102 does not have a microphone. In such embodiments, regardless of whether earbud 104 is docked or undocked, the user's voice data may be captured by a microphone provided on earbud 104. In such a case, the earbud microphone may always be on. The earbud microphone may be on only during a voice call (or when voice input is expected from the user such as when iOS Siri is active). Alternatively, base station 102 includes a microphone. In such a case, the base station microphone may be activated while earbud 104 is docked and deactivated while earbud 102 is undocked, and the earbud microphone may be activated while earbud 104 is undocked and deactivated while earbud 104 is docked.

Redirecting Audio Playback when Earbud Becomes Undocked while in a Car

There may be situations when the user, while conducting a voice call using the car speaker, may want to begin conducting the voice call privately using the earbud 104. In such situations, the user can simply unplug the earbud 104 from the base station 102, and the voice call that was previously playing via the car speaker begins to be directed to the earbud 104 and automatically begin to be played via the earbud speaker without the user having to activate the earbud 104 or press any button(s) on the personal wireless media station 100 or the primary device 200. Such an example is illustrated in FIG. 24 with reference to example #6 of Table 1.

### Flowchart Illustrating Audio Playback Redirection of Example #6 of Table 1

FIG. 24 is a flowchart that illustrates the redirection of audio playback corresponding to example #6 of Table 1. The steps illustrated in FIG. 24 may be performed by the personal wireless media station 100 of FIG. 7, or any components therein, or any other personal wireless media stations discussed herein or other devices (presently known or developed in the future) within the scope of the present disclosure. Some or all of the method 2400 may be performed by the base station 102, by the earbud 104, or another component such as the primary device 200.

### Playing Sound Via the Car Speaker

At block 2402, sound is played via a car speaker wirelessly connected to the primary device 200. For example, the user has entered her car while the personal wireless media station 100 is paired with the primary device 200. When the car is started, the primary device 200 may detect the presence of the car speaker and connect to the car speaker while maintaining the connection to the personal wireless media station 100. Any sound played via the personal wireless media station 100 (e.g., via the base station speaker) may begin to be played via the car speaker while the primary device 200 is wirelessly connected to both the car speaker and the personal wireless media station 100 in a docked state. In some cases, prior to such playing, the primary device 200 may determine that the car speaker has priority over the personal wireless media station 100 for playing sound from the primary device 200. In some cases, the primary device 200 may terminate its connection to the earbud 104 but maintain its connection to the base station 102 upon connecting to the car speaker.

### Undocking Determination

At block 2404, the personal wireless media station 100 determines whether the earbud 104 has been undocked from the base station 102 while the sound is being played via the car speaker. If the personal wireless media station 100 determines that the earbud 104 has been undocked from the base station 102, the method 2400 proceeds to block 2406. Otherwise, the method 2400 returns to block 2402, and the sound from the primary device 200 continues to be played via the car speaker. The undocking determination may be performed using any of the techniques described herein. Although the undocking determination is illustrated as being a routine that is repeatedly or periodically performed, in other cases, as described herein, block 2404 is an undocking determination made in response to receiving a signal from another component of the personal wireless media station 100 (e.g., base station 102, earbud 104, or a component thereof) and not based on repeated or periodic checks performed to determine whether the earbud 104 is still docked to the base station 102, and the method 2400 proceeds to block 2406 upon receipt of such a signal.

### Instructing Primary Device to Switch Audio Destination

At block 2406, the personal wireless media station 100 (e.g., base station 102 or earbud 104) sends instructions to the primary device 200 to direct audio data to the earbud speaker instead of the car speaker. In some cases, the entity making the determination in block 2404 may also send the instructions to the primary device 200. For example, if the base station 102 determined in block 2404 that the earbud 104 has been undocked, the base station 102 may send the instructions to the primary device 200. Alternatively, if the earbud 104 determined in block 2404 that the earbud 104 has been undocked, the earbud 104 may send the instructions to the primary device 200. In some other cases, an entity other than the entity making the determination in block 2404 may send the instructions to the primary device 200. In some embodiments, the instructions to direct audio data to the earbud speaker instead of the car speaker comprise instructions to update audio output settings such that the earbud speaker has a higher priority level than the car speaker. In some cases, the instructions to direct audio data to the earbud speaker instead of the car speaker comprise instructions to set the earbud speaker as the most preferred audio output destination.

Audio Redirected from Car Speaker to Earbud

At block 2408, the sound ceases to be provided via the car speaker and begins to be played via the personal wireless media station 100. The sound may be played via the earbud 104 immediately after or substantially simultaneously with the stopping of the playing via the car speaker. Here, immediately after or substantially simultaneously means within 0.01, 0.01, 0.1, 0.5, 1.0, 2.0, 3.0, or 5.0 seconds (or any other value between such values) from stoppage of playing sound via the car speaker or from determination that the earbud 104 has been undocked. Alternatively, there may be an overlap period during which sound is played both via the car speaker and the earbud speaker. The overlap period may last for any of these enumerated time periods.

### Variations

In some embodiments, block 2402 may be omitted, and upon detecting the undocking of the earbud 104, the base station 102 or the earbud 104 may send instructions to the primary device 200 to direct future audio data to the earbud 104 instead of the car speaker, effectively setting the earbud 104 as the primary audio output device (or changing the primary audio output device from the car speaker to the earbud 104). As another example, even though the method 2400 was described in the context of a car speaker, the techniques described herein may be extended to any other third-party speaker (e.g., Bluetooth speaker) that is connected to the primary device 200 over a wireless connection or a wired connection.

Redirecting Audio Playback when Earbud Becomes Docked while in a Car

There may be situations when the user, while listening to music using the earbud 104, may want to listen to music using the car speaker. In such situations, the user can simply plug the earbud 104 into the base station 102, and the audio that was previously playing via the earbud speaker begins to be directed to the car speaker and automatically begins to be played via the car speaker without the user having to press any button(s) on the personal wireless media station 100 or the primary device 200. Such an example is illustrated in FIG. 25 with reference to example #14 of Table 2.

Flowchart Illustrating Redirection of Audio Playback Upon Docking while in a Car

FIG. 25 is a flowchart that illustrates the redirection of audio playback corresponding to example #14 of Table 2. The steps illustrated in FIG. 25 may be performed by the personal wireless media station 100 of FIG. 7, or any components therein, or any other personal wireless media stations discussed herein or other devices (presently known or developed in the future) within the scope of the present disclosure. Some or all of the method 2500 may be performed by the base station 102, by the earbud 104, or another component such as the primary device 200.

### Playing Sound Via the Earbud Speaker

At block 2502, sound is played via the earbud speaker on the earbud 104 that is wirelessly connected to the primary device 200. For example, the user has entered her car while the personal wireless media station 100 is paired with the primary device 200. When the user starts the car, the car speaker is turned on, and the primary device 200 detects the presence of the car speaker and connects to the car speaker while maintaining its connection to the personal wireless media station 100. Any audio content played via the personal wireless media station 100 (e.g., via the earbud speaker) prior to the connection with the car speaker may begin to be played via the car speaker while the primary device 200 is wirelessly connected to both the car speaker and the personal wireless media station 100 in an undocked state. In some cases, prior to such playing, the primary device 200 may determine that the earbud speaker has priority over the car speaker for playing sound from the primary device 200.

### Docking Determination

At block 2504, the personal wireless media station 100 determines whether the earbud 104 has been docked to the base station 102 while the sound is being played via the earbud speaker. If the personal wireless media station 100 determines that the earbud 104 has been docked to the base station 102, the method 2500 proceeds to block 2506. Otherwise, the method 2500 returns to block 2502, and the sound from the primary device 200 continues to be played via the earbud speaker. The docking determination may be performed using any of the techniques described herein. Although the docking determination is illustrated as being a routine that is repeatedly or periodically performed, in other cases, as described herein, block 2504 is a docking determination made in response to receiving a signal from another component of the personal wireless media station 100 (e.g., base station 102, earbud 104, or a component thereof) and not based on repeated or periodic checks performed to determine whether the earbud 104 is still not docked to the base station 102, and the method 2500 proceeds to block 2506 upon receipt of such a signal.

### Instructing Primary Device to Switch Audio Destination

At block 2506, the personal wireless media station 100 (e.g., base station 102 or earbud 104) sends instructions to the primary device 200 to direct audio data to the car speaker instead of the earbud speaker. In some cases, the entity making the determination in block 2504 may also send the instructions to the primary device 200. For example, if the base station 102 determined in block 2504 that the earbud 104 has been docked, the base station 102 may send the instructions to the primary device 200. Alternatively, if the earbud 104 determined in block 2504 that the earbud 104 has been docked, the earbud 104 may send the instructions to the primary device 200. In some other cases, an entity other than the entity making the determination in block 2504 may send the instructions to the primary device 200. In some embodiments, the instructions to direct audio data to the car speaker instead of the earbud speaker comprise instructions to update audio output settings such that the car speaker has a higher priority level than the earbud speaker. In some cases, the instructions to direct audio data to the car speaker instead of the earbud speaker comprise instructions to set the car speaker as the most preferred audio output destination.

Audio Redirected from Earbud to Car Speaker

At block 2508, the sound ceases to be provided via the earbud speaker and begins to be played via the car speaker. The sound may be played via the car speaker immediately after or substantially simultaneously with the stopping of the playing via the earbud speaker. Here, immediately after or substantially simultaneously means within 0.01, 0.01, 0.1, 0.5, 1.0, 2.0, 3.0, or 5.0 seconds (or any other value between such values) from stoppage of playing sound via the earbud speaker or from determination that the earbud 104 has been docked. Alternatively, there may be an overlap period during which sound is played both via the earbud speaker and the car speaker. The overlap period may last for any of these enumerated time periods. In some cases, even though the sound is no longer provided via the earbud speaker in response to the docking, text data and other non-audio data continue to be provided via the base station 102.

### Variations

In some embodiments, block 2502 may be omitted, and upon detecting the docking of the earbud 104, the base station 102 or the earbud 104 may send instructions to the primary device 200 to direct future audio data to the car speaker instead of the earbud speaker, effectively setting the car speaker as the primary audio output device (or changing the primary audio output device from the earbud 104 to the car speaker). As another example, even though the method 2500 was described in the context of a car speaker, the techniques described herein may be extended to any other third-party speaker (e.g., Bluetooth speaker) that is connected to the primary device 200 over a wireless connection or a wired connection.

Directing Audio Playback Based on Sound Content when Earbud Becomes Docked

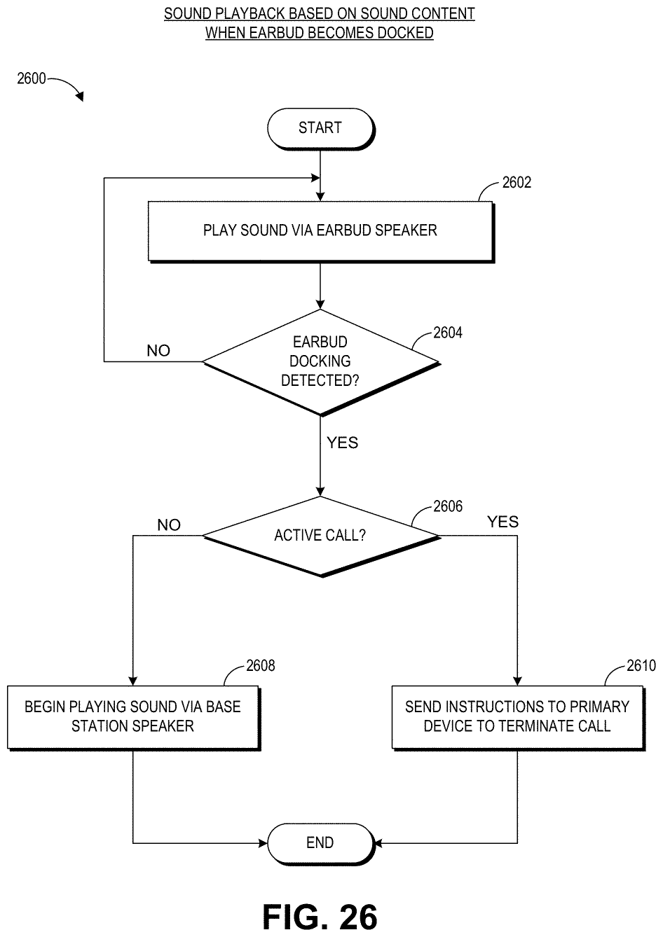

After the user is done having with a voice call using the earbud 104, the user may simply dock the earbud 104 to the base station 102, and the call can be automatically terminated without the user having to press an end button on the base station 102, earbud 104, or primary device 200. Docking of the earbud 104 causes the call to be terminated. The personal wireless media station 100 may then automatically resume playing the music that the user was listening to prior to the voice call, without the user having to press a resume or play button on the base station 102, earbud 104, or primary device 200. Such an example is illustrated in FIG. 26 with reference to examples #11 and #13 of Table 2.

### Flowchart for Directing Audio Playback Based on Sound Content Upon Docking

FIG. 26 is a flowchart for directing audio playback covered by examples #11 and #13 of Table 2. The steps illustrated in FIG. 26 may be performed by the personal wireless media station 100 of FIG. 7, or any components therein, or any other personal wireless media stations discussed herein or other devices (presently known or developed in the future) within the scope of the present disclosure. Some or all of the method 2600 may be performed by the base station 102, by the earbud 104, or another component such as the primary device 200.

### Playing Sound Via the Earbud Speaker

At block 2602, sound is played via the earbud speaker on the earbud 104 that is wirelessly connected to the primary device 200. For example, the sound may be received by the earbud 104 from the primary device 200 and played via the earbud speaker while the earbud 104 is in an undocked state. The sound may be music stored or streamed on the primary device 200. Alternatively, the sound may be a ringtone or an audio alert indicating that a voice call is incoming. In some cases, the sound may be voice data received from the primary device 200 for an active voice call.

### Docking Determination

At block 2604, the personal wireless media station 100 determines whether the earbud 104 has been docked to the base station 102 while the sound is being played via the earbud speaker. If the personal wireless media station 100 determines that the earbud 104 has been docked to the base station 102, the method 2600 proceeds to block 2606. Otherwise, the method 2600 returns to block 2602, and the sound from the primary device 200 continues to be played via the earbud speaker. The docking determination may be performed using any of the techniques described herein. Although the docking determination is illustrated as being a routine that is repeatedly or periodically performed, in other cases, as described herein, block 2604 is a docking determination made in response to receiving a signal from another component of the personal wireless media station 100 (e.g., base station 102, earbud 104, or a component thereof) and not based on repeated or periodic checks performed to determine whether the earbud 104 is still not docked to the base station 102, and the method 2600 proceeds to block 2606 upon receipt of such a signal.

### Active Call Determination

At block 2606, the personal wireless media station 100 (e.g., base station 102 or earbud 104) determines whether a voice call is active (e.g., a communications channel for receiving and transmitting the respective parties' voice data to each other is established). For example, the personal wireless media station 100, based on information previously received from the primary device 200 such as incoming call information, caller information, and the like, may determine that there is an active voice call (e.g., currently ongoing). As another example, the personal wireless media station 100 may send a request to the primary device 200 to determine whether a voice call is active. In such an example, the personal wireless media station 100 may determine, based on information sent by the primary device 200 in response to the request from the personal wireless media station 100, whether there is an active voice call. In some cases, the entity making the determination in block 2604 may also determine whether a voice call is active. Alternatively, an entity other than the entity making the determination in block 2604 may determine whether a voice call is active. If the personal wireless media station 100 determines that a voice call is not active (e.g., a situation corresponding to example #13 of Table 2), the method 2600 proceeds to block 2608. Otherwise, the method 2600 proceeds to block 2610 (e.g., a situation corresponding to example #11 of Table 2).

### Audio Continued on Base Station Speaker

At block 2608, the sound ceases to be provided via the earbud speaker and begins to be played via the base station speaker. The sound may be played via the base station speaker immediately after or substantially simultaneously with the stopping of the playing via the earbud speaker. Here, immediately after or substantially simultaneously means within 0.01, 0.01, 0.1, 0.5, 1.0, 2.0, 3.0, or 5.0 seconds (or any other value between such values) from stoppage of playing sound via the earbud speaker or from determination that the earbud 104 has been docked. Alternatively, there may be an overlap period during which sound is played both via the earbud speaker and the base station speaker. The overlap period may last for any of these enumerated time periods.

### Active Call Terminated

At block 2610, the personal wireless media station 100 (e.g., base station 102 or earbud 104) sends instructions to the primary device 200 to terminate the active voice call. In some cases, the base station speaker resumes playing the sound (e.g., music or other sound such as talk show, podcast, etc.) that was playing before the voice call was accepted or picked up. For example, the primary device 200, upon terminating the call, may resume sending the audio data for the music or other sound that was playing prior to the voice call to the personal wireless media station 100 (e.g., base station 102 or earbud 104). In some cases, as indicated in example #11 of Table 2, the personal wireless media station 100 causes the active call to continue to be conducted via the base station speaker by playing any voice data received for the call via the base station speaker.

Directing Audio Playback Based on Sound Content when Earbud Becomes Undocked

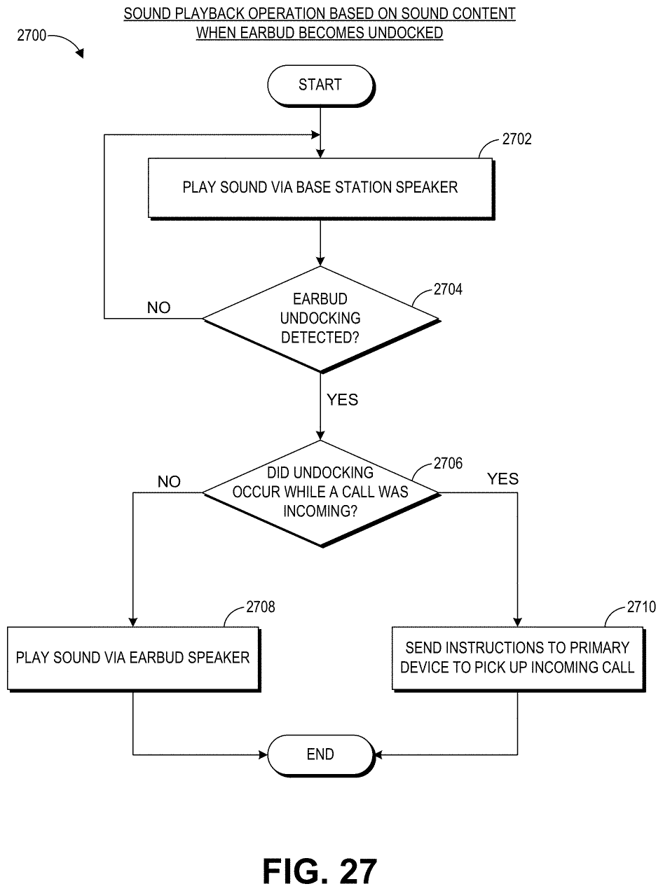

There may be situations in which the user, while listening to music via the base station speaker, receives an incoming voice call. In such situations, the user can simply undock the earbud 104 from the base station 102 and conduct the voice call using the earbud 104. The undocking of the earbud 104 causes the call to be picked up and causes the call to be provided to the earbud 104, without the user having to press a button on the base station 102, earbud 104, or primary device 200 to accept the incoming call. Such an example is illustrated in FIG. 27 with reference to examples #1 and #5 of Table 1.

### Flowchart for Directing Audio Playback Based on Sound Content Upon Undocking

FIG. 27 is a flowchart for directing audio playback covered by examples #1 and #5 of Table 1. The steps illustrated in FIG. 27 may be performed by the personal wireless media station 100 of FIG. 7, or any components therein, or any other personal wireless media stations discussed herein or other devices (presently known or developed in the future) within the scope of the present disclosure. Some or all of the method 2700 may be performed by the base station 102, by the earbud 104, or another component such as the primary device 200.

### Playing Sound Via the Earbud Speaker

At block 2702, sound is played via the base station speaker on the base station 102 that is wirelessly connected to the primary device 200. For example, the sound may be received by the earbud 104 from the primary device 200 and played via the base station speaker while the earbud 104 is in a docked state. The sound may be music stored or streamed on the primary device 200. Alternatively, the sound may be a ringtone or an audio alert indicating that a voice call is incoming. In some cases, the sound may be voice data received from the primary device 200 for an active voice call.

### Undocking Determination

At block 2704, the personal wireless media station 100 determines whether the earbud 104 has been undocked from the base station 102 while the sound is being played via the base station speaker. If the personal wireless media station 100 determines that the earbud 104 has been undocked from the base station 102, the method 2700 proceeds to block 2706. Otherwise, the method 2700 returns to block 2702, and the sound from the primary device 200 continues to be played via the base station speaker. The undocking determination may be performed using any of the techniques described herein. Although the undocking determination is illustrated as being a routine that is repeatedly or periodically performed, in other cases, as described herein, block 2704 is an undocking determination made in response to receiving a signal from another component of the personal wireless media station 100 (e.g., base station 102, earbud 104, or a component thereof) and not based on repeated or periodic checks performed to determine whether the earbud 104 is still docked to the base station 102, and the method 2700 proceeds to block 2706 upon receipt of such a signal.

### Incoming Call Determination

At block 2706, the personal wireless media station 100 (e.g., base station 102 or earbud 104) determines whether the undocking occurred while a voice call was incoming (e.g., a request to establish a communications channel for receiving and transmitting the respective parties' voice data to each other was being received at the primary device 200 at the time the earbud 104 was undocked from the base station 102). For example, the personal wireless media station 100, based on information received from the primary device 200 such as incoming call information, caller information, and the like, may determine that there is or was an incoming voice call. In some cases, the entity making the determination in block 2704 may also determine whether a voice call is or was incoming. Alternatively, an entity other than the entity making the determination in block 2704 may determine whether a voice call is or was incoming. If the personal wireless media station 100 determines that a voice call is not or was not incoming (e.g., a situation corresponding to example #5 of Table 1), the method 2700 proceeds to block 2708. Otherwise, the method 2700 proceeds to block 2710 (e.g., a situation corresponding to example #1 of Table 1).

### Audio Continued on Earbud Speaker

At block 2708, the sound ceases to be provided via the base station speaker and begins to be played via the earbud speaker. The sound may be played via the earbud speaker immediately after or substantially simultaneously with the stopping of the playing via the base station speaker. Here, immediately after or substantially simultaneously means within 0.01, 0.01, 0.1, 0.5, 1.0, 2.0, 3.0, or 5.0 seconds (or any other value between such values) from stoppage of playing sound via the base station speaker or from determination that the earbud 104 has been undocked. Alternatively, there may be an overlap period during which sound is played both via the earbud speaker and the base station speaker. The overlap period may last for any of these enumerated time periods.

### Incoming Call Accepted

At block 2710, the personal wireless media station 100 (e.g., base station 102 or earbud 104) sends instructions to the primary device 200 to accept the incoming voice call. The accepted call is automatically conducted via the earbud 104, such that the voice data of the other party received by the primary device 200 is sent to the earbud 104, and voice data of the user captured by the earbud microphone is sent to the primary device 104 to be transmitted to the other party.

### Battery Use Case

The personal wireless media station 100 includes two components each having its own functions and its own battery. The goal of the base station 102 is not to just charge the earbud 104, and the goal of the earbud 104 is not to just charge the earbud 104. The base station 102 also needs to keep some of the battery power to itself so that it can perform other functions such as display caller ID, play music, etc. Thus, the base station 102 is configured such that it provides charge to the earbud battery only if one or more charging conditions are satisfied (e.g., base station 102 is connected to a power source, earbud battery is below a threshold level, base station battery is above a threshold level, etc.). In some cases, the base station 102 does not communication with the primary device 200, and its primary purpose is to charge the earbud 102 and house the earbud 102 (e.g., as shown in the figures or otherwise).

### Earbud Battery Charging

FIG. 28 is a flowchart for charging the earbud battery, according to an embodiment of the present invention. The steps illustrated in FIG. 28 may be performed by the personal wireless media station 100 of FIG. 7, or any components therein, or any other personal wireless media stations discussed herein or other devices (presently known or developed in the future) within the scope of the present disclosure. For convenience, method 2800 is described as performed by the personal wireless media station 100. However, some or all of the method 2800 may be performed by the base station 102, by the earbud 104, or another component such as the primary device 200.

### Docking Determination

At block 2802, the personal wireless media station 100 determines that the earbud 104 is or has been docked to the base station 102. For example, the personal wireless media station 100 may utilize any of the techniques described herein to determine whether the earbud 104 is or has been docked to the base station 102. Although not described in Table 2, each entry of Table 2 may include “Enter earbud charging mode” (e.g., performing the remaining steps of method 2800 described below) in the “Device operation triggered by action” column.

### Determining Presence of Power Source

At block 2804, the personal wireless media station 100 determines whether the base station 102 is connected to a power source (e.g., via a charging cable). If the personal wireless media station 100 determines that the base station 102 is connected to a power source, the method 2800 proceeds to 2806, where the personal wireless media station 100 charges the earbud battery to a maximum capacity (e.g., 100%). Otherwise, the method 2800 proceeds to block 2808.

### Determining Charging Threshold Conditions

At block 2808, the personal wireless media station 100 determines whether one or more charging threshold conditions are satisfied. For example, the personal wireless media station 100 may determine whether the current charge level of the earbud battery is less than threshold #1. Alternatively, or additionally, the personal wireless media station 100 may determine whether the current charge level of the base station battery is greater than threshold #2. If the personal wireless media station 100 determines that the current charge level of the earbud battery is less than threshold #1 and/or the current charge level of the base station battery is greater than threshold #2, the method 2800 proceeds to block 2810, where the personal wireless media station 100 charges the earbud battery until the current charge level of the earbud battery is no longer less than threshold #1 and/or the current charge level of the base station battery is no longer greater than threshold #2. Otherwise, the method 2800 proceeds to block 2812.

Refraining from Charging Earbud Battery

At block 2812, the personal wireless media station 100 refrains from charging the earbud battery while the earbud battery is docked. In embodiments, the personal wireless media station 100 refrains from charging the battery until at least one of the determinations in block 2804 or block 2808 is a positive determination.

### Variations

In some cases, the base station 102 charges the earbud battery to a threshold charge level even if a power source is not connected to the base station 102. In some cases, the base station 102 charges the earbud battery to the maximum battery capacity even if a power source is not connected to the base station 102 and/or even if the base station battery is below a threshold charge level. In some cases, the base station 102 charges the earbud battery while the earbud 104 is providing audio data to the base station 102. In some cases, the base station 102 charges the earbud battery while the earbud 104 is not providing audio data to the base station 102. In some cases, the base station 102 charges the earbud battery regardless of whether the earbud 104 is providing audio data to the base station 102. In some cases, the base station 102 charges the earbud battery while the earbud 104 is providing audio data to the base station 102 and does not charge the earbud battery while the earbud 104 is not providing audio data to the base station 102. In some cases, the base station 102 charges the earbud battery while the earbud 104 is not providing audio data to the base station 102 and does not charge the earbud battery while the earbud 104 is providing audio data to the base station 102.

### Call/Power Control Using One Button

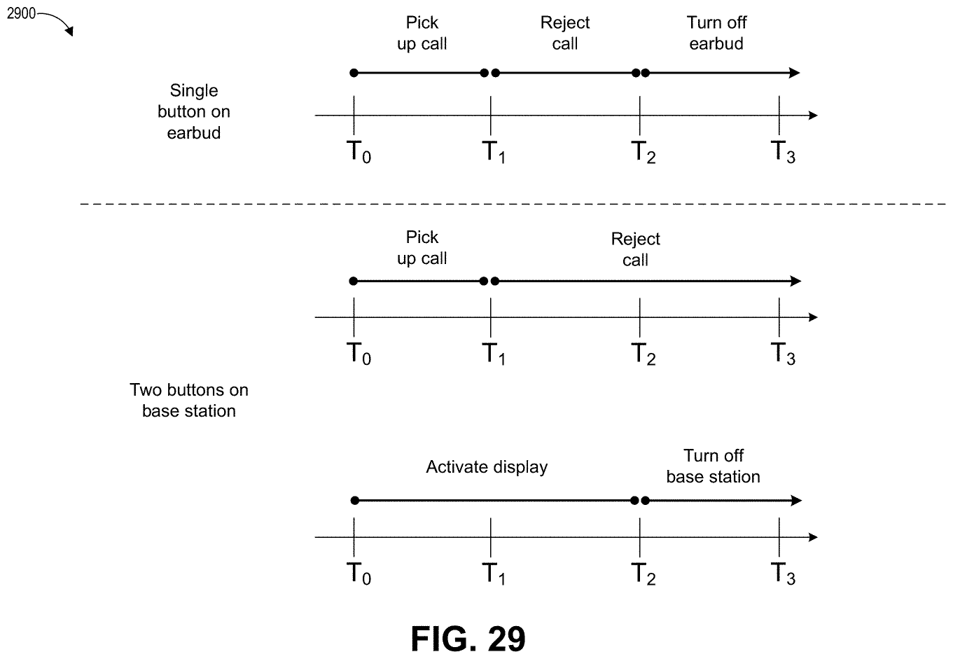

FIG. 29 illustrates example functions provided via the buttons on the base station 102 or the earbud 104. In one example, one or both of the base station 102 and the earbud 104 may include a single button for accepting a call, rejecting a call, and turning off the base station 102 and/or the earbud 104. In such an example, the period for which the button is consecutively held down or activated may determine which function is to be executed. For example, if the user holds down the button for a period of time less than T₁, the personal wireless media station 100 picks up an incoming call (e.g., sends instructions to the primary device 200 to pick up the incoming call). If the user holds down the button for a period of time greater than T₁ but less than T₂, the personal wireless media station 100 rejects an incoming call (e.g., sends instructions to the primary device 200 to reject the incoming call). If the user holds down the button for a period of time greater than T₂ but less than T₃, the personal wireless media station 100 turns off the device (e.g., earbud 104, base station 102, or both).

### Call/Power Control Using Two Buttons

In some cases, two buttons may be provided to accept a call, reject a call, and turn off the base station 102 and/or the earbud 104. In such cases, if the user holds down button #1 for a period of time less than T₁, the personal wireless media station 100 picks up an incoming call (e.g., sends instructions to the primary device 200 to pick up the incoming call). If the user holds down button #1 for a period of time greater than T₁, the personal wireless media station 100 rejects an incoming call (e.g., sends instructions to the primary device 200 to reject the incoming call). If the user holds down button #2 for a period of time less than T₂, the personal wireless media station 100 activates the display provided on the personal wireless media station 100 (e.g., base station display screen). If the user holds down button #2 for a period of time greater than T₂ but less than T₃, the personal wireless media station 100 turns off the device (e.g., earbud 104, base station 102, or both).

### Disabling One-Button Call/Power Control Method Upon Docking

In some cases, the one-button call/power control described above is disabled upon docking of the earbud 104 to the base station 102. Advantageously, such a disabling of the one-button control can prevent the user from (i) inadvertently picking up a call that the user intended to reject or (ii) inadvertently turning off the personal wireless media station 100 when the user wanted to reject an incoming call.

Incoming Call when Earbud is Undocked

In embodiments, when an incoming call is detected on the primary device 200, the primary device 200 sends text data corresponding to the incoming call to the base station 102 and sends audio data corresponding to the incoming call to the earbud 104. If the earbud 104 is docked to the base station 102 when such a call is received, the text data is displayed via the base station display screen and the audio data (e.g., ringtone) is played via the base station speaker, and nothing is played via the earbud speaker. For example, the earbud 104 may receive the audio data from the primary device 200, process the audio data (e.g., decode the audio data and/or convert the audio data into a digital format), and provides the processed audio data via the electrical connection established between the base station and earbud connectors. The provided audio data is played by the base station 102 via the base station speaker.

Incoming Call when Earbud is Docked

In embodiments, when an incoming call is detected on the primary device 200, the primary device 200 sends text data corresponding to the incoming call to the base station 102 and sends audio data corresponding to the incoming call to the earbud 104. If the earbud 104 is undocked from the base station 102 when such a call is received, the text data is displayed via the base station display screen and the audio data (e.g., ringtone) is played via the earbud speaker, and nothing is played via the base station speaker. For example, the earbud 104 may receive the audio data from the primary device 200, process the audio data (e.g., decode the audio data and/or convert the audio data into a digital format), and play the processed audio data via the earbud speaker.

Earbud Operation when Base Station is Turned Off while Earbud is Undocked

In embodiments, the earbud 104 remains on when the base station 102 is turned off while the earbud 104 is undocked. In embodiments, the earbud 104 remains off when the base station 102 is turned on while the earbud 104 is undocked.

Base Station Operation on when Earbud is Turned Off while Earbud is Undocked

In embodiments, the base station 102 remains on when the earbud 104 is turned off while the earbud 104 is undocked. In embodiments, the base station 102 remains off when the earbud 104 is turned on while the earbud 104 is undocked.

Earbud Operation when Base Station is Turned Off while Earbud is Docked

In embodiments, the earbud 104 also turns off when the base station 102 is turned off while the earbud 104 is docked. In embodiments, the earbud 104 also turns on when the base station 102 is turned on while the earbud 104 is docked.

Base Station Operation on when Earbud is Turned Off while Earbud is Docked

In embodiments, the base station 102 also turns off when the earbud 104 is turned off while the earbud 104 is docked. In embodiments, the base station 102 also turns on when the earbud 104 is turned on while the earbud 104 is docked.

### Additional Views of Base Station and Earbud

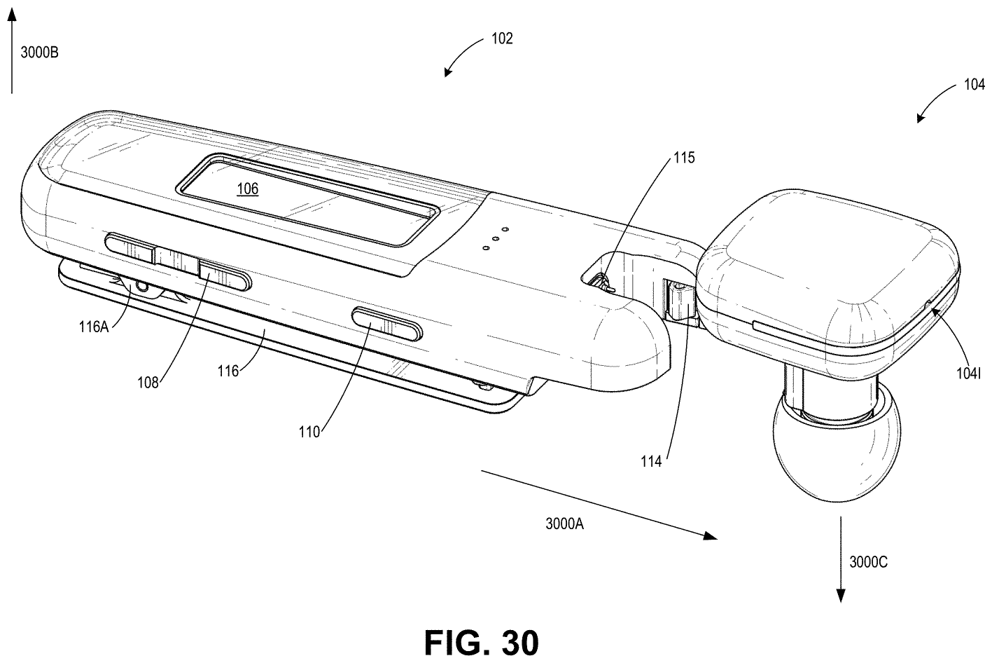

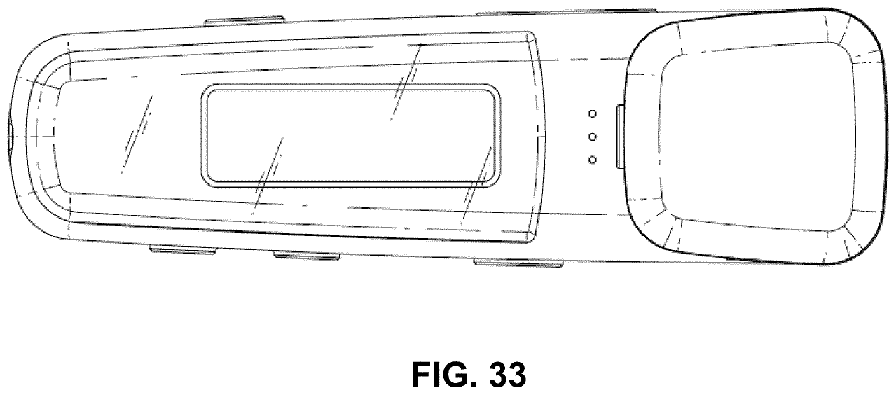

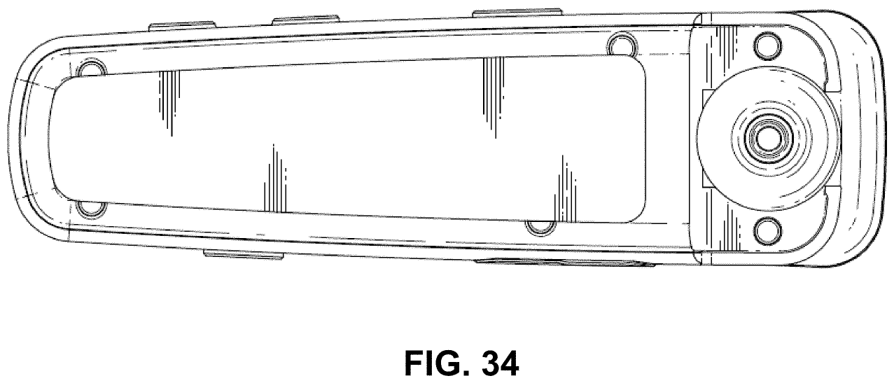

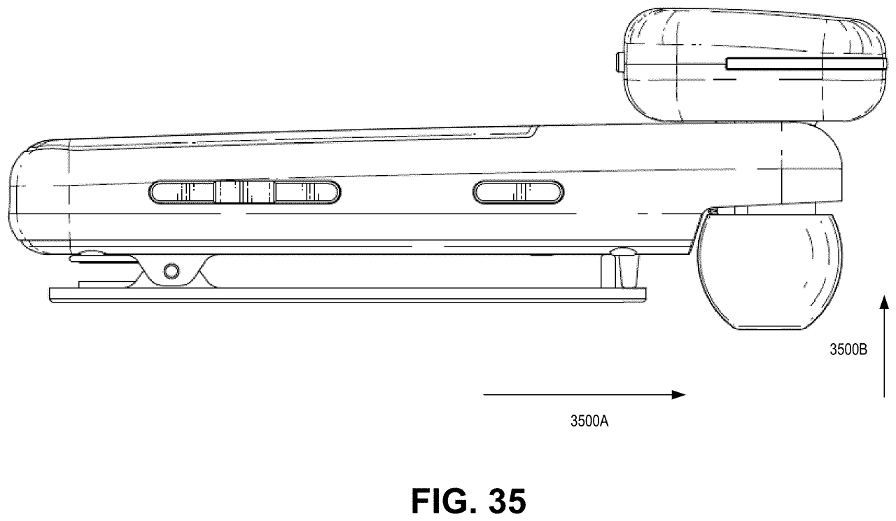

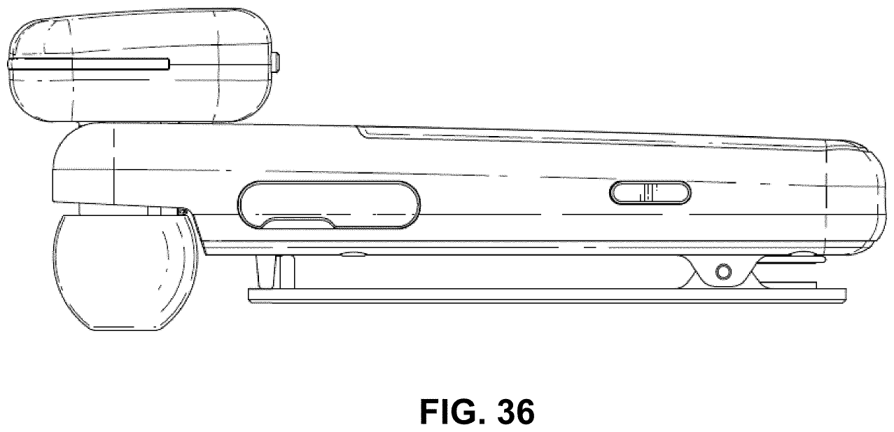

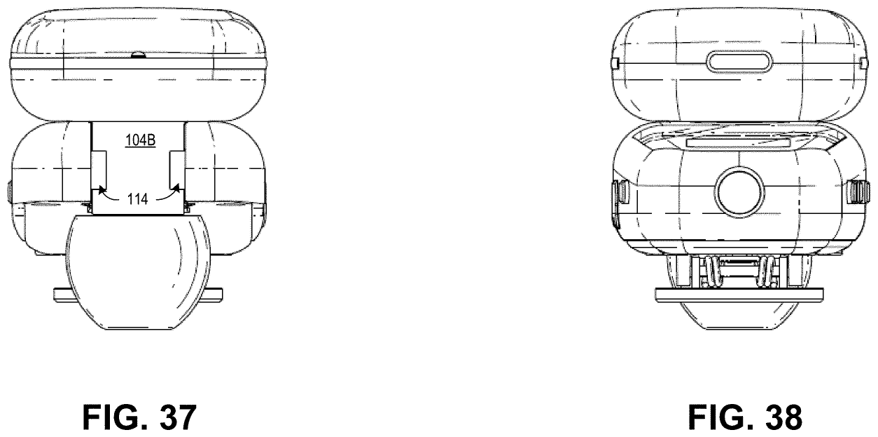

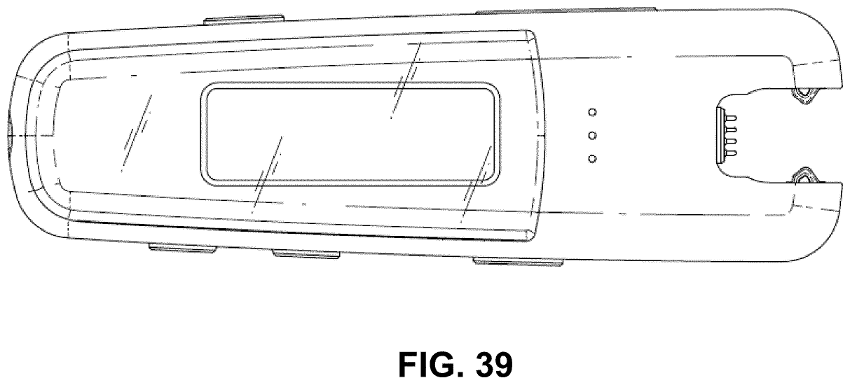

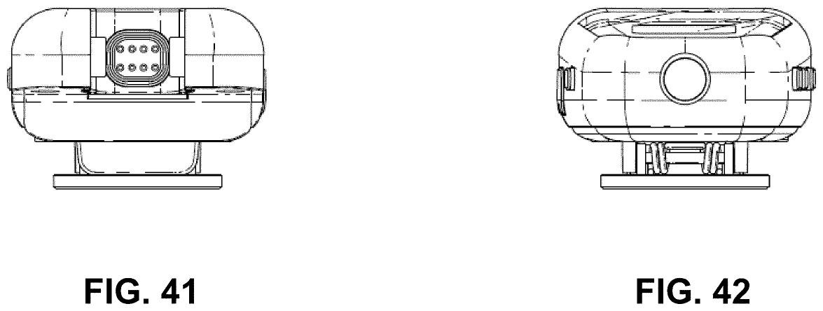

FIGS. 30-49 illustrate a personal wireless media station, according to example embodiments.

### Clip

As shown in FIG. 31, the clip 116 provided on the base station 102 may include a clip hinge 116A and end portions 116B and 116C. When the end portion 116B is pressed towards the body of the base station 102 (e.g., by pinching the end portion 116B against the body of the base station 102), the end portion 116C moves away from the body of the base station 102 and the clip 116 opens towards the undocking direction 3100A. While the clip 116 is open, the user's clothing can be inserted into the opening such that the clip 116, when closed, holds onto the user's clothing. FIG. 1 shows such a configuration, where the base station 102 is clipped onto the user's clothing by moving the base station 102 towards the undocking direction 3100A. In the example of FIG. 1, when the user pulls the earbud 104 away from the base station 102, the base station 102 may initially be pulled along the same direction (e.g., until the user's force overcomes the force of the locking mechanism of the docking arms). By having the clip 116 that opens towards the undocking direction 3100A, when the base station 102 is pulled in the undocking direction 3100A along with the earbud 102, the user's clothing caught by the clip 116 is pushed further into the clip 116 towards the clip hinge 116A, ensuring that the base station 102 remains clipped onto the user's clothing through the undocking of the earbud 102. Alternatively, in other embodiments, the clip 116 opens towards a direction opposite to the undocking direction 3100A. FIG. 3 shows such a configuration, where the base station 102 is clipped onto the user's handbag by opening the clip 116 and moving the base station 102 towards a direction opposite to the undocking direction 3100A.

### Base Station Antenna

The base station 102 sends data to the primary device 200 and receives data from the primary device 200 using an antenna. In some cases, the base station 102 includes an on-chip antenna disposed inside the main body of the base station 102. In some cases, the base station 102 includes an antenna inside the clip hinge 116A.

### Earbud Microphone Placement

In embodiments, as shown in FIG. 30, the earbud microphone 1041 is provided on the side of the earbud head 104A facing in the undocking direction 3000A. Such a configuration allows the earbud microphone 1041 to be naturally facing down towards the user's mouth when the user grips the earbud head 104A using her fingers to undock the earbud 104 and brings the earbud 104 up to her ear while maintaining the grip on the earbud head 104A. For example, the user may use place her thumb on the side (“side A”) of the earbud head 104 that is facing her, place her index and middle fingers on the side of the earbud head 104 that is opposite to side A, grip the earbud heard 104A using the three fingers, and pull the earbud head 104A in the undocking direction 3000A, as shown in FIG. 30. When the user brings the earbud 104 up to her ear such that the ear portion 104C is pointing into her ear in an anatomically natural manner (e.g., with the two fingers towards the front of the user and the thumb towards the back of the user), the earbud microphone 1041 is facing towards the user's mouth, thereby improving the quality of the recording of the user's voice via the earbud microphone 1041.

### Relationship Among Earbud Microphone, Display, and Earpiece

In embodiments, the display direction (e.g., display direction 3000B of FIG. 30, or the direction in which the display surface of the base station 102 is facing) and the earpiece direction (e.g., earpiece direction 3000C of FIG. 30 or the direction in which the ear portion 104C is pointing) are the same, and the earbud microphone is provided on a side of the earbud head 104A facing a direction opposite to the undocking direction 3000A. In embodiments, the display direction and the earpiece direction are opposite to each other, and the earbud microphone is provided on a side of the earbud head 104A facing the undocking direction 3000A.

### Earbud Button Placement

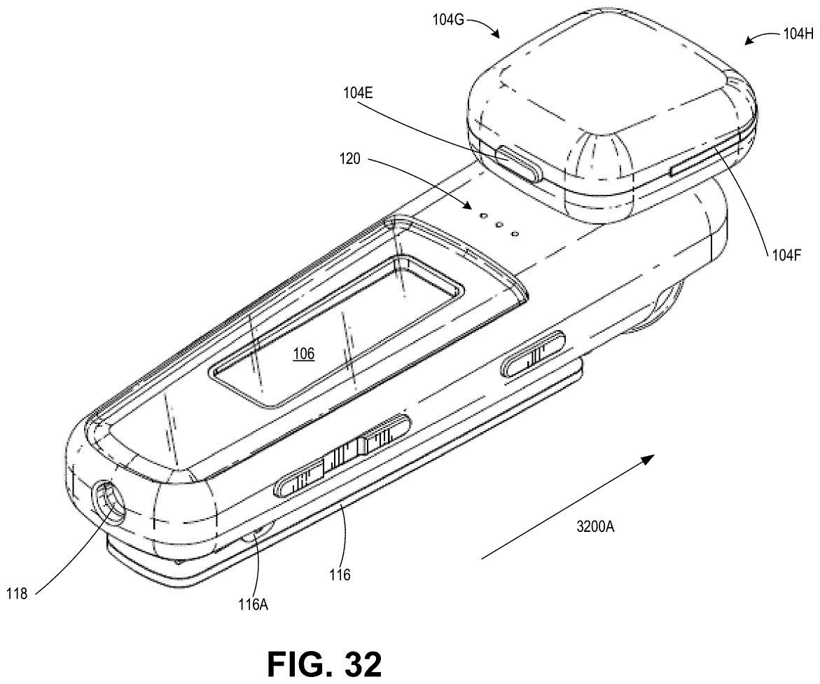

In the example of FIG. 32, the earbud 104 does not include any buttons on the two parallel sides 104F and 104G that each have a surface that is parallel to the undocking direction 3200A. For example, the user may pinch these two sides together when docking or undocking the earbud 104. Having no buttons on these two sides can prevent the user from inadvertently activating a function such as accept or reject an incoming voice call. In embodiments, the earbud button 104E is placed on a side of the earbud 104 facing in a direction opposite to the undocking direction 3200A such that when the earbud 104 is undocked and brought up to the user's ear, the earbud button 104E is naturally facing away from the user's mouth. In some cases, the earbud button 1041 is placed on a side of the earbud 104 that is on the opposite side of the side that includes the earbud microphone 1041.

### Length of Earbud Waist

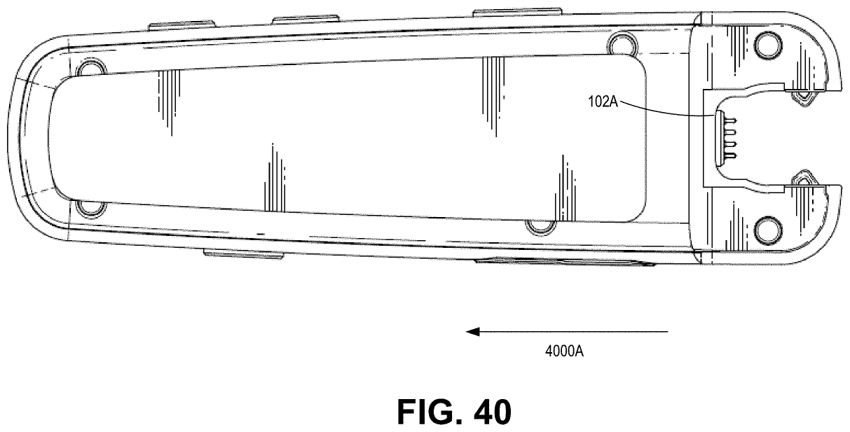

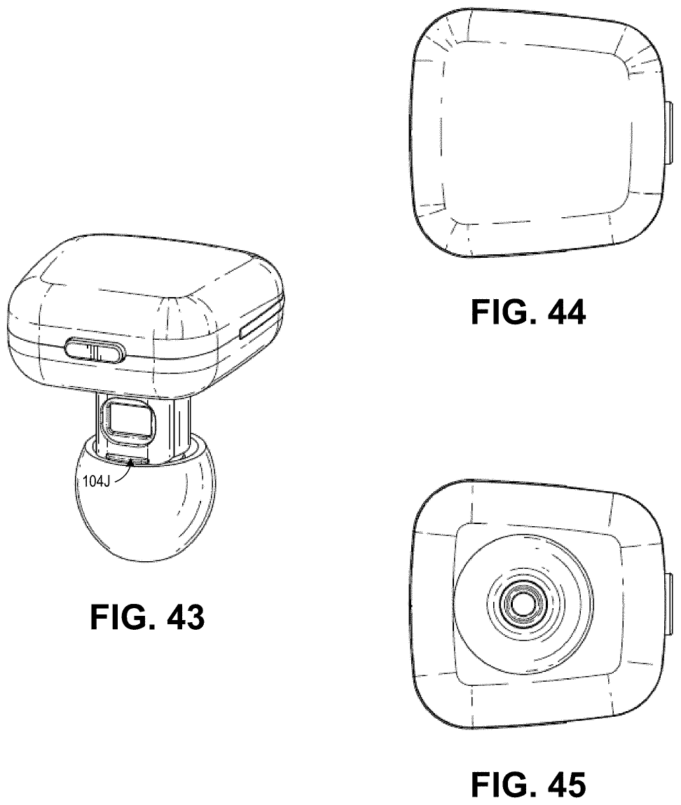

In embodiments, the length of the earbud waist 104B is equal to or substantially equal to the height of the docking arm of the base station 102. In some cases, the length of the earbud waist 104B is defined as the distance between the head portion 104A shown in FIG. 40 and the flange portion 104J shown in FIGS. 43 and 49. During docking, the flange portion 104J of the earbud 104 travels beyond the edge portion 102A of the base station 102 shown in FIG. 40 in the docking direction 4000A, such that an overlap between the flange portion 104J and the edge portion 102A is created when viewing into the page in FIG. 40 (e.g., overlap along the docking direction 4000A).

### Width of Earbud Waist

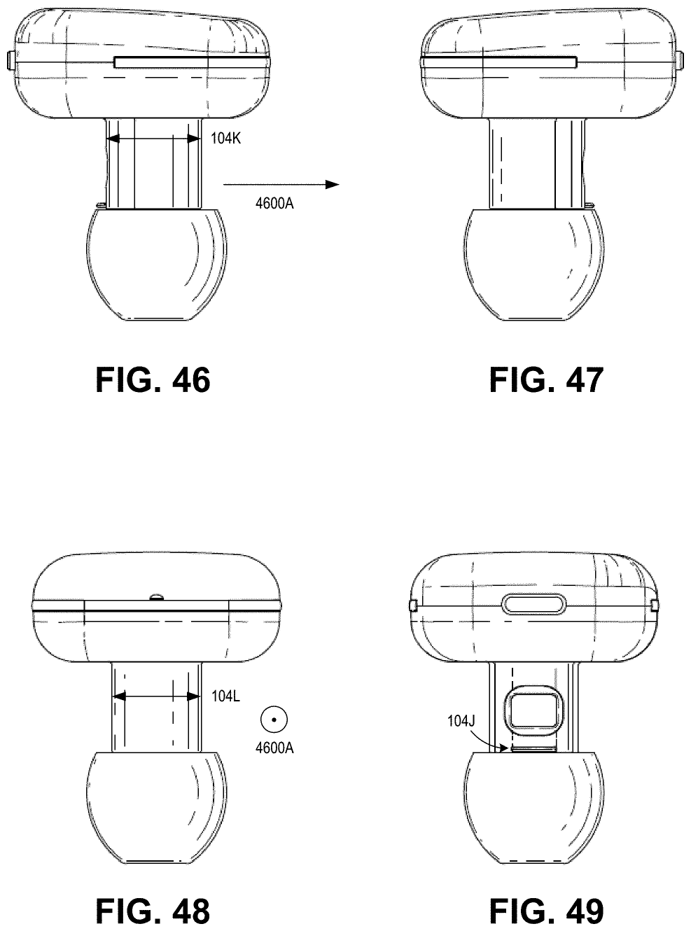

In embodiments, the width 104K of the earbud waist 104B along the undocking direction 4600A (as shown in FIG. 46) is greater than the width 104L of the earbud waist 104B along a direction perpendicular to the undocking direction 4600A and parallel to the top surface of the head portion 104A (as shown in FIG. 48). Such a configuration prevents the earbud 104B from being rotated along its axial direction when the distance between the docking arms of the base station 102 is greater than equal to the width 104L but less than the width 104K. In other cases, the widths 104K and 104L are equal or substantially equal to each other.

### Other Components

As shown in FIG. 32, base station 102 may further include an audio connector 118 for establishing an electrical connection to an auxiliary audio output device such as earphones, speakers, and the like. While an electrical connection is establish between base station 102 and an auxiliary audio output device, any audio received from earbud 104 over the wired connection between base station 102 and earbud 104 may be played via the auxiliary audio output device and not via the base station speaker 120 (or via the earbud speaker).

### Additional Primary Devices

Although various embodiments are described with reference to a single primary device (e.g., smartphone), in embodiments, the personal wireless media station 100 is configured to communicate with multiple primary devices (e.g., a smartphone and an office phone belonging to the same user). For example, in some cases, the personal wireless media station 100 connects to only one primary device at a time. For example, if only one of multiple primary devices is within a threshold range, the personal wireless media station 100 connects to the primary device within the threshold range. If multiple primary devices are within the threshold range, the personal wireless media station 100 may connect to one of them depending on the context. For example, if the user is in her office, the personal wireless media station 100 connects to her office phone, and if the user is outside her office, the personal wireless media station 100 connects to her smartphone. In some cases, during work hours (or other threshold window), the personal wireless media station 100 connects to her office phone, and outside of the work hours (or other threshold window), the personal wireless media station 100 connects to her smartphone.

### Other Variations

In some cases, the base station 102 does not have a speaker and does not wirelessly communicate with the primary device 200 or the earbud 102. In such cases, the base station 102 serves as a docking station for docking the earbud 104 and a battery pack for charging the earbud 104.

### Other Considerations

Although the embodiments of the inventions have been disclosed in the context of a certain preferred embodiments and examples, it will be understood by those skilled in the art that the present inventions extend beyond the specifically disclosed embodiments to other alternative embodiments and/or uses of the inventions and obvious modifications and equivalents thereof. In addition, while a number of variations of the inventions have been shown and described in detail, other modifications, which are within the scope of the inventions, will be readily apparent to those of skill in the art based upon this disclosure. It is also contemplated that various combinations or subcombinations of the specific features and aspects of the embodiments may be made and still fall within one or more of the inventions. Accordingly, it should be understood that various features and aspects of the disclosed embodiments can be combined with or substituted for one another in order to form varying modes of the disclosed inventions. Thus, it is intended that the scope of the present inventions herein disclosed should not be limited by the particular disclosed embodiments described above, and that various changes in form and details may be made without departing from the spirit and scope of the present disclosure as set forth in the following claims.

What is claimed is:

1. A mobile system comprising:
a mobile base station comprising a connection hole, a user input button, at least one processor, at least one memory, and circuitry; and
a wireless earbud configured for plugging into the connection hole of the mobile base station to form an integrated body with the mobile base station,
wherein the system establishes a wireless pairing between a smartphone and the wireless earbud using two-way wireless communication,
wherein the wireless earbud is configured to receive audio data originated from the smartphone,
wherein, in response to pressing of the user input button, the at least one processor is configured to execute computer program instructions stored in the at least one memory to initiate processing for the wireless pairing with the smartphone such that the wireless earbud receives audio data originated from the smartphone and plays audio using the audio data from the smartphone,
wherein, in response to plugging the wireless earbud into the connection hole of the mobile base station, the at least one processor is configured to execute computer program instructions stored in the at least one memory to initiate charging of a battery of the wireless earbud only if one or more charging conditions are satisfied, wherein the one or more charging conditions include the battery of the wireless earbud being below a first threshold level, and
wherein, while the wireless earbud is plugged into the connection hole of the mobile base station, the wireless earbud is configured to electrically connect with the circuitry of the mobile base station and further configured to perform wired data communication with the mobile base station.

2. The system of claim 1, wherein the one or more charging conditions include one or more of the mobile base station being connected to a power supply, and a battery of the mobile base station being above a second threshold level.

3. The system of claim 1, wherein, while the wireless earbud is plugged into the connection hole of the mobile base station, the system is configured such that the smartphone wirelessly communicates with at least one of the mobile base station and the wireless earbud.

4. The system of claim 41,
wherein the at least one processor is configured to determine whether the wireless earbud is plugged into the connection hole or unplugged out of the connection hole of the mobile base station, and
wherein the system is configured such that there is no data transmission wirelessly between the wireless earbud and the mobile base station.

5. The system of claim 1,
wherein, while the wireless earbud is plugged in the connection hole of the mobile base station, the circuitry of the mobile base station is configured to obtain characteristics of the wireless earbud and send the characteristics to the at least one processor, and
wherein the mobile system is configured to generate sound when a mobile application installed on the smartphone is searching for the mobile system while the wireless earbud is paired with the smartphone.

6. A mobile system comprising:
a mobile base station comprising a connection hole, a user input button, at least one processor, at least one memory, a battery, and circuitry; and
a wireless earbud configured for plugging into the connection hole of the mobile base station to form an integrated body with the mobile base station,
wherein, while the wireless earbud is plugged in the connection hole of the mobile base station, the wireless earbud is configured to electrically connect with the circuitry of the mobile base station and further configured to perform wired data communication with the mobile base station,
wherein, while the wireless earbud is plugged in the connection hole of the mobile base station, the circuitry of the mobile base station is configured to obtain characteristics of the wireless earbud and send the characteristics to the at least one processor,
wherein, while the wireless earbud is plugged in the connection hole of the mobile base station, the mobile base station is configured to charge a battery of the wireless earbud only if one or more charging conditions are satisfied, and wherein the one or more charging conditions include the battery of the wireless earbud being below a first threshold level,
wherein, using two-way wireless communication, the wireless earbud establishes a wireless paring with a smartphone to perform data communication with the smartphone,
wherein the mobile system is configured to generate sound when a mobile application installed on the smartphone is searching for the mobile system while the wireless earbud is paired with the smartphone, and
wherein, in response to pressing of the user input button of the mobile base station, the at least one processor is configured to execute computer program instructions stored in the at least one memory to initiate processing for the wireless pairing.

7. The system of claim 6, wherein the one or more charging conditions include one or more of the mobile base station being connected to a power supply and a battery of the mobile base station being above a second threshold level.

8. The system of claim 6, wherein, while the wireless earbud is plugged into the connection hole of the mobile base station, the system is configured such that the smartphone wirelessly communicates with at least one of the mobile base station and the wireless earbud.

9. The system of claim 6,
wherein the at least one processor is configured to determine whether the wireless earbud is plugged into the connection hole or unplugged out of the connection hole of the mobile base station, and
wherein the mobile base station is configured such that battery charging of the wireless earbud is performed while the wireless earbud is plugged in the connection hole of the mobile base station.

10. The system of claim 6, wherein the system is configured to turn off wireless Bluetooth communication of the wireless earbud while the wireless earbud is being charged.

11. The system of claim 6, wherein the system is configured such that while a connector of the wireless earbud is connected to a connector of the mobile base station and the wireless earbud is detected, at least one wireless Bluetooth communication of the wireless earbud is operable to turn off.

12. The system of claim 11, wherein the wireless earbud is detected using a switch.

13. The system of claim 11, wherein a connection between the mobile base station and wireless earbud is made to charge the wireless earbud.

14. The system of claim 6,
wherein the at least one processor is configured to determine whether the wireless earbud is plugged into the connection hole or unplugged out of the connection hole of the mobile base station, and
wherein, while the wireless earbud is plugged into the connection hole of the mobile base station, the system is configured such that at least one of the mobile base station and the wireless earbud wirelessly communicates with the smartphone.

15. A mobile system comprising:
a smartphone comprising at least one mobile application installed thereon;
a mobile apparatus comprising a main body and a wireless earbud;
the main body comprising a connection hole, a user input button, at least one processor, at least one memory, and circuitry; and
the wireless earbud configured for plugging into the connection hole of the main body to form an integrated body with the main body,
wherein, while the wireless earbud is plugged in the connection hole of the main body, the wireless earbud is configured to electrically connect with the circuitry of the main body and further configured to perform wired data communication with the main body,
wherein, while the wireless earbud is plugged in the connection hole of the main body, the circuitry of the main body is configured to obtain characteristics of the wireless earbud and send the characteristics to the at least one processor,
wherein, while the wireless earbud is plugged in the connection hole of the main body, the at least one processor is configured to execute computer program instructions stored in the at least one memory to initiate charging of a battery of the wireless earbud only if one or more charging conditions are satisfied, and wherein the one or more charging conditions include the battery of the wireless earbud being below a first threshold level,
wherein, using two-way wireless communication, the system establishes a wireless pairing between the wireless earbud and the smartphone for wireless data communication therebetween,
wherein the mobile apparatus is configured to generate sound when the at least one mobile application is searching for the mobile apparatus while the wireless earbud and the smartphone are paired,
wherein, in response to pressing of the user input button on the main body, the at least one processor is configured to execute computer program instructions stored in the at least one memory to initiate processing for the wireless pairing, and
wherein, while the wireless earbud is plugged into the connection hole of the main body, the system is configured such that the smartphone wirelessly communicates with at least one of the main body and the wireless earbud.

16. The system of claim 15, wherein the one or more charging conditions include one or more of the mobile base station being connected to a power supply and a battery of the mobile base station being above a second threshold level.

17. The system of claim 15, wherein the main body is not configured to form a wired connection with the smartphone.
